(19) United States
(12) Patent Application Publication
(10) Pub. No.: US 2024/0247100 A1
(43) Pub. Date: Jul. 25, 2024

(54) CLEAVABLE POLYMERS

(71) Applicant: IOWA STATE UNIVERSITY RESEARCH FOUNDATION, INC., Ames, IA (US)

(72) Inventors: Eric William Cochran, Ames, IA (US); George A. Kraus, Ames, IA (US); Michael J. Forrester, Ames, IA (US); Aleksei Ananin, Ames, IA (US); Ting-Han Lee, San Jose, CA (US); Aaron David Sadow, Ames, IA (US); Nacu Hernandez, Ames, IA (US); Dhananjay Dileep, Ames, IA (US)

(21) Appl. No.: 18/397,035

(22) Filed: Dec. 27, 2023

Related U.S. Application Data
(60) Provisional application No. 63/436,053, filed on Dec. 29, 2022.

(51) Int. Cl. C08G 63/183; C08J 5/18

(52) U.S. Cl. CPC C08G 63/183; C08J 5/18; C08J 2367/02

(57) ABSTRACT

The present application is directed to a cleavable polymer comprising one or more repeat units containing monomer A and one or more repeat units containing monomer B, wherein repeat unit containing monomer A and repeat unit containing monomer B are as described herein and to a process of preparing such a cleavable polymer. The present application is also directed to a cleavable polymer comprising one or more repeat units containing monomer C and one or more repeat units containing monomer D, wherein repeat unit containing monomer C and repeat unit containing monomer D are as described herein.

This application claims the benefit of U.S. Provisional Patent Application Ser. No. 63/436,053, filed Dec. 29, 2022, which is hereby incorporated by reference in its entirety.

This invention was made with government support under EE-0009294 awarded by U.S. Department of Energy. The government has certain rights in the invention.

### FIELD

The present application relates to cleavable polymers and methods of making thereof.

### BACKGROUND

Most petroleum-derived plastics like poly(ethylene terephthalate) (PET) are long-lived, resulting in “white pollution” due to their nondegradable characteristics and leakage into the environment due to inappropriate waste management practices (Liu et al., “‘White Revolution‘ to’White Pollution’-Agricultural Plastic Film Mulch in China,” Environmental Research Letters 9:091001 (2014); Shen et al., “Are Biodegradable Plastics a Promising Solution to Solve the Global Plastic Pollution?,” Environmental Pollution 263:114469 (2020)). Since its adoption by Pepsico for use in bottles in the 1970s (McElheny, V. K., “Technology,” The New York Times (1977)), PET has surpassed glass and metal as the dominant packaging material, accounting for about 6% of the global plastic market share (Hestin et al., “Sustainability Blueprint for Plastics Packaging Waste: Quality Sorting & Recycling,” Final Report 1-50 (2017)). This success has been buoyed by its low cost, high strength-to-weight ratio, impact strength, optical clarity, chemical resistance, and barrier properties. In 2021 alone, approximately 81 million metric tons of PET were produced, with market forecasters anticipating 115 million tons by 2028, driven by the rising global population and attendant increase in food consumption (“Global Polyethylene Terephthalate (PET) Resin Market to Boost in Coming Years—Projected to Reach Worth 114.7 Million Tons in 2028,” Blue Weave Consulting & Research Pvt. Ltd (2022)). This is accompanied by the increased production of its precursors terephthalic acid (TPA) and ethylene glycol (EG), mostly from petroleum resources. In spite of highly visible bottle recycling efforts, far less than half of PET is recycled; moreover, even recycled PET is often landfilled, with only a paltry 7% used for bottle-to-bottle recycling (“The New Plastics Economy Rethinking the Future of Plastics,” The World Economic Forum, Ellen MacArthur Foundation and McKinsey & Company p 36 (2016)). Ultimately, the quality of all mechanically recycled PET becomes unsuitable for use such that the landfill and/or the environment are the terminal destinations. The tremendous quantity of bottles that have entered the environment has a massive impact on all living species, especially in the ocean, where the mass of plastic waste is projected to exceed that of fish by 2025 (“The New Plastics Economy Rethinking the Future of Plastics,” The World Economic Forum, Ellen MacArthur Foundation and McKinsey & Company p 36 (2016)).

Since the structure of PET makes it resistant to natural degradation and energy intensive for chemical recycling, it is imperative to establish new strategies for PET and PET-like materials designed for closed-loop circularity due to these ecological and economic considerations. Today, PET recycling is almost exclusively primary or secondary recycling, complex physical processes that involve sorting, cleaning, grinding, melting, and reforming (Al-Sabagh et al., “Greener Routes for Recycling of Polyethylene Terephthalate,” Egyptian Journal of Petroleum 25:53-64 (2016)). Energy consumption for these processes is very process dependent and ranges from 8 to 55 MJ/kg (Hopewell et al., “Plastics Recycling: Challenges and Opportunities,” Philosophical Transactions of the Royal Society B: Biological Sciences 364:2115-2126 (2009)). Moreover, there is a notable deterioration of product performance due to degradation, oxidation, contamination, and altered molecular weight distribution (Al-Sabagh et al., “Greener Routes for Recycling of Polyethylene Terephthalate,” Egyptian Journal of Petroleum 25:53-64 (2016)).

Tertiary recycling, known commonly as chemical recycling or chemolysis, promises the recovery of virgin monomers that can be used to regenerate brand-new plastics, even from highly damaged and contaminated feedstocks. Multiple approaches for PET chemolysis have been considered including glycolysis, alcoholysis, and hydrolysis (George et al., “Recent Developments in the Chemical Recycling of Postconsumer Poly (Ethylene Terephthalate) Waste,” Industrial & Engineering Chemistry Research 53:14185-14198 (2014)). Hydrolysis uses aqueous solutions with acidic, alkaline, or neutral catalysts, whereas glycolysis and alcoholysis use glycols or alcohols, respectively. Other approaches such as aminolysis and ammonolysis use aqueous amine solutions or ammonia are seldom considered due to the lack of product application.

As the simplest and oldest approach to PET depolymerization, glycolysis has been studied thoroughly over these decades. Generally, ethylene glycol is used to attain the PET precursor bis(hydroxyethyl) terephthalate (BHET) for subsequent PET regeneration. Besides temperature and time, various catalysts, including metal acetates, metal oxides, carbonates, sulfates, ionic liquids, and others have been investigated. Metal acetates are the most widely used with activities ordering as Zn²⁺>Pb²⁺>Mn²⁺>Co²⁺ and BHET yields ranging 70-100% (Baliga et al., “Depolymerization of Poly (Ethylene Terephthalate) Recycled from Post-Consumer Soft-Drink Bottles,” Journal of Polymer Science Part A: Polymer Chemistry 27:2071-2082 (1989)). Imran et al., “Manganese-, Cobalt-, and Zinc-Based Mixed-Oxide Spinels as Novel Catalysts for the Chemical Recycling of Poly (Ethylene Terephthalate) Via Glycolysis,” Polymer Degradation and Stability 98:904-915 (2013) used pure oxides and mixed-oxide spinel as catalysts and indicated better efficiency comparted to single oxides due to higher surface area and acid site concentration. Moreover, the type of metal cation, coordination geometry (tetrahedral or octahedral), and the spinel geometry (tetragonal or cubic) affect the BHET yield (Imran et al., “Manganese-, Cobalt-, and Zinc-Based Mixed-Oxide Spinels as Novel Catalysts for the Chemical Recycling of Poly (Ethylene Terephthalate) Via Glycolysis,” Polymer Degradation and Stability 98:904-915 (2013)). Al-Sabagh et al., “Cu-and Zn-Acetate-Containing Ionic Liquids as Catalysts for the Glycolysis of Poly (Ethylene Terephthalate),” Polymer Degradation and Stability 110:364-377 (2014) studied glycolysis using Cu— and Zn-acetate-containing ionic liquids as catalysts and the catalytic activity was claimed to be stable for up to six reuses. Moreover, studies showed that purification of glycolysis products in the presence of ionic liquids was found to be simpler than that of using conventional catalysts such as metal acetate. Microwave-assisted glycolysis of PET has gained considerable attention due to the 300 s time scale required to achieve nearly complete conversion albeit at energy requirements near 60 MJ/kg (Achilias et al., “Glycolytic Depolymerization of PET Waste in a Microwave Reactor,” Journal of Applied Polymer Science 118:3066-3073 (2010); U.S. Patent Application Publication No. 2020/0056009 to Parrott).

Alcoholysis involves the degradation of PET in an alcoholic medium under high temperature and pressure, whereas methanolysis has drawn more attention over recent years. It can proceed under three forms: liquid (conventional), super-heated (vapor), or supercritical methanol (Shojaei et al., “Chemical Recycling of PET: A Stepping-Stone Toward Sustainability,” Polymers for Advanced Technologies 31:2912-2938 (2020)). The conventional process uses the same catalysts as glycolysis, whereas the super-heated pathway leads to a lower decomposition rate but has higher tolerance for contaminated PET. The supercritical process achieves significantly higher PET decomposition rates without catalyst, albeit at the expense of severe reaction conditions (T>240° C., P>8 MPa).

Hydrolysis of PET can be performed with acids like H₂SO₄ and HNO₃, alkalis like NaOH and KOH, or neutral materials including metal acetates, phase transfer agents, or hydrotalcite in aqueous or nonaqueous media. Campanelli et al., “A Kinetic Study of the Hydrolytic Degradation of Polyethylene Terephthalate at High Temperatures,” 48:443-451 (1993) demonstrated complete depolymerization to monomers in excess water at 265° C. for 2 hours. G0910 et al., “Hydrolysis of Waste Polyethylene Terephthalate and Characterization of Products by Differential Scanning Calorimetry,” Thermochimica Acta 404:193-205 (2003) carried out neutral hydrolysis of PET with different amounts of water and different catalysts in xylene. They concluded that xylene facilitated both depolymerization and subsequent monomer purification (Güçlü et al., “Hydrolysis of Waste Polyethylene Terephthalate and Characterization of Products by Differential Scanning Calorimetry,” Thermochimica Acta 404:193-205 (2003)). Mancini et al., “Optimization of Neutral Hydrolysis Reaction of Post-Consumer PET for Chemical Recycling,” Progress in Rubber Plastics and Recycling Technology 20:117-132 (2004) used 7.5M sulfuric acid to reach 80-90% depolymerization over 4 days at 100° C. and in 5 hours at 135° C. Karayannidis et al., “Poly (Ethylene Terephthalate) Recycling and Recovery of Pure Terephthalic Acid by Alkaline Hydrolysis,” Advances in Polymer Technology: Journal of the Polymer Processing Institute 21:250-259 (2002) conducted alkaline hydrolysis at 120-200° C. with aqueous NaOH solutions to yield high purity disodium terephthalate. Recently, Wang et al., “Zinc-Catalyzed Ester Bond Cleavage: Chemical Degradation of Polyethylene Terephthalate,” Journal of Cleaner Production 208:1469-1475 (2019) showed nearly quantitative hydrolysis of PET at 180° C. after 8 hours in aqueous 70 wt % ZnCl₂ solution.

While these recycling pathways are fascinating and hold great promise, they are still too resource-intensive to merit large-scale implementation, all requiring some combination of harsh conditions, time, and separations with energy consumption on the order of 60 MJ/kg or higher (Wang et al., “Zinc-Catalyzed Ester Bond Cleavage: Chemical Degradation of Polyethylene Terephthalate,” Journal of Cleaner Production 208:1469-1475 (2019); Viana et al., “Chemical Recycling of PET by Catalyzed Glycolysis: Kinetics of the Heterogeneous Reaction,” Chemical Engineering Journal 173:210-219 (2011); Delle Chiaie et al., “Dual-Catalytic Depolymerization of Polyethylene Terephthalate (PET),” Polymer Chemistry 11:1450-1453 (2020)). In practice, glycolysis products comprise a significant number of oligomers besides BHET, imposing separations challenges that impede commercial adoption (Chen et al., “The Glycolysis of Poly (Ethylene Terephthalate),” Journal ofAppliedPolymer Science 73:35-40 (1999)). While methanolysis produces relatively pure dimethyl terephthalate (DMT) and EG, it requires relatively high temperature and pressure. Moreover, most PET manufacturing is based on TPA rather than DMT, the conversion of which would impose further cost-escalating processing (Karayannidis et al., “Poly (Ethylene Terephthalate) Recycling and Recovery of Pure Terephthalic Acid by Alkaline Hydrolysis,” Advances in Polymer Technology: Journal of the Polymer Processing Institute 21:250-259 (2002)). Hydrolysis is the only method to directly recover TPA and EG from PET, but the harsh catalytic conditions would cause high corrosion to the facility and generate undesirable inorganic salts due to the concentrated acidic or basic solution used (Launay et al., “Hydrolysis of Poly (Ethylene Terephthalate): A Kinetic Study,” Polymer Degradation and Stability 46:319-324 (1994)).

According to the chemical recycling processes mentioned, it is concluded that all of the degradation processes need organic solvents, concentrated acidic/basic solution, or extreme reaction conditions (high temperature and high pressure). On one hand, these factors would significantly increase the capital cost combined with the environmental cost. On the other hand, the separation and purification of some products like BHET are difficult. As a result, further efforts to achieve resource-efficient and environmentally benign methods for PET chemical recycling are indicated.

The present application is directed to overcoming these and other deficiencies in the art.

### SUMMARY

One aspect of the present application relates to a cleavable polymer. This polymer comprises one or more repeat units containing monomer A and one or more repeat units containing monomer B,
where
repeat unit containing monomer A is

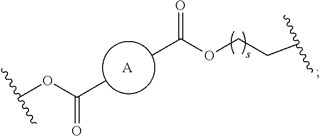

repeat unit containing monomer B is

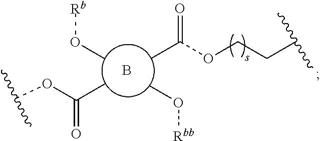

[symbol]

is a chemically cleavable bond;

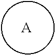

is selected from the group consisting of arylene, heteroarylene, heterocyclene, and C₅₋₈ cycloalkylene;

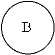

is selected from the group consisting of phenylene, furanylene, thiphenylene, and naphtanylene, wherein phenylene, furanylene, thiphenylene, and naphtanylene can be optionally substituted from 1 to 2 times with R;
R^{a} and R^{aa} are independently selected from —H, —C₁₋₃₀ alkyl, or —C₁₋₃alkyl-OH;
R^{b} and R^{bb} are independently selected from —H,

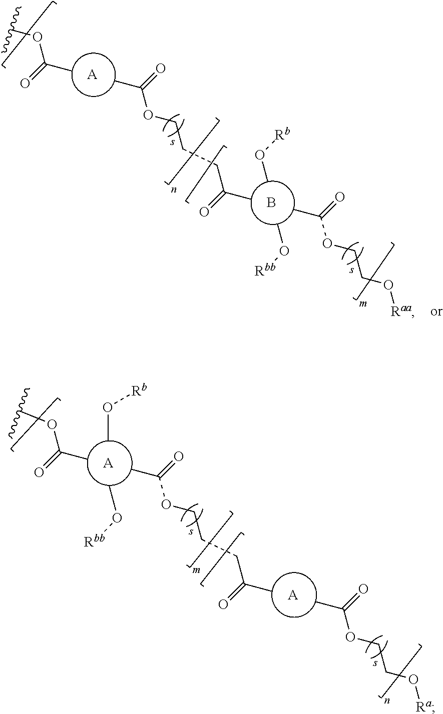

R is —OR¹, —NHR², —NO₂, or halogen;
R¹ is H, C₁₋₃₀ alkyl, or aryl;
R² is —C(O)—R¹;
s is 1 to 30;
n is 1 to 1,000,000; and
m is 1 to 1,000,000.

Another aspect of the present application relates to a cleavable polymer comprising a moiety of formula:

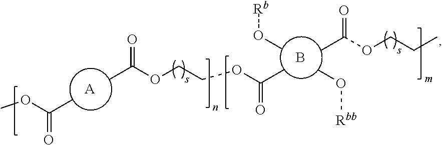

wherein [symbol] is a chemically cleavable bond;

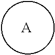

is selected from the group consisting of arylene, heteroarylene, heterocyclene, and C₅₋₈ cycloalkylene;

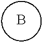

is selected from the group consisting of phenylene, furanylene, thiphenylene, and naphtanylene, wherein phenylene, furanylene, thiphenylene, and naphtanylene can be optionally substituted from 1 to 2 times with R;
R is —OR¹, —NHR², —NO₂, or halogen;
R¹ is H, C₁₋₃₀ alkyl, or aryl;
R² is —C(O)—R¹;
R^{a} and R^{aa} are independently selected from —H, —C₁₋₃₀ alkyl, or —C₁₋₃₀alkyl-OH;
R^{b} and R^{bb} are independently selected from —H,

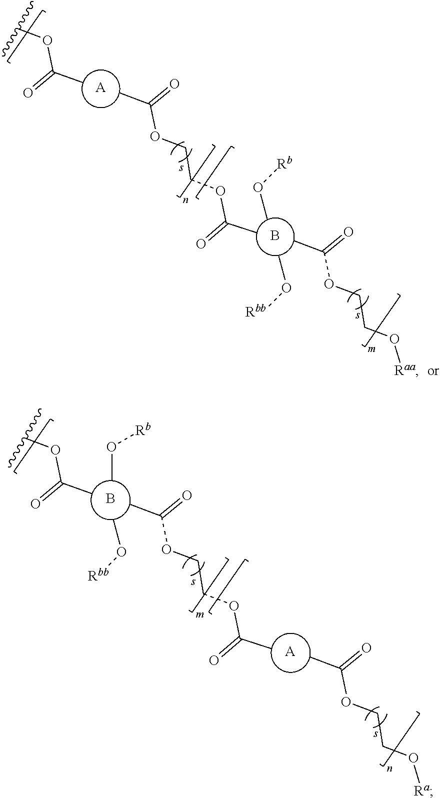

s is 1 to 30;
n is 1 to 1,000,000; and
m is 1 to 1,000,000.

Another aspect of the present application relates to a process for preparation of a cleavable polymer comprising one or more repeat units containing monomer A and one or more repeat units containing monomer B. This process includes:
providing a compound having the structure of Formula (II):

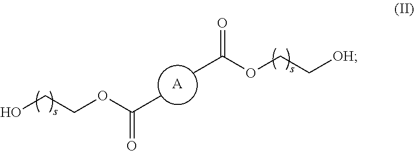

providing a compound having the structure of Formula (III):

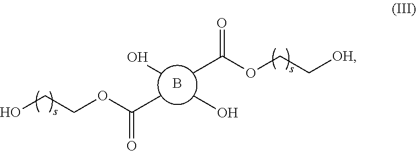

reacting the compound of formula (II) and the compound of formula (III) under conditions effective to produce the polymer,
wherein

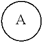

is selected from the group consisting of arylene, heteroarylene, heterocyclene, and C₅₋₈ cycloalkylene;

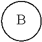

is selected from the group consisting of phenylene, furanylene, thiphenylene, and naphtanylene, wherein phenylene, furanylene, thiphenylene, and naphtanylene can be optionally substituted from 1 to 2 times with R;
R is —OR¹, —NHR², —NO₂, or halogen;
R¹ is H, C₁₋₃₀ alkyl, or aryl;
R² is —C(O)—R¹; and
s is 1 to 30.

Another aspect of the present application relates to a cleavable polymer comprising one or more repeat units containing monomer C and one or more repeat units containing monomer D,
wherein

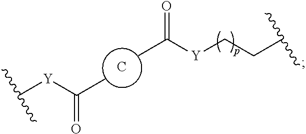

repeat unit containing monomer C is
repeat unit containing monomer D is;

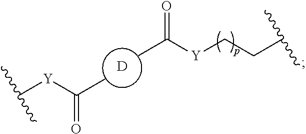

each Y is independently O or NH;

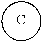

is arylene or C₂₋₃₀ alkylene, wherein arylene and C₂₋₃₀ alkylene can be optionally substituted from 1 to 3 times with R³;

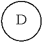

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁—N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

Another aspect of the present application relates to a polymer comprising a moiety of formula:

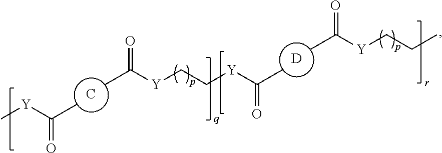

each Y is independently O or NH;

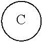

is arylene or C₂₋₃₀ alkylene, wherein arylene and C₂₋₃₀ alkylene can be optionally substituted from 1 to 3 times with R³;

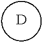

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁—N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30;
q is 1 to 1,000,000; and
r is 1 to 1,000,000.

Another aspect of the present application relates to a process for preparation of a polymer comprising one or more repeat units containing monomer C and one or more repeat units containing monomer D. This process includes:
providing a compound having the structure of Formula (VIII):

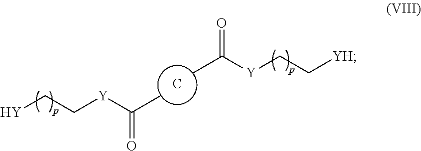

providing a compound having the structure of Formula (IX):

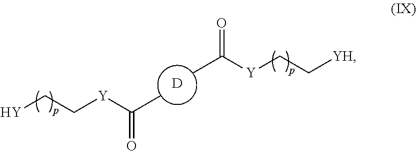

and
reacting the compound of formula (VIII) and the compound of formula (IX) under conditions effective to produce the polymer, wherein

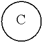

is arylene or C₂₋₃₀ alkylene, wherein arylene and C₂₋₃₀ alkylene can be optionally substituted from 1 to 3 times with R³;

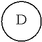

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

Another aspect of the present application relates to a process for preparation of a polymer comprising one or more repeat units containing monomer C and one or more repeat units containing monomer D. This process includes:
providing a compound having the structure of formula (X):

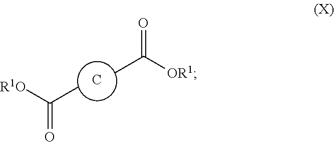

providing a compound having the structure of formula (XI):

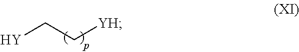

providing a compound having the structure of formula (XII):

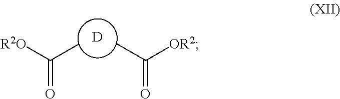

and
reacting the compound of formula (X), the compound of formula (XI), and the compound of formula (XII) under conditions effective to produce the polymer,
wherein
each Y is independently O or NH;

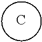

is arylene or C₂₋₃₀ alkylene, wherein arylene and C₂₋₃₀ alkylene can be optionally substituted from 1 to 3 times with R³;

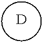

is arylene, heteroarylene, or arylene-Z-arylene, wherein arylene and heteroarylene can be optionally substituted from 1 to 3 times with R⁴;
R¹ is H or C₁₋₆ alkyl;
R² is H or C₁₋₆ alkyl;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)k₂—(CH₂)k₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

Another aspect of the present application relates to a cleavable polymer comprising one or more repeat units containing monomer A, one or more repeat units containing B, and one or more repeat units containing C:
wherein
repeat unit containing monomer A is

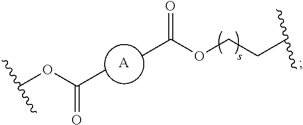

repeat unit containing monomer B is

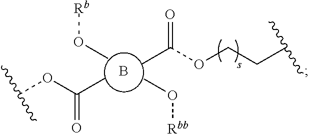

repeat unit containing monomer C is

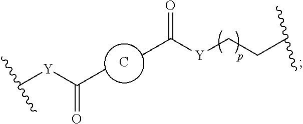

[symbol]

is a chemically cleavable bond;

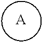

is selected from the group consisting of arylene, heteroarylene, heterocyclene, and C₅₋₈ cycloalkylene;

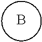

is selected from the group consisting of phenylene, furanylene, thiphenylene, and naphtanylene, wherein phenylene, furanylene, thiphenylene, and naphtanylene can be optionally substituted from 1 to 2 times with R;

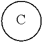

is arylene or C₂₋₃₀ alkylene, wherein arylene and C₂₋₃₀ alkylene can be optionally substituted from 1 to 3 times with R³;
each Y is independently O or NH;
R^{a} and R^{aa} are independently selected from —H, —C₁₋₃₀ alkyl, or —C₁₋₃₀alkyl-OH;
R^{b} and R^{bb} are independently selected from —H,

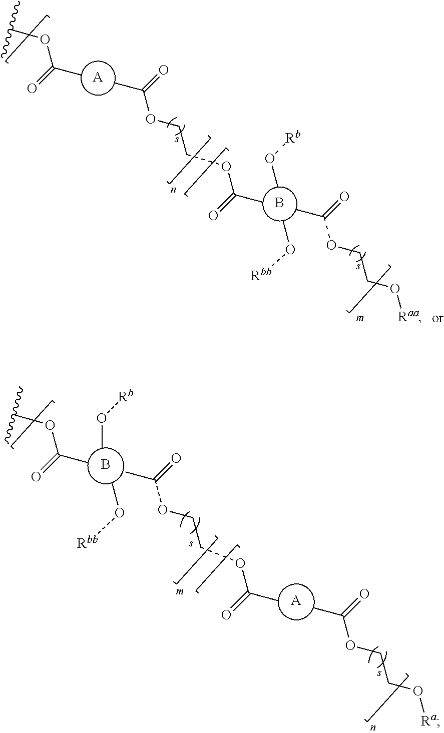

R is —OR¹, —NHR², —NO₂, or halogen;
R¹ is H, C₁₋₃₀ alkyl, or aryl;
R² is —C(O)—R¹;
R³ is —CH═CH—;
p is 1 to 30;
s is 1 to 30;
n is 1 to 1,000,000; and
m is 1 to 1,000,000.

Another aspect of the present application relates to a cleavable polymer comprising one or more repeat units containing monomer A, one or more repeat units containing monomer B, and one or more repeat units containing monomer D:
wherein
repeat unit containing monomer A is

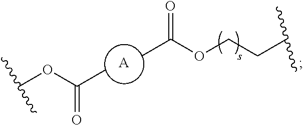

repeat unit containing monomer B is

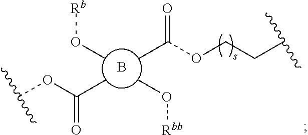

repeat unit containing monomer D is

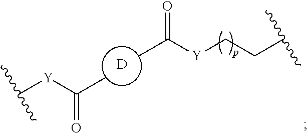

[symbol] is a chemically cleavable bond;

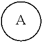

is selected from the group consisting of arylene, heteroarylene, heterocyclene, and C₅₋₈ cycloalkylene;

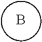

is selected from the group consisting of phenylene, furanylene, thiphenylene, and naphtanylene, wherein phenylene, furanylene, thiphenylene, and naphtanylene can be optionally substituted from 1 to 2 times with R;

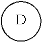

is arylene, heteroarylene, or arylene-Z-arylene, wherein arylene and heteroarylene can be optionally substituted from 1 to 3 times with R⁴;
each Y is independently O or NH;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
R^{a} and R^{aa} are independently selected from —H, —C₁₋₃₀ alkyl, or —C₁₋₃₀ alkyl-OH;
R^{b} and R^{bb} are independently selected from —H,

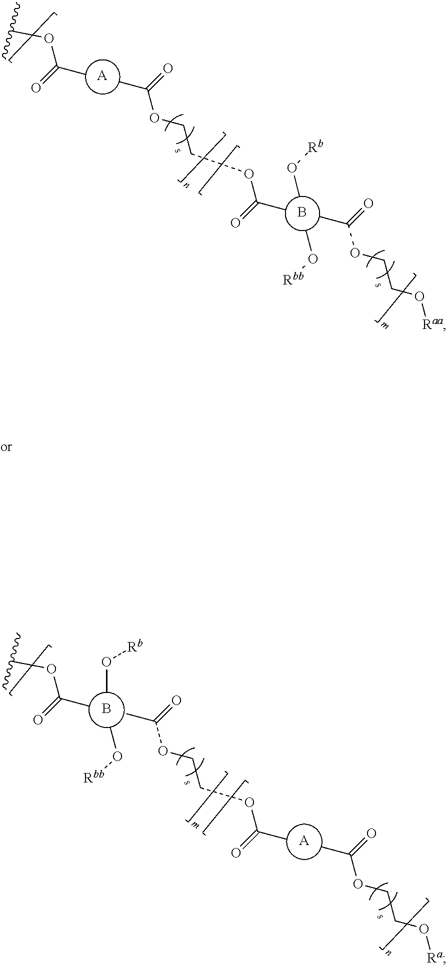

R is —OR—NHR²—NO₂, or halogen;
R¹ is H, C₁₋₃₀ alkyl, or aryl;
R² is —C(O)—R¹;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Ar is aryl optionally substituted with C₁₋₆ alkyl or —OC₁₋₆ alkyl;
p is 1 to 30;
s is 1 to 30;
n is 1 to 1,000,000; and
m is 1 to 1,000,000.

Another aspect of the present application relates to a polymer comprising one or more repeat units containing monomer A, one or more repeat units containing monomer C, and one or more repeat units containing monomer D:
wherein
repeat unit containing monomer A is_;

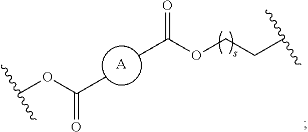

repeat unit containing monomer C is

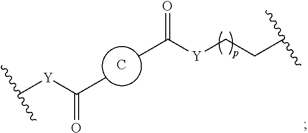

repeat unit containing monomer D is

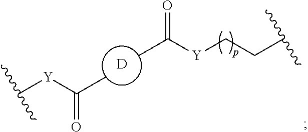

each Y is independently O or NH;

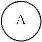

is selected from the group consisting of arylene, heteroarylene, heterocyclene, and C₅₋₈ cycloalkylene;

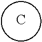

is arylene or C₂₋₃₀ alkylene, wherein arylene and C₂₋₃₀ alkylene can be optionally substituted from 1 to 3 times with R³;

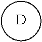

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30; and
s is 1 to 30.

Another aspect of the present application relates to a cleavable polymer comprising one or more repeat units containing monomer B, one or more repeat units containing monomer C, and one or more repeat units containing monomer D:
wherein
repeat unit containing monomer B is

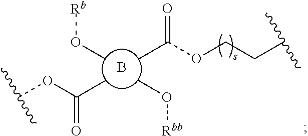

repeat unit containing monomer C is

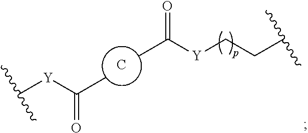

repeat unit containing monomer D is;

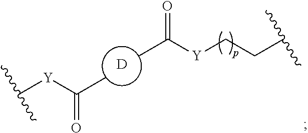

[symbol] is a chemically cleavable bond;
each Y is independently O or NH;

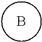

is selected from the group consisting of phenylene, furanylene, thiphenylene, and naphtanylene, wherein phenylene, furanylene, thiphenylene, and naphtanylene can be optionally substituted from 1 to 2 times with R;

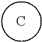

is arylene or C₂₋₃₀ alkylene, wherein arylene and C₂₋₃₀ alkylene can be optionally substituted from 1 to 3 times with R³;

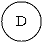

is arylene, heteroarylene, or arylene-Z-arylene, wherein arylene and heteroarylene can be optionally substituted from 1 to 3 times with R⁴;
R^{a} and R^{aa} are independently selected from —H, —C₁₋₃₀ alkyl, or —C₁₋₃o alkyl-OH;
R^{b} and R^{bb} are independently selected from —H,

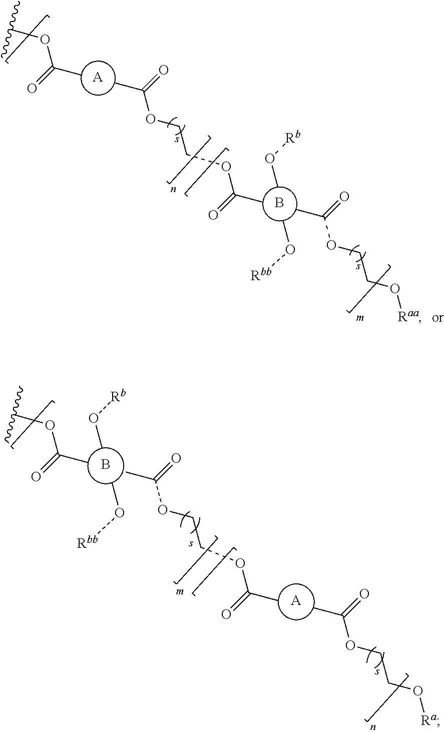

R is —OR¹, —NHR², —NO₂, or halogen;
R¹ is H, C₁₋₃o alkyl, or aryl;
R² is —C(O)—R¹;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30;
s is 1 to 30;
n is 1 to 1,000,000; and
m is 1 to 1,000,000.

The present application describes a family of PET copolymers embedded with an “Epiusian” or “Trojan Horse” (TH) counit that enables depolymerization under far milder conditions (FIG. 1). Previous work with poly(1,5 dimethoxy-2,6 ethylene naphthalate) (1,5 DM- 2,6 PEN) showed that unlike other poly(ethylene naphthalates) with thermal stability to over 400° C., this material underwent rapid chain scission reactions in both aerobic and anaerobic environments near 200° C. (Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety). Evidently, the ortho- substituents coordinated to facilitate decomposition reactions through an autocatalytic process known as “anchimeric assistance” or “neighboring group participation” (NGP) (Bowden, K. “Neighbouring Group Participation by Carbonyl Groups in Ester Hydrolysis,” Advances in Physical Organic Chemistry 28:171-206 (1993), which is hereby incorporated by reference in its entirety). In fact, Kaplan and Sawodny used a similar substitution pattern to demonstrate complexation with metals in a series of polyesters based on 2,5-dihydroxyterephthalic acid (Kaplan et al., “Metal Complexes of Polyesters,” Inorganica Chimica Acta 134:279-282 (1987), which is hereby incorporated by reference in its entirety). These authors noted decreases in the thermal stability as measured by TGA under N₂ by up to 100° C. depending on the complexed metal cation. Based on these observations it was assumed that chemically reversible NGP-activated reactions in terephthalate analogs like 2,5-dihydroxyterephthalate (DHTE) could be exploited to insert a chink into the armor of otherwise chemically resilient polymers. By copolymerizing with ≤20 mol % DHTE, PET retains or improves upon key performance features while exhibiting drastically enhanced sensitivity to hydrolysis under selective conditions. DHTE can be synthesized readily from biobased succinic acid (SA), a diacid sugar fermentation product recognized as one of the top 12 value-added platform chemicals derived from biomass by US Department of Energy (DOE) (Short et al., “Aromatic Polyesters from Biosuccinic Acid,” Polymer Chemistry 9:4113-4119 (2018); Liu et al., “Paired and Tandem Electrochemical Conversion of 5-(Hydroxymethyl) Furfural Using Membrane-Electrode Assembly-Based Electrolytic Systems,” ChemElectroChem 8:2817-2824 (2021); Liu et al., “Paired Electrolysis of 5- (Hydroxymethyl) Furfural in Flow Cells with a High-Performance Oxide-Derived Silver Cathode,” Green Chemistry 23:5056-5063 (2021), which are hereby incorporated by reference in their entirety). It should be noted that SA along with other aliphatic-like diacids, including adipic, sebacic, and maleic acids, have been used as comonomers applied to modify the properties of PET, especially in terms of its crystallinity and hydrophobicity in order to gain biodegradability (Okada, M., “Chemical Syntheses of Biodegradable Polymers,” Progress in Polymer Science 27:87-133 (2002), which is hereby incorporated by reference in its entirety). However, while the introduction of these chemicals into PET polymer backbone increased its degradability, they also reduced the thermal and mechanical properties. Here, appropriately chosen TH counits could both retain the high performance of PET due to their aromatic structure while introducing degradability due to their NGP activity. As described in the present application, abundant and inexpensive water serves as both solvent and reactant. The PET copolymers were depolymerized with zinc-based catalysts through selective cleavage of C—O bonds due to the metal ion coordination with ester and phenolic groups. Additionally, appreciable activity was found without catalyst and in a simulated marine environment. The depolymerization products, TPA and 2,5-dihydroxyterephthalic acid (DHTA), readily precipitate from water at room temperature. This strategy provides several orders of magnitude improvement of relatively inefficient chemical deconstruction reaction and high precursor recovery while retaining the thermal and mechanical performance of legacy PET.

The present application describes a novel copolymerization strategy that facilitates low-energy PET chemical recycling from the solid state in water. Through the incorporation of biobased DHTE counits into polymer backbone, novel PET plastics were introduced that undergo selective hydrolysis of ester bonds at DHTE sites, autocatalyzed by NGP. This process quickly degrades the long polymer chain into oligomeric subchains that readily undergo hydrolysis until only small molecules remain. A series of poly(ethylene terephthalate-stat-2,5-dihydroxyterephthalate) (PEDHT) copolymers were synthesized from ethylene glycol (EG), terephthalic acid (TPA), and DHTE via two-step melt polycondensation. Powdered specimens were subjected to hydrolysis in 150-190° C. water with 0-1 wt % ZnCl₂ Lewis acid catalyst or alternatively in simulated sea water. Degradation progress followed pseudo-first order kinetics as measured by mass loss of suspended polymer solids. With increasing DHTE loading, the rate constant increased monotonically while the thermal activation barrier decreased. The depolymerization products were found to be ethylene glycol, terephthalic acid, 2,5-dihydroxyterephthalic acid, and bis(2-hydroxyethyl) terephthalate dimer, which could be used to regenerate virgin polymer. Composition-optimized copolymers showed a decrease of nearly 50% in activation energy and 6-order reduction in depolymerization time compared to PET homopolymer. Thermomechanical properties of PEDHT were similar or superior to PET. The glass transition temperature of PEDHT copolymers was 4-7° C. higher than that of PET, whereas the thermal decomposition temperature was comparable. Young's modulus, yield strength, and ultimate tensile strength showed an improvement of 40%, 40%, and 110%, respectively. Overall, the present application provides novel insight to the design of polymers for end-of-life while maintaining key properties like service temperature and mechanical properties. Moreover, this chemical recycling procedure is more environmentally friendly compared to those traditional approaches since water is the only needed material, which is green, sustainable, and cheap.

### BRIEF DESCRIPTION OF THE DRAWINGS

FIG. 1 is a schematic showing the Trojan-Horse paradigm for poly(ethylene terephthalate) (PET) chemical recycling.

FIG. 2 shows step-growth polycondensation of pure PET and poly(ethylene terephthalate)-poly(ethylene terephthalate-stat-2,5-dihydroxyterephthalate) (PET-PEDHT) copolymer via a two-step polymerization.

FIG. 3 shows GC-MS data indicating high purity of bis(2-hydroxyethyl) 2,5-dihydroxyterephthalate (BHDHT) (the hydroxyl end group was capped by silane agent).

FIG. 4 shows ATR-FTIR spectra of PET and poly(ethylene terephthalate-stat-2,5-dihydroxyterephthalate) (PEDHT) copolymers.

FIGS. 5A-B are differential scanning calorimetry (DSC) thermograms of PET and PEDHT copolymers: second heating (FIG. 5A) and second cooling (FIG. 5B) (scan rate was 10° C. min⁻¹).

FIGS. 6A-B show TGA thermograms (FIG. 6A) and DTG curve (FIG. 6B) of PET and PEDHT copolymers. Heating rate was 10° C. min⁻¹.

FIGS. 7A-B show representative stress-strain curves of PET and PEDHT copolymers with the speed of 10 mm-min⁻¹ at room temperature: PET, PEDHT5, PEDHT10, and PEDHT20.

FIGS. 8A-B show effect of the reaction conditions on the degradation kinetics of PET and PEDHT copolymers. FIG. 8A is graph showing In k vs ZnCl₂ concentration of PEDHT10 at 170° C. FIG. 8B is graph showing In k (left axis, □) and Ea (right axis, ∘) vs DHTE loading. Filled symbols are 0% ZnCl₂ (except for 10% loading which is 1% ZnCl₂). Open symbols denote sea water experiments.

FIGS. 9A-F are graphs showing effect of the reaction conditions on the degradation kinetics of PET and PEDHT copolymers. The linear relationship between 1n (1/(1-x)) and time of different catalyst concentration of PEDHT10 at 170° C. and 8 hours (FIG. 9A) and different reaction temperature of PEDHTs and pure PET (FIGS. 9B-F).

FIG. 10 is a graph showing effect of the reaction conditions on the degradation kinetics of PET and PEDHT copolymers. Arrhenius plot of PET and PEDHTs.

FIGS. 11A-B show ¹H NMR spectrum of solid degradation products (FIG. 11A) and liquid degradation products (FIG. 11B). Deuterated reagent: DMSO-d6.

FIG. 12 shows GC-MS spectrum of solid degradation products. Solvent: pyridine.

FIG. 13 shows proposed TH-unit mediated degradation mechanism in PEDHT copolymers via selective cleavage of ester bonds in the presence of Zn-based catalysts.

FIG. 14 shows GPC analysis of PEDHT copolymers: PET, PEDHT5, PEDHT10, and PEDHT20.

FIGS. 15A-G show the chemical structures of terephthalic acid (FIG. 15A) and several examples of cleavable monomers (FIGS. 15B-G).

FIG. 16 is a schematic illustrating the synthesis of the cleavable monomer shown in FIG. 15E.

FIG. 17 shows the ¹H-NMR spectra of the cleavable monomer shown in FIG. 15E.

FIG. 18 shows the ¹H-NMR spectra of the PET copolymer containing 7.2 mol % of the repeat unit owing to the incorporation of the cleavable monomer shown in FIG. 15E.

FIG. 19 is a schematic illustrating the synthesis of a PET copolymer incorporating the cleavable monomer shown in FIG. 15E.

FIGS. 20A-B show the chemical mechanism of ozone-assisted depolymerization (FIG. 20A) and a stacked time series of ¹H-NMR spectra showing the ozone-mediated consumption of the —CH₂═CH₂— bonds in a PET copolymer incorporating the cleavable monomer shown in FIG. 15E (FIG. 20B).

FIG. 21 shows GPC chromatograms that demonstrate the rapid reduction in the molecular weight of a PET copolymer incorporating the cleavable monomer shown in FIG. 15E when subjected to ozonolysis.

FIG. 22 shows is a schematic depicting the KMnO₄-mediated oxidative cleavage of a PET copolymer incorporating the cleavable monomer shown in FIG. 15E.

FIG. 23 shows GPC chromatograms that demonstrate the reduction in molecular weight of a PET copolymer incorporating the cleavable monomer shown in FIG. 15E when subjected to KMnO₄-mediated depolymerization under various conditions.

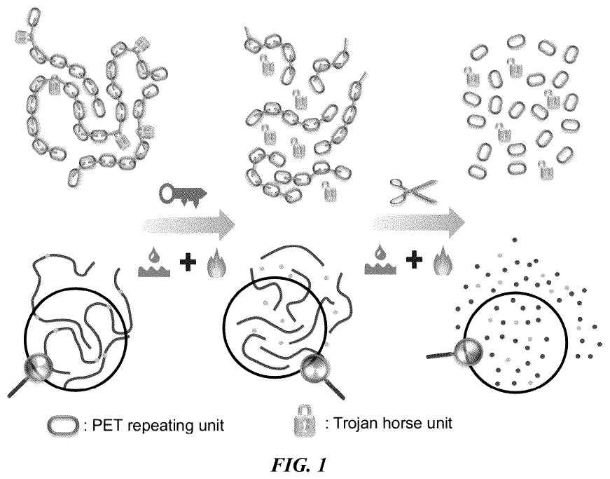

### DETAILED DESCRIPTION

One aspect of the present application relates to a cleavable polymer. This polymer comprises one or more repeat units containing monomer A and one or more repeat units containing monomer B, where
repeat unit containing monomer A is

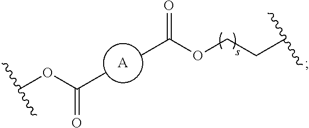

repeat unit containing monomer B is

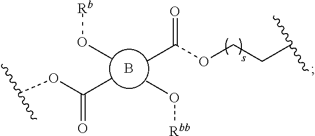

[symbol] is a chemically cleavable bond;

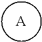

is selected from the group consisting of arylene, heteroarylene, heterocyclene, and C₅₋₈ cycloalkylene;

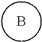

is selected from the group consisting of phenylene, furanylene, thiphenylene, and naphtanylene, wherein phenylene, furanylene, thiphenylene, and naphtanylene can be optionally substituted from 1 to 2 times with R;
R^{a} and R^{aa} are independently selected from —H, —C₁₋₃₀ alkyl, or —C₁₋₃ alkyl-OH;
R^{b} and R^{bb} are independently selected from —H,

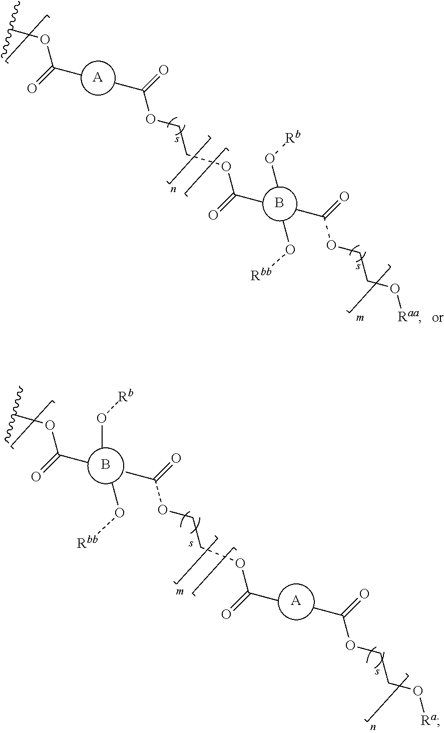

R is —OR¹, —NHR², —NO₂, or halogen;
R¹ is H, C₁₋₃₀ alkyl, or aryl;
R² is —C(O)—R¹;
s is 1 to 30;
n is 1 to 1,000,000; and
m is 1 to 1,000,000.

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

As used herein, the term “alkane” refers to aliphatic hydrocarbons of formula C˜H₂n+₂, which may be straight or branched having about 1 to about 100 (e.g., 1-2, 1-3, 1-4, 1-5, 1-6, 1-7, 1-8) carbon atoms in the chain. For example, straight or branched carbon chain could have 1 to 30 carbon atoms. Branched means that one or more lower alkyl groups such as methyl, ethyl, or propyl are attached to a linear alkyl chain. Exemplary alkanes include methane, ethane, n-propane, i-propane, n-butane, t-butane, n-pentane, and 3-pentane. The term “alkylene” refers to a divalent group formed from an alkane by removal of two hydrogen atoms. Exemplary alkylene groups include, but are not limited to, divalent groups derived from the alkanes described above.

The term “alkyl” means an aliphatic hydrocarbon group which may be straight or branched having about 1 to about 30 carbon atoms in the chain. For example, straight or branched carbon chain could have 1 to 10 carbon atoms. Branched means that one or more lower alkyl groups such as methyl, ethyl or propyl are attached to a linear alkyl chain. Exemplary alkyl groups include methyl, ethyl, n-propyl, i-propyl, n-butyl, t-butyl, n-pentyl, and 3-pentyl.

As used herein, the term “cycloalkane” refers to aliphatic hydrocarbons of formula Cₙ H₂ₙ, which may be straight or branched having about 3 to about 8 carbon atoms in the chain. Exemplary cycloalkanes include cyclopropane, cyclobutane, cyclopentane, cyclohexane, and cycloheptane. The term “cycloalkylene” refers to a divalent group formed from a cycloalkane by removal of two hydrogen atoms. Exemplary cycloalkylene groups include, but are not limited to, divalent groups derived from the cycloalkanes described above.

The term “aryl” means an aromatic monocyclic or multi-cyclic ring system of 6 to about 14 carbon atoms, preferably of 6 to about 10 carbon atoms. Representative aryl groups include phenyl and naphthyl. The term “arylene” refers to a group obtained by removal of a hydrogen atom from an aryl group. Non-limiting examples of arylene include phenylene and naphthylene.

The term “benzyl” means a benzyl group as shown below

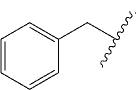 [SMILES: *Cc1ccccc1]

The term “heteroaryl” means an aromatic monocyclic or multi-cyclic ring system of about 5 to about 14 ring atoms, preferably about 5 to about 10 ring atoms, in which one or more of the atoms in the ring system is/are element(s) other than carbon, for example, nitrogen, oxygen, or sulfur. In the case of multi-cyclic ring system, only one of the rings needs to be aromatic for the ring system to be defined as “Heteroaryl”. Preferred heteroaryls contain about 5 to 6 ring atoms. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like. The term “heteroarylene” refers to a group obtained by removal of a hydrogen atom from a heteroaryl group. Exemplary heteroarylene groups include, but are not limited to, groups derived from the heteroaryl groups described above.

As used herein, “heterocyclyl” or “heterocycle” refers to a stable 3- to 18-membered ring (radical) which consists of carbon atoms and from one to five heteroatoms selected from the group consisting of nitrogen, oxygen and sulfur. For purposes of this application, the heterocycle may be a monocyclic, or a polycyclic ring system, which may include fused, bridged, or spiro ring systems; and the nitrogen, carbon, or sulfur atoms in the heterocycle may be optionally oxidized; the nitrogen atom may be optionally quaternized; and the ring may be partially or fully saturated. Examples of such heterocycles include, without limitation, oxiranyl, azepinyl, azocanyl, pyranyl dioxanyl, dithianyl, 1,3-dioxolanyl, tetrahydrofuryl, dihydropyrrolidinyl, decahydroisoquinolyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, 2-oxoazepinyl, oxazolidinyl, oxiranyl, piperidinyl, piperazinyl, 4-piperidonyl, pyrrolidinyl, pyrazolidinyl, thiazolidinyl, tetrahydropyranyl, thiamorpholinyl, thiamorpholinyl sulfoxide, and thiamorpholinyl sulfone. Further heterocycles and heteroaryls are described in Katritzky et al., eds., Comprehensive Heterocyclic Chemistry: The Structure, Reactions, Synthesis and Use of Heterocyclic Compounds, Vol. 1-8, Pergamon Press, N.Y. (1984), which is hereby incorporated by reference in its entirety. The term “non-aromatic heterocyclene” refers to a group obtained by removal of a hydrogen atom from a non-aromatic heterocyclyl group. Exemplary non-aromatic heterocyclene groups include, but are not limited to, groups derived from the non-aromatic heterocyclyl groups described above.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

The term “substituted” or “substitution” of an atom means that one or more hydrogen on the designated atom is replaced with a selection from the indicated group, provided that the designated atom's normal valency is not exceeded.

The term “halogen” means fluoro, chloro, bromo, or iodo.

The term “optionally substituted” is used to indicate that a group may have a substituent at each substitutable atom of the group (including more than one substituent on a single atom), provided that the designated atom's normal valency is not exceeded, and the identity of each substituent is independent of the others. Up to three H atoms in each residue are replaced with alkyl, halogen, haloalkyl, hydroxy, loweralkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

“Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds; by “stable compound” or “stable structure” is meant a compound that is sufficiently robust to survive isolation to a useful degree of purity from a reaction mixture, and formulation into an efficacious therapeutic agent.

Throughout the present application, —refers to a chemically cleavable bond. The term “chemically cleavable bond” is used to indicate those bonds integral to the polymer backbone designed to be labile under mild-yet-specific conditions. Such conditions include exposure to elevated temperature, radiation, ozone, oxidants, acids, or bases.

The term “copolymer” refers to a polymer derived from more than one species of monomer.

The term “alternating copolymer” or “alternating polymer” refers to a copolymer consisting of two or more species of monomeric units that are arranged in an alternating sequence (in which every other building unit is different (-M₁M₂-)n.

The term “random copolymer” or “random polymer” refers to a copolymer in which there is no definite order for the sequence of the different building blocks (-M₁M₂M₁M₁M₂M₁M₂M₂-).

The term “statistical copolymer” or “statistical polymer” refers to a copolymer in which the sequential distribution of the monomeric units obeys known statistical laws.

The term “block copolymer” or “block polymer” refers to a macromolecule consisting of long sequences of different repeat units. Exemplary block polymers include, but are not limited to AₙBₘ, AₙBₘAₘ, AₙBₘCₖ, or AₙBₘCₖAₙ.

The term “statistically defined manner” refers to the repeat unit sequence distribution (RUSD) of the polymer, which is determined by the polymerization chemistry, the number and nature of comonomers, and the reaction conditions under which the polymer is formed. For any polymer, the RUSD can be represented by a probability function Pᵢ(j) that indicates the likelihood that the identity of the repeat unit at location j along the chain contour is i. Common RUSD classifications include, but are not limited to, random (Pᵢ=constant) and block (e.g., Pᵢ(j<f)=0 and Pᵢ(j≥f)=1 given fixed contour coordinate f). RUSD prediction and measurement are discussed in most polymer chemistry texts, e.g., Hiemenz and Lodge, Polymer Chemistry, 2^{nd} Ed., Boca Raton Fl. CRC Press (2007), which is hereby incorporated by reference in its entirety.

In some embodiments, the repeat unit containing monomer A is

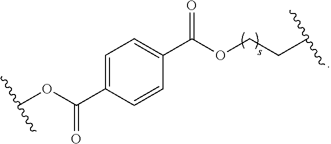

In some embodiments, the repeat unit containing monomer B is

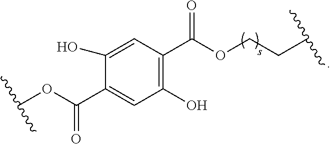

In some embodiments, the polymer has the structure selected from the group consisting of:

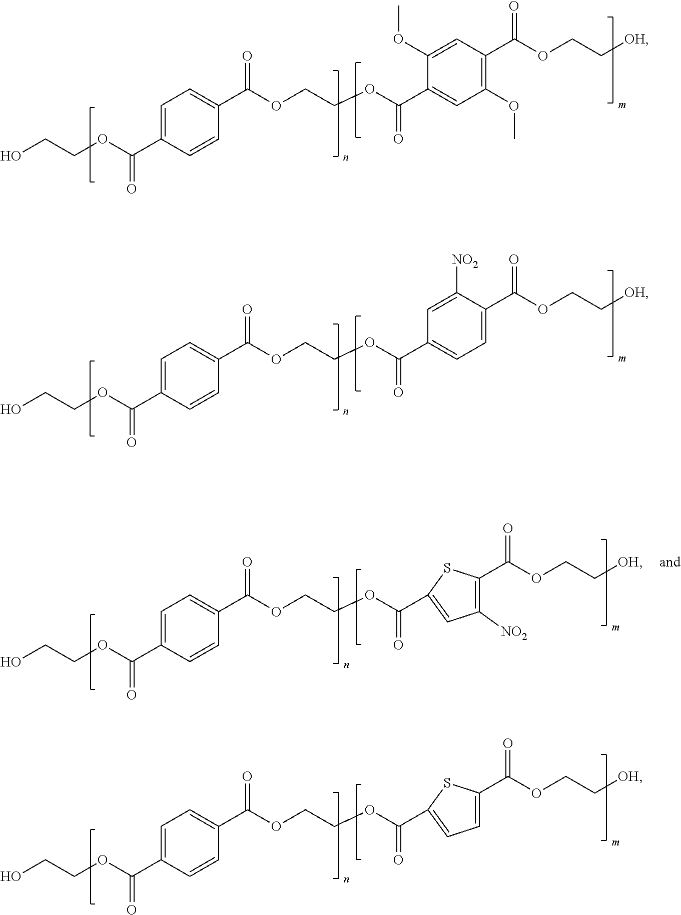

wherein
n and m represent number average degrees of polymerization for repeat units and are distributed throughout the polymer chain in a statistically defined manner;
n is 1 to 1,000,000; and
m is 1 to 1,000,000.

Another aspect of the present application relates to a cleavable polymer comprising a moiety of formula:

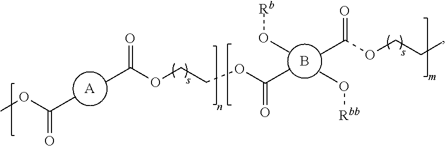

wherein
[symbol] is a chemically cleavable bond;

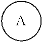

is selected from the group consisting of arylene, heteroarylene, heterocyclene, and C₅₋₈ cycloalkylene;

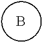

is selected from the group consisting of phenylene, furanylene, thiphenylene, and naphtanylene, wherein phenylene, furanylene, thiphenylene, and naphtanylene can be optionally substituted from 1 to 2 times with R;
R is —OR¹, —NHR², —NO₂, or halogen;
R¹ is H, C₁₋₃₀ alkyl, or aryl;
R² is —C(O)—R¹;
R^{a} and R^{aa} are independently selected from —H, —C₁₋₃₀ alkyl, or —C₁₋₃alkyl-OH;
R^{b} and R^{bb} are independently selected from —H,

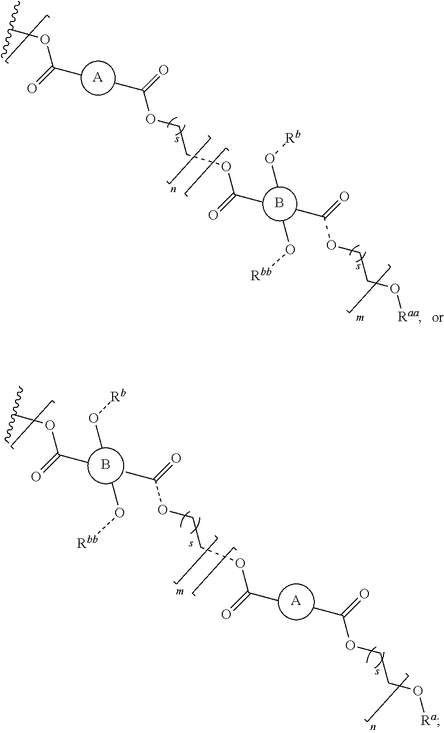

s is 1 to 30;
n is 1 to 1,000,000; and
m is 1 to 1,000,000.

In some embodiments, R^{a} and R^{aa} are independently selected from —H, —CH₃, or —CH₂—CH₂—OH.

In some embodiments, the polymer according to the present application:

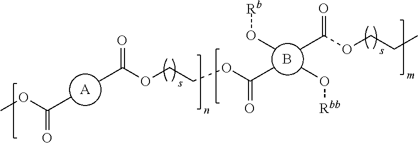

can further have one or more of the polymer blocks of formula

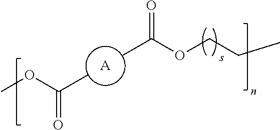

(block A) and/or

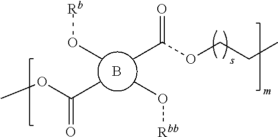

(block B) attached to the end of either or both sides of the polymer chain

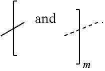

For example, the polymer according to the present application can have a structure of formula -Aₙ-Bₘ—, -Aₙ-Bₘ-Aₙₙ-Bₘₘ—, -Aₙ-Bₘ-Aₙₙ-Bₘₘ-Aₙₙₙ-Bₘₘₘ—, —B-Aₙ-Bₘ-Aₙₙ-Bₘₘ-Aₙₙₙ-Bₘₘ, —B-Aₙ-Bₘ-A-Bₘ-Aₙₙ,—Bₘₘₘ, B-Aₙ-Bₘ-A-B-Aₙₙ-Bₘₘ, —Bₘ-Aₙ-Bₘ-Aₙₙ-Bₘ-Aₙₙ-Bₘₘₘ—, or -Aₙ-Bₘ-Aₙₙ-Bₘₘ-Aₙₙ-Bₘₘ-A-, wherein A is

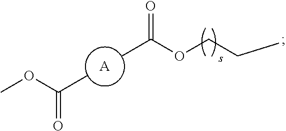

each A can be the same or different; B is

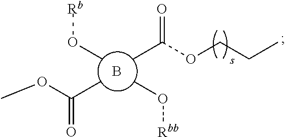

each B can be the same or different; each n, nn, nnn . . . nₖ can be the same or different and are independently selected from 1 to 1,000,000; each m, mm, mmm . . . mᵢ can be the same or different and are independently selected from 1 to 1,000,000; k and i are 1,000,000; wherein the sum of n, nn, nnn . . . nₖ is 1 to 1,000,000, and the sum of m, mm, mmm . . . mᵢ is 1 to 1,000,000.

According to the present application, n is from 1 to 1,000,000. For example, n is from 2 to 1,000,000, n is from 10 to 1,000,000, n is from 20 to 1,000,000, n is from 25 to 1,000,000, n is from 30 to 1,000,000, n is from 40 to 1,000,000, n is from 50 to 1,000,000, n is from 75 to 1,000,000, n is from 100 to 1,000,000, n is from 150 to 1,000,000, n is from 200 to 1,000,000, n is from 250 to 1,000,000, n is from 300 to 1,000,000, n is from 350 to 1,000,000, n is from 400 to 1,000,000, n is from 450 to 1,000,000, n is from 500 to 1,000,000, n is from 550 to 1,000,000, n is from 600 to 1,000,000, n is from 650 to 1,000,000, n is from 700 to 1,000,000, n is from 750 to 1,000,000, n is from 800 to 1,000,000, n is from 850 to 1,000,000, n is from 900 to 1,000,000, n is from 950 to 1,000,000, n is from 1,000 to 1,000,000, n is from 1,500 to 1,000,000, n is from 2,000 to 1,000,000, n is from 3,000 to 1,000,000, n is from 4,000 to 1,000,000, n is from 5,000 to 1,000,000, n is from 6,000 to 1,000,000, n is from 7,000 to 1,000,000, n is from 8,000 to 1,000,000, n is from 9,000 to 1,000,000, n is from 10,000 to 1,000,000, n is from 20,000 to 1,000,000, n is from 30,000 to 1,000,000, n is from 40,000 to 1,000,000, n is from 50,000 to 1,000,000, n is from 100,000 to 1,000,000, n is from 250,000 to 1,000,000, n is from 500,000 to 1,000,000, n is from 750,000 to 1,000,000. For example, n is from 2 to 850,000, n is from 10 to 700,000, n is from 50 to 600,000, n is from 100 to 500,000, n is from 250 to 500,000, n is from 500 to 500,000, n is from 1,000 to 500,000, n is from 2,000 to 500,000, n is from 10,000 to 500,000, n is from 100,000 to 500,000.

According to the present application, m is from 1 to 1,000,000. For example, m is from 2 to 1,000,000, m is from 10 to 1,000,000, m is from 20 to 1,000,000, m is from 25 to 1,000,000, m is from 30 to 1,000,000, m is from 40 to 1,000,000, m is from 50 to 1,000,000, m is from 75 to 1,000,000, m is from 100 to 1,000,000, m is from 150 to 1,000,000, m is from 200 to 1,000,000, m is from 250 to 1,000,000, m is from 300 to 1,000,000, m is from 350 to 1,000,000, m is from 400 to 1,000,000, m is from 450 to 1,000,000, m is from 500 to 1,000,000, m is from 550 to 1,000,000, m is from 600 to 1,000,000, m is from 650 to 1,000,000, m is from 700 to 1,000,000, m is from 750 to 1,000,000, m is from 800 to 1,000,000, m is from 850 to 1,000,000, m is from 900 to 1,000,000, m is from 950 to 1,000,000, m is from 1,000 to 1,000,000, m is from 1,500 to 1,000,000, m is from 2,000 to 1,000,000, m is from 3,000 to 1,000,000, m is from 4,000 to 1,000,000, m is from 5,000 to 1,000,000, m is from 6,000 to 1,000,000, m is from 7,000 to 1,000,000, m is from 8,000 to 1,000,000, m is from 9,000 to 1,000,000, m is from 10,000 to 1,000,000, m is from 20,000 to 1,000,000, m is from 30,000 to 1,000,000, m is from 40,000 to 1,000,000, m is from 50,000 to 1,000,000, m is from 100,000 to 1,000,000, m is from 250,000 to 1,000,000, m is from 500,000 to 1,000,000, m is from 750,000 to 1,000,000. For example, m is from 2 to 850,000, m is from 10 to 700,000, m is from 50 to 600,000, m is from 100 to 500,000, m is from 250 to 500,000, m is from 500 to 500,000, m is from 1,000 to 500,000, m is from 2,000 to 500,000, m is from 10,000 to 500,000, m is from 100,000 to 500,000.

According to the present application, s is from 1 to 30. For example, s is from 1 to 25, s is from 1 to 20, s is from 1 to 15, s is from 1 to 10, s is from 2 to 30, s is from 2 to 25, s is from 2 to 20, s is from 2 to 15, s is from 2 to 10. For example, s can be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30.

In some embodiments, the polymer according to the present application:

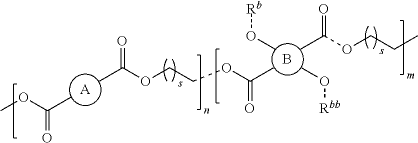

can further have one or more of the polymer blocks of formula

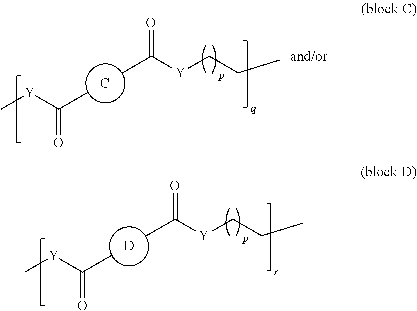

attached to the end of either or both sides of the polymer chain

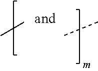

or in between

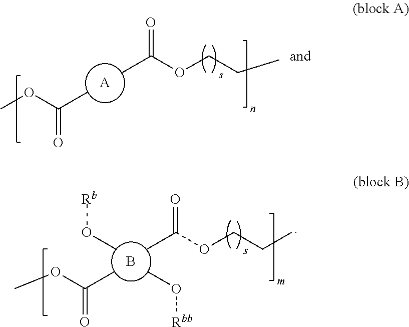

For example, the polymer according to the present application can have a structure of formula —C_{q}-Aₙ-Bₘ, —C_{q}-Aₙ-Bₘ—C_{qq}—, —C_{q}-C_{qq}-Aₙ-Bₘ—, —C_{q}-Aₙ-Bₘ-Dᵣ, —C_{q}-Aₙ-Bₘ-Dᵣ-Dᵣᵣ-, -Dᵣ-Aₙ-Bₘ—, -Aₙ-Bₘ-Dᵣ-, -Aₙ-Bₘ-Dᵣ-Dᵣᵣ, -Aₙ-C_{q}—Bₘ, -Aₙ-Dᵣ-Bₘ—, or —C_{q}-Aₙ-Dᵣ-Bₘ-Dᵣᵣ-, wherein A

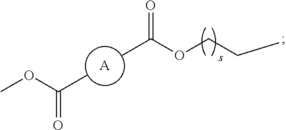

each A can be the same or different; B is

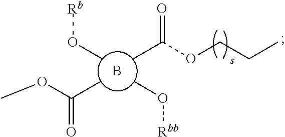

each B can be the same or different; C is

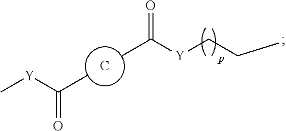

each C can be the same or different; D is

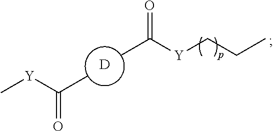

each D can be the same or different; each n, nn, nnn . . . nₖ can be the same or different and are independently selected from 1 to 1,000,000; each m, mm, mmm . . . . ₘ can be the same or different and are independently selected from 1 to 1,000,000; each q, qq, qqq . . . q₁ can be the same or different and are independently selected from 1 to 1,000,000; each r, rr, rrr . . . rₒ can be the same or different and are independently selected from 1 to 1,000,000; k, i, l, and o are 1,000,000; wherein the sum of n, nn, nnn . . . nₖ is 1 to 1,000,000, the sum of m, mm, mmm . . . . mᵢ is 1 to 1,000,000; the sum of q, qq, qqq . . . q₁ is 1 to 1,000,000; and the sum of r, rr, rrr . . . rₒ is 1 to 1,000,000.

For example, the polymer according to the present application can have a structure of formula —C_{q}-Aₙ-Bₘ-Aₙₙ-B—, —B-Aₙ-Bₘ-Dᵣ-Aₙₙ-Bₘₘ-Dᵣᵣ-Aₙₙ-Bₘₘ—, -Aₙ-Bₘ-Dᵣ-C_{q}-A-Bₘₘ-Aₙ, -Dᵣ-B-Aₙ-Bₘ—C_{q}—B-Aₙₙₙ-Bₘₘₘ, -Dᵣ-Dᵣᵣ-Aₙ-Bₘ-Aₙₙ-Bₘₘ-Aₙₙₙ-Bₘₘₘ—C_{q}—, or -Aₙ-Bₘ-Aₙₙ-Bₘₘ- Dᵣ-Dᵣᵣ,-Aₙₙ-Bₘₘₘ-A-, wherein A is

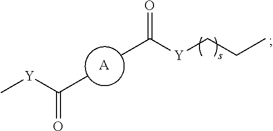

each A can be the same or different; B is

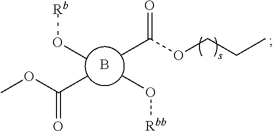

each B can be the same or different; C is

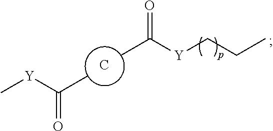

each C can be the same or different; D is

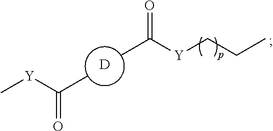

each D can be the same or different; each n, nn, nnn . . . nₖ can be the same or different and are independently selected from 1 to 1,000,000; each m, mm, mmm . . . . mᵢ can be the same or different and are independently selected from 1 to 1,000,000; each q, qq, qqq . . . q₁ can be the same or different and are independently selected from 1 to 1,000,000; each r, rr, rrr . . . rₒ can be the same or different and are independently selected from 1 to 1,000,000; k, i, l, and o are 1,000,000; wherein the sum of n, nn, nnn . . . nₖ is 1 to 1,000,000, the sum of m, mm, mmm . . . mᵢ is 1 to 1,000,000; the sum of q, qq, qqq . . . q₁ is 1 to 1,000,000; and the sum of r, rr, rrr . . . rₒ is 1 to 1,000,000.

According to the present application, p is from 1 to 30. For example, p is from 1 to 25, p is from 1 to 20, p is from 1 to 15, p is from 1 to 10, p is from 2 to 30, p is from 2 to 25, p is from 2 to 20, p is from 2 to 15, p is from 2 to 10. For example, p can be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30.

According to the present application, r is from 1 to 1,000,000. For example, r is from 2 to 1,000,000, r is from 10 to 1,000,000, r is from 20 to 1,000,000, r is from 25 to 1,000,000, r is from 30 to 1,000,000, r is from 40 to 1,000,000, r is from 50 to 1,000,000, r is from 75 to 1,000,000, r is from 100 to 1,000,000, r is from 150 to 1,000,000, r is from 200 to 1,000,000, r is from 250 to 1,000,000, r is from 300 to 1,000,000, r is from 350 to 1,000,000, r is from 400 to 1,000,000, r is from 450 to 1,000,000, r is from 500 to 1,000,000, r is from 550 to 1,000,000, r is from 600 to 1,000,000, r is from 650 to 1,000,000, r is from 700 to 1,000,000, r is from 750 to 1,000,000, r is from 800 to 1,000,000, r is from 850 to 1,000,000, r is from 900 to 1,000,000, r is from 950 to 1,000,000, r is from 1,000 to 1,000,000, r is from 1,500 to 1,000,000, r is from 2,000 to 1,000,000, r is from 3,000 to 1,000,000, r is from 4,000 to 1,000,000, r is from 5,000 to 1,000,000, r is from 6,000 to 1,000,000, r is from 7,000 to 1,000,000, r is from 8,000 to 1,000,000, r is from 9,000 to 1,000,000, r is from 10,000 to 1,000,000, r is from 20,000 to 1,000,000, r is from 30,000 to 1,000,000, r is from 40,000 to 1,000,000, r is from 50,000 to 1,000,000, r is from 100,000 to 1,000,000, r is from 250,000 to 1,000,000, r is from 500,000 to 1,000,000, or r is from 750,000 to 1,000,000. For example, r is from 2 to 850,000, r is from 10 to 700,000, r is from 50 to 600,000, r is from 100 to 500,000, r is from 250 to 500,000, r is from 500 to 500,000, r is from 1,000 to 500,000, r is from 2,000 to 500,000, r is from 10,000 to 500,000, or r is from 100,000 to 500,000.

According to the present application, q is from 1 to 1,000,000. For example, q is from 2 to 1,000,000, q is from 10 to 1,000,000, q is from 20 to 1,000,000, q is from 25 to 1,000,000, q is from 30 to 1,000,000, q is from 40 to 1,000,000, q is from 50 to 1,000,000, q is from 75 to 1,000,000, q is from 100 to 1,000,000, q is from 150 to 1,000,000, q is from 200 to 1,000,000, q is from 250 to 1,000,000, q is from 300 to 1,000,000, q is from 350 to 1,000,000, q is from 400 to 1,000,000, q is from 450 to 1,000,000, q is from 500 to 1,000,000, q is from 550 to 1,000,000, q is from 600 to 1,000,000, q is from 650 to 1,000,000, q is from 700 to 1,000,000, q is from 750 to 1,000,000, q is from 800 to 1,000,000, q is from 850 to 1,000,000, q is from 900 to 1,000,000, q is from 950 to 1,000,000, q is from 1,000 to 1,000,000, q is from 1,500 to 1,000,000, q is from 2,000 to 1,000,000, q is from 3,000 to 1,000,000, q is from 4,000 to 1,000,000, q is from 5,000 to 1,000,000, q is from 6,000 to 1,000,000, q is from 7,000 to 1,000,000, q is from 8,000 to 1,000,000, q is from 9,000 to 1,000,000, q is from 10,000 to 1,000,000, q is from 20,000 to 1,000,000, q is from 30,000 to 1,000,000, q is from 40,000 to 1,000,000, q is from 50,000 to 1,000,000, q is from 100,000 to 1,000,000, q is from 250,000 to 1,000,000, q is from 500,000 to 1,000,000, or q is from 750,000 to 1,000,000. For example, q is from 2 to 850,000, q is from 10 to 700,000, q is from 50 to 600,000, q is from 100 to 500,000, q is from 250 to 500,000, q is from 500 to 500,000, q is from 1,000 to 500,000, q is from 2,000 to 500,000, q is from 10,000 to 500,000, or q is from 100,000 to 500,000.

In one embodiment, the polymer is an alternating copolymer.

In another embodiment, the polymer is a random copolymer.

In another embodiment, the polymer is a statistical copolymer.

In yet another embodiment, the polymer is a block copolymer.

In some embodiments, the polymer has the structure of Formula (I):

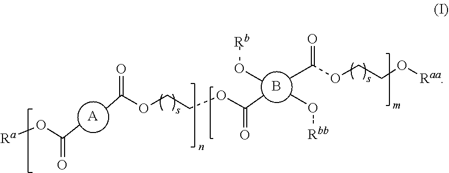

In some embodiments, the polymer has the structure of Formula (Ia):
wherein

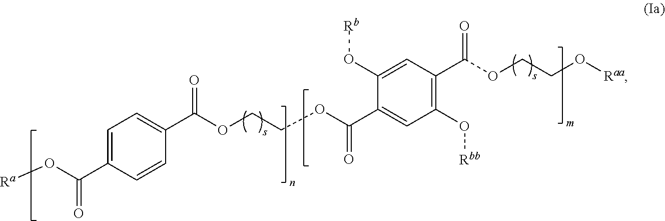

R^{a} and R^{aa} are independently selected from —H, —CH₃, or —CH₂—CH₂—OH; and
R^{b} and R^{bb} are independently selected from —H,

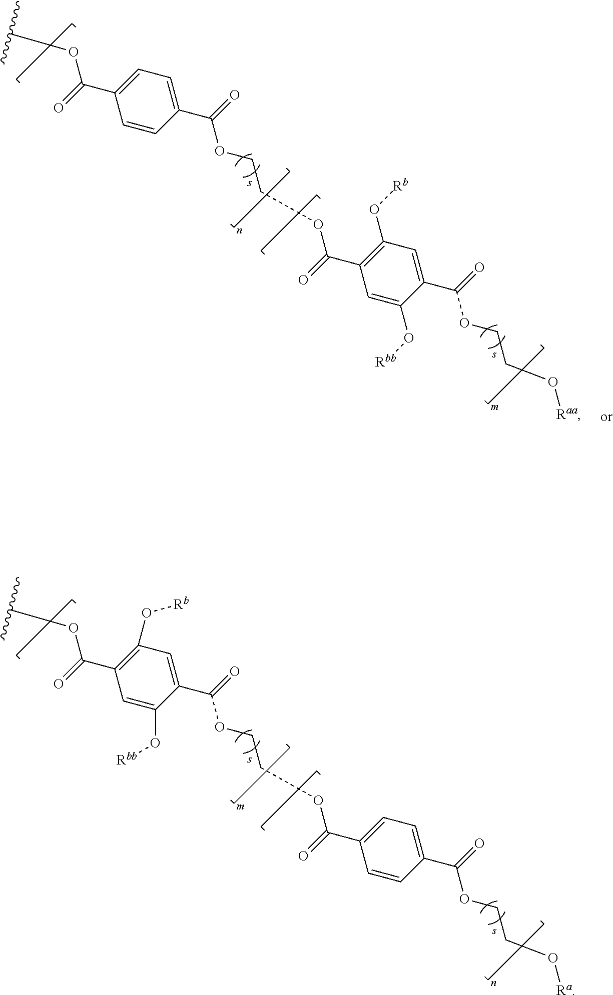

In some embodiments, the polymer has the structure of Formula (Ib):

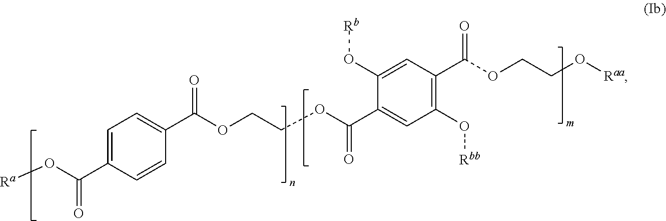

R^{a} and R^{aa} are independently selected from —H, —CH₃, or —CH₂—CH₂—OH; and
R^{b} and R^{bb} are independently selected from —H,

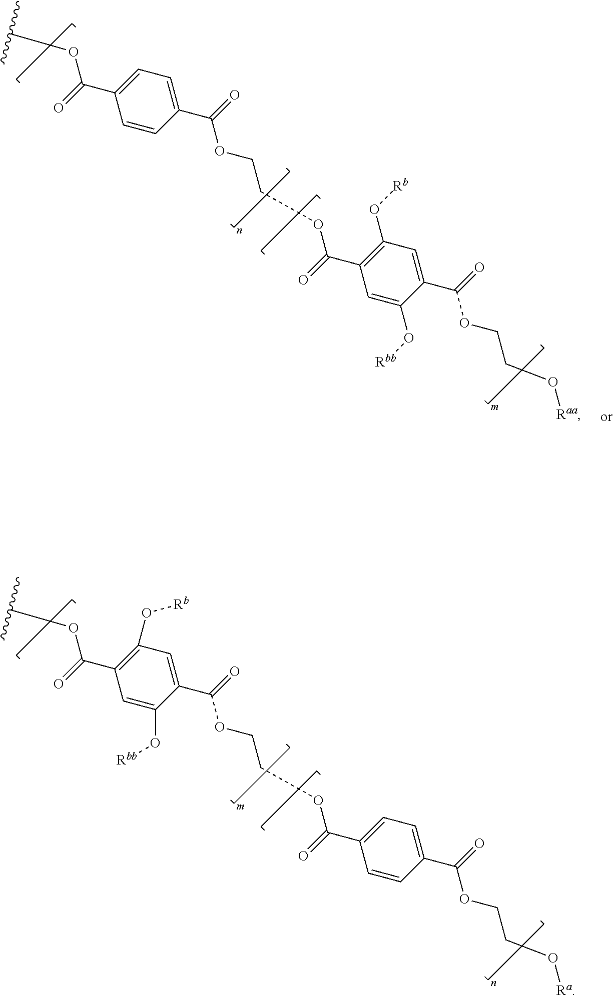

According to the present application, the polymer can have a number average molecular weight (Mₙ) above 1 kDa, above 2 kDa, above 3 kDa, above 4 kDa, above 5 kDa, above 6 kDa, above 7 kDa, above 8 kDa, above 9 kDa, above 10 kDa, above 11 kDa, above 12 kDa, above 13 kDa, above 14 kDa, above 15 kDa, above 16 kDa, above 17 kDa, above 18 kDa, above 19 kDa, above 20 kDa, above 21 kDa, above 22 kDa, above 23 kDa, above 24 kDa, above 25 kDa, above 26 kDa, above 27 kDa, above 28 kDa, above 29 kDa, or above 30 kDa.

According to the present application, the polymer can have a number average molecular weight (Mₙ) ranging from 0.1 kDa to 200 kDa. For example, the polymer can have a number average molecular weight (Mₙ) from 0.1 kDa to 40 kDa, from 0.5 kDa to 35 kDa, from 1 kDa to 35 kDa, from 2 kDa to 30 kDa, from 3 kDa to 30 kDa, from 4 kDa to 30 kDa, from 5 kDa to 30 kDa, from 6 kDa to 30 kDa, from 7 kDa to 30 kDa, from 8 kDa to 30 kDa, from 9 kDa to 30 kDa, from 10 kDa to 30 kDa, from 11 kDa to 30 kDa, from 12 kDa to 30 kDa, from 13 kDa to 30 kDa, from 14 kDa to 30 kDa, from 15 kDa to 30 kDa, from 2 kDa to 20 kDa, from 3 kDa to 20 kDa, from 4 kDa to 20 kDa, from 5 kDa to 20 kDa, from 6 kDa to 20 kDa, from 7 kDa to 20 kDa, from 8 kDa to 20 kDa, from 9 kDa to 20 kDa, from 10 kDa to 20 kDa, from 11 kDa to 20 kDa, from 12 kDa to 20 kDa, from 13 kDa to 20 kDa, from 14 kDa to 20 kDa, from 15 kDa to 20 kDa, from 2 kDa to 15 kDa, from 3 kDa to 15 kDa, from 4 kDa to 15 kDa, from 5 kDa to 15 kDa, from 6 kDa to 15 kDa, from 7 kDa to 15 kDa, from 8 kDa to 15 kDa, from 9 kDa to 15 kDa, from 10 kDa to 15 kDa, from 1 kDa to 10 kDa, from 2 kDa to 10 kDa, from 3 kDa to 10 kDa, from 4 kDa to 10 kDa, or from 5 kDa to 10 kDa.

The polymers of the present application can be prepared according to the Schemes 1-3 described below.

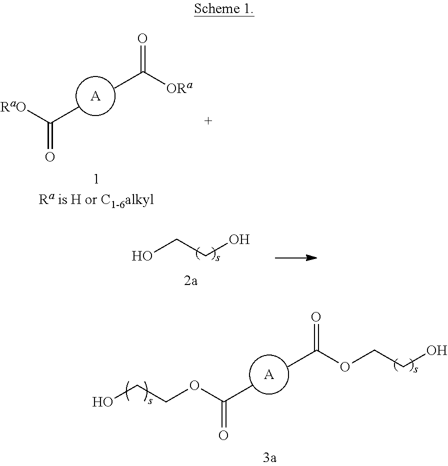

Initial esterification/transesterification reaction between compound 1 and diol 2a leads to formation of compound 3a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

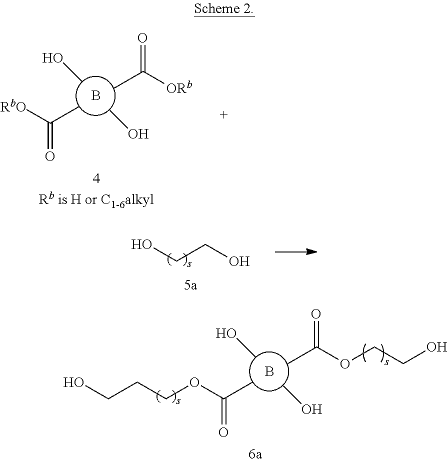

The reaction between compounds 4 and diol 5a leads to formation of compound 6a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

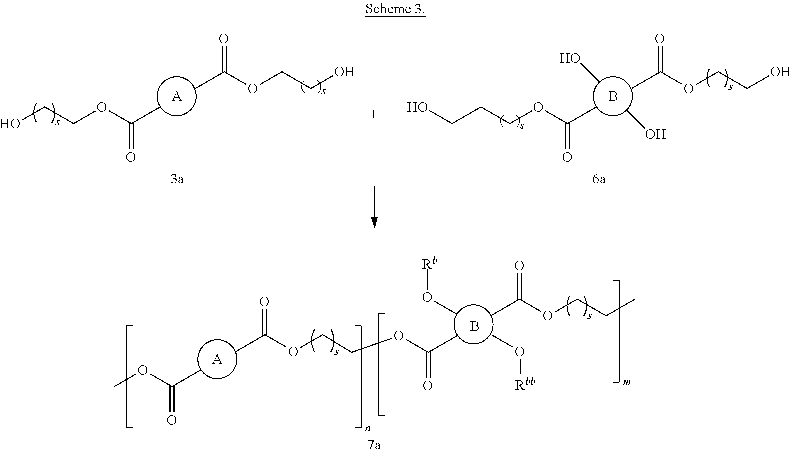

R^{b} and R^{bb} are independently selected from —H,

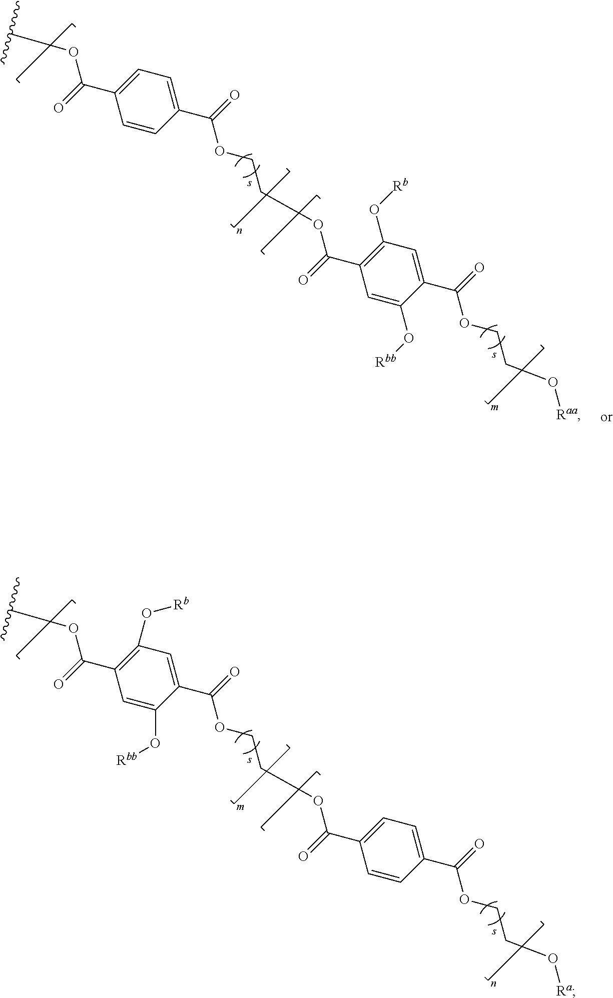

and
R^{a} and R^{aa} are independently selected from —H, —CH₃, or —CH₂—CH₂—OH.

Polymers of formula 7a can be prepared by an initial polycondensation reaction (oligomer formation) between compounds 3a and 6a followed by a polymerization step (polymer formation) (Scheme 3). The initial polycondensation reaction (oligomer formation) can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 0° C. to 150° C., at a temperature of 40° C. to 90° C., or at a temperature of 50° C. to 70° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 20° C. to 400° C., at a temperature of 100° C. to 300° C., or at a temperature of 200° C. to 300° C.

Another aspect of the present application relates to a process for preparation of a cleavable polymer comprising one or more repeat units containing monomer A and one or more repeat units containing monomer B. This process includes:
providing a compound having the structure of Formula (II):

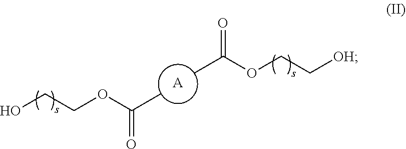

providing a compound having the structure of Formula (III):

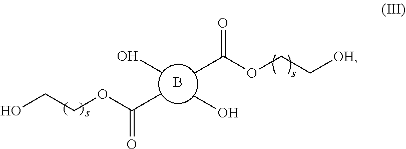

reacting the compound of formula (II) and the compound of formula (III) under conditions effective to produce the polymer,
wherein

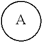

is selected from the group consisting of arylene, heteroarylene, heterocyclene, and C₅₋₈ cycloalkylene;

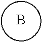

is selected from the group consisting of phenylene, furanylene, thiphenylene, and naphtanylene, wherein phenylene, furanylene, thiphenylene, and naphtanylene can be optionally substituted from 1 to 2 times with R;
R is —OR¹, —NHR², —NO₂, or halogen;
R¹ is H, C₁₋₃₀ alkyl, or aryl;
R² is —C(O)—R¹; and
s is 1 to 30.

Any of the above described polymers can be prepared using this aspect of the invention. In some embodiments, the polymer has the structure of Formula (I), as described above. In some embodiments, the polymer has the structure of Formula (Ia), as described above. In some embodiments, the polymer has the structure of Formula (Ib), as described above.

In some embodiments, the step of reacting the compound of Formula (II) with the compound of Formula (III) comprises heating the compound of Formula (II) with the compound of Formula (III) in a reaction vessel.

In some embodiments, the compound of Formula (II) and the compound of Formula (III) are heated in a reaction vessel under vacuum.

In another embodiment, the compound of formula (II) is reacted with the compound of formula (III) at a temperature above 100° C. Preferably, the compound of formula (II) is reacted with the compound of formula (III) at a temperature from about 100° C. to about 500° C., from about 150° C. to about 450°, from about 150° C. to about 400°, from about 200° C. to about 350°, from about 200° C. to about 300°, from about 250° C. to about 300°, or from about 200° C. to about 350°. More preferably, the compound of formula (II) is reacted with the compound of formula (III) at a temperature from about 180° C. to about 350° C., from about 190° C. to about 340° C., from about 190° C. to about 330° C., from about 190° C. to about 320° C., from about 190° C. to about 310° C., from about 200° C. to about 300° C., from about 210° C. to about 300° C., from about 210° C. to about 290° C., from about 220° C. to about 290° C., from about 220° C. to about 280° C., from about 230° C. to about 280° C., from about 230° C. to about 270° C., from about 240° C. to about 270° C., from about 250° C. to about 270° C., or from about 250° C. to about 260° C.

In some embodiments, the compound of Formula (II) and the compound of Formula (III) are heated in the presence of a catalyst.

The catalyst that can be used for reacting the compound of Formula (II) with the compound of Formula (III) can be selected from the group consisting of antimony-containing compounds (e.g., antimony(III) oxide), germanium-containing compounds, titanium-containing compounds, cobalt-containing compounds, tin containing compounds, aluminum, aluminum salts, alkaline salts, alkali salts, phosphorous-containing compounds, phosphorous-containing anions, sulfur-containing compounds, sulfur-containing anions, and combinations thereof.

In some embodiments, the compound of Formula (II) and the compound of Formula (III) are heated in the presence of a thermal stabilizer.

A variety of phosphous containing compound can be used as the thermal stabilizer such as phosphoric esters, phosphorus esters, other phosphoric esters, phosphoric acid, polyphosphoric acid, or a combination thereof. Suitable phosphoric esters that can be used include, but are not limited to, trimethyl phosphate, triehtyl phosphate, tri-n-butyl phosphate, trioctyl phosphate, and triphenyl phosphate. Suitable phosphorus esters that can be used include, but are not limited to, triphenyl phosphite, trisdodecyl phosphite, and trisnonylphenyl phosphite. Suitable other phosphoric esters that can be used include, but are not limited to, monomethyl phosphate, dimethyl phosphate, monoethyl phosphate, diethyl phosphate, monoisopropyl phosphate, diisopropyl phosphate, dibutyl phosphate, monobutyl phosphate, and dioctyl phosphate.

According to the present application, the compound of formula (II) and the compound of formula (III) can be reacted in any suitable solvent or without the solvent. This reaction can be performed in water, methanol (MeOH), ethanol (EtOH), isopropanol (i-PrOH), dimethylformamide (DMF), acetone, methyl ethyl ketone (MEK), ethyl acetate, THF, or diethyl ether or other such solvents or in a mixture of such solvents. Preferably, the compound of formula (II) and the compound of formula (III) are reacted in the absence of solvent.

In some embodiments, the step of providing the compound of Formula (II) comprises: providing a compound of Formula (IV):

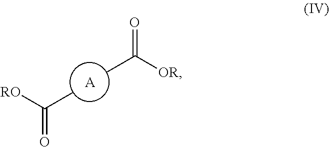

wherein R is H or C₁₋₆ alkyl;
providing a compound of Formula (V): H/OH

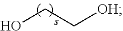

and reacting the compound of Formula (IV) and the compound of Formula (V) under conditions effective to produce the compound of Formula (II).

In some embodiments, the compound of Formula (IV) is reacted with the compound of Formula (V) in the presence of a catalyst.

The catalyst that can be used during the reaction between the compound of Formula (IV) and the compound of Formula (V) can be selected from the group consisting of sulfur containing catalysts, tin containing catalysts, zirconium containing catalysts, titanium containing catalysts, aluminum containing catalysts, iron containing catalysts, tungsten containing catalysts, and a combination thereof. Suitable tin containing catalysts that can be used include tin oxides or supported heterogeneous tin oxides. Suitable sulfur containing catalysts that can be used include sulfuric acid (H₂SO₄), tolulene sulfonic acid, or amberlyst.

In some embodiments, the step of reacting the compound of Formula (IV) and the compound of Formula (V) is conducted by heating the compound of Formula (IV) with the compound of Formula (V) in a reaction vessel.

In some embodiments, the compound of Formula (IV) and the compound of Formula (V) are heated under inert atmosphere.

In some embodiments, the compound of Formula (IV) and the compound of Formula (V) are heated under pressure of 0.0001 to 25 bar; 0.0005 to 20 bar; 0.001 to 19 bar; 0.001 to 18 bar; 0.001 to 17 bar; 0.001 to 16 bar; 0.001 to 15 bar; 0.001 to 14 bar; 0.001 to 13 bar; 0.001 to 12 bar; 0.001 to 11 bar; or 0.001 to 10 bar.

In some embodiments, the compound of Formula (III) is provided by providing a compound of Formula (VI);

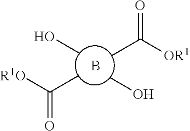

wherein R¹ is H or C₁₋₆ alkyl;
providing a compound of Formula (V):

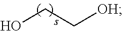

and
reacting the compound of Formula (VI) and the compound of Formula (V) under conditions effective to produce the compound of Formula (III).

In some embodiments, the compound of Formula (VI) and the compound of Formula (V) are reacted in the presence of a catalyst.

The catalyst that can be used during the reaction between the compound of Formula (VI) and the compound of Formula (V) can be selected from the group consisting of sulfur containing catalysts, tin containing catalysts, zirconium containing catalysts, titanium containing catalysts, aluminum containing catalysts, iron containing catalysts, tungsten containing catalysts, and a combination thereof. Suitable tin containing catalysts that can be used include tin oxides or supported heterogeneous tin oxides. Suitable sulfur containing catalysts that can be used include sulfuric acid (H₂SO₄), tolulene sulfonic acid, or amberlyst.

In some embodiments, the step of reacting the compound of Formula (VI) and the compound of Formula (V) is conducted by heating the compound of Formula (VI) with the compound of Formula (V) in a reaction vessel.

In some embodiments, the compound of Formula (VI) and the compound of Formula (V) are heated under inert atmosphere.

In some embodiments, the compound of Formula (VI) and the compound of Formula (V) are heated under pressure of 0.0001 to 25 bar; 0.0005 to 20 bar; 0.001 to 19 bar; 0.001 to 18 bar; 0.001 to 17 bar; 0.001 to 16 bar; 0.001 to 15 bar; 0.001 to 14 bar; 0.001 to 13 bar; 0.001 to 12 bar; 0.001 to 11 bar; or 0.001 to 10 bar.

Another aspect of the present application relates to a cleavable polymer comprising one or more repeat units containing monomer C and one or more repeat units containing monomer D, wherein
repeat unit containing monomer C is;

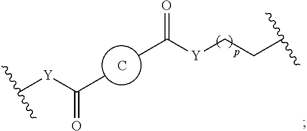

repeat unit containing monomer D is

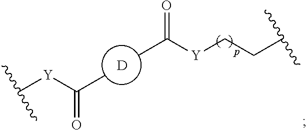

each Y is independently O or NH;

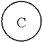

is arylene or C₂₋₃₀ alkylene, wherein arylene and C₂₋₃₀ alkylene can be optionally substituted from 1 to 3 times with R³;

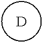

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to30.

In some embodiments,

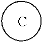

is arylene or C₂₋₃₀ alkylene, wherein C₂₋₃₀ alkylene can be optionally substituted from 1 to 3 times with R³.

In some embodiments, the repeat unit containing monomer C is

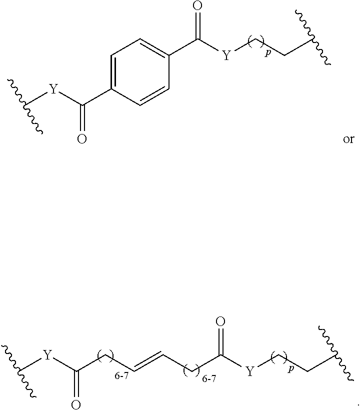

In some embodiments, the repeat unit containing monomer D is selected from the group consisting of

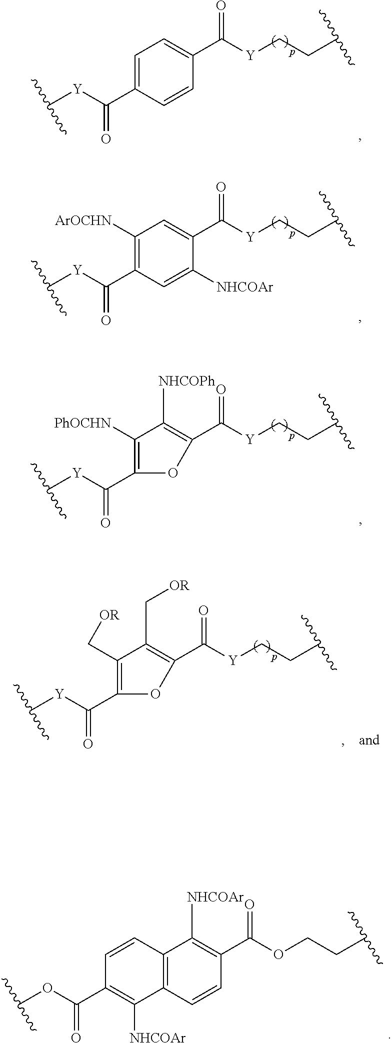

Another aspect of the present application relates to a polymer comprising a moiety of formula:

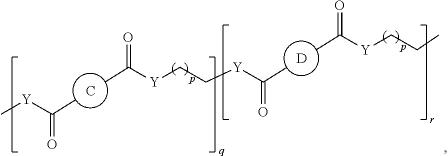

wherein
each Y is independently O or NH;

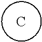

is arylene or C₂₋₃₀ alkylene, wherein arylene and C₂₋₃₀ alkylene can be optionally substituted from 1 to 3 times with R³;

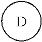

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30;
q is 1 to 1,000,000; and
r is 1 to 1,000,000.

In some embodiments, the polymer according to the present application:

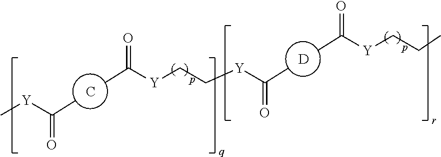

can further have one or more of the polymer blocks of formula

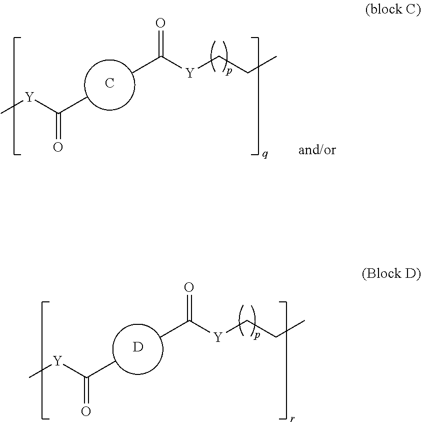

attached to the end of either or both sides of the polymer chain and

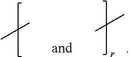

For example, the polymer according to the present application can have a structure of formula —C_{q}-Dᵣ-, —C_{q}-Dᵣ-C_{qq}-Dᵣᵣ-, —C_{q}-Dᵣ-C_{qq}-Dᵣᵣ-C_{qqq}-Dᵣᵣᵣ-, -D-C_{q}-Dᵣ-C_{qq}-Dᵣᵣ-C_{qqq}-Dᵣ—, -D- C_{q}-Dᵣ-C-Dᵣᵣ-C_{qqq}-Dₘ-, -D-C_{q}-Dᵣ-C-D-C_{qqq}-Dᵣᵣᵣ-, -Dᵣ-C_{q}-Dᵣ-C_{qq}-Dᵣᵣ-C_{qqq}-Dᵣᵣᵣ—, or-C_{q}-Dᵣ-C_{qq}-Dᵣᵣ-C_{qqq}-Dₘ-C—, wherein C is

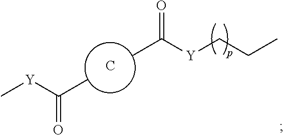

each C can be the same or different; D is

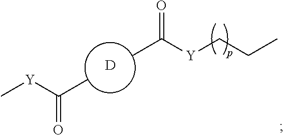

each D can be the same or different; each q, qq, qqq . . . q₁ can be the same or different and are independently selected from 1 to 1,000,000; each r, rr, rrr . . . rₒ can be the same or different and are independently selected from 1 to 1,000,000; 1 and o are 1,000,000; wherein the sum of q, qq, qqq . . . q₁ is 1 to 1,000,000; and the sum of r, rr, rrr . . . rₒ is 1 to 1,000,000.

According to the present application, r is from 1 to 1,000,000. For example, r is from 2 to 1,000,000, r is from 10 to 1,000,000, r is from 20 to 1,000,000, r is from 25 to 1,000,000, r is from 30 to 1,000,000, r is from 40 to 1,000,000, r is from 50 to 1,000,000, r is from 75 to 1,000,000, r is from 100 to 1,000,000, r is from 150 to 1,000,000, r is from 200 to 1,000,000, r is from 250 to 1,000,000, r is from 300 to 1,000,000, r is from 350 to 1,000,000, r is from 400 to 1,000,000, r is from 450 to 1,000,000, r is from 500 to 1,000,000, r is from 550 to 1,000,000, r is from 600 to 1,000,000, r is from 650 to 1,000,000, r is from 700 to 1,000,000, r is from 750 to 1,000,000, r is from 800 to 1,000,000, r is from 850 to 1,000,000, r is from 900 to 1,000,000, r is from 950 to 1,000,000, r is from 1,000 to 1,000,000, r is from 1,500 to 1,000,000, r is from 2,000 to 1,000,000, r is from 3,000 to 1,000,000, r is from 4,000 to 1,000,000, r is from 5,000 to 1,000,000, r is from 6,000 to 1,000,000, r is from 7,000 to 1,000,000, r is from 8,000 to 1,000,000, r is from 9,000 to 1,000,000, r is from 10,000 to 1,000,000, r is from 20,000 to 1,000,000, r is from 30,000 to 1,000,000, r is from 40,000 to 1,000,000, r is from 50,000 to 1,000,000, r is from 100,000 to 1,000,000, r is from 250,000 to 1,000,000, r is from 500,000 to 1,000,000, or r is from 750,000 to 1,000,000. For example, r is from 2 to 850,000, r is from 10 to 700,000, r is from 50 to 600,000, r is from 100 to 500,000, r is from 250 to 500,000, r is from 500 to 500,000, r is from 1,000 to 500,000, r is from 2,000 to 500,000, r is from 10,000 to 500,000, or r is from 100,000 to 500,000.

According to the present application, q is from 1 to 1,000,000. For example, q is from 2 to 1,000,000, q is from 10 to 1,000,000, q is from 20 to 1,000,000, q is from 25 to 1,000,000, q is from 30 to 1,000,000, q is from 40 to 1,000,000, q is from 50 to 1,000,000, q is from 75 to 1,000,000, q is from 100 to 1,000,000, q is from 150 to 1,000,000, q is from 200 to 1,000,000, q is from 250 to 1,000,000, q is from 300 to 1,000,000, q is from 350 to 1,000,000, q is from 400 to 1,000,000, q is from 450 to 1,000,000, q is from 500 to 1,000,000, q is from 550 to 1,000,000, q is from 600 to 1,000,000, q is from 650 to 1,000,000, q is from 700 to 1,000,000, q is from 750 to 1,000,000, q is from 800 to 1,000,000, q is from 850 to 1,000,000, q is from 900 to 1,000,000, q is from 950 to 1,000,000, q is from 1,000 to 1,000,000, q is from 1,500 to 1,000,000, q is from 2,000 to 1,000,000, q is from 3,000 to 1,000,000, q is from 4,000 to 1,000,000, q is from 5,000 to 1,000,000, q is from 6,000 to 1,000,000, q is from 7,000 to 1,000,000, q is from 8,000 to 1,000,000, q is from 9,000 to 1,000,000, q is from 10,000 to 1,000,000, q is from 20,000 to 1,000,000, q is from 30,000 to 1,000,000, q is from 40,000 to 1,000,000, q is from 50,000 to 1,000,000, q is from 100,000 to 1,000,000, q is from 250,000 to 1,000,000, q is from 500,000 to 1,000,000, or q is from 750,000 to 1,000,000. For example, q is from 2 to 850,000, q is from 10 to 700,000, q is from 50 to 600,000, q is from 100 to 500,000, q is from 250 to 500,000, q is from 500 to 500,000, q is from 1,000 to 500,000, q is from 2,000 to 500,000, q is from 10,000 to 500,000, or q is from 100,000 to 500,000.

In some embodiments, the polymer according to the present application:

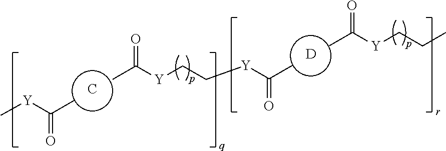

can further have one or more of the polymer blocks of formula

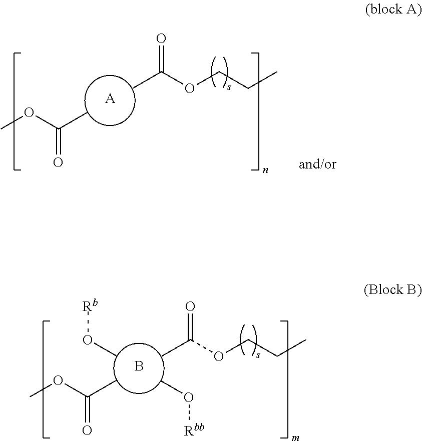

attached to the end of either or both sides of the polymer chain and or in

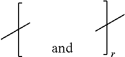

or in between

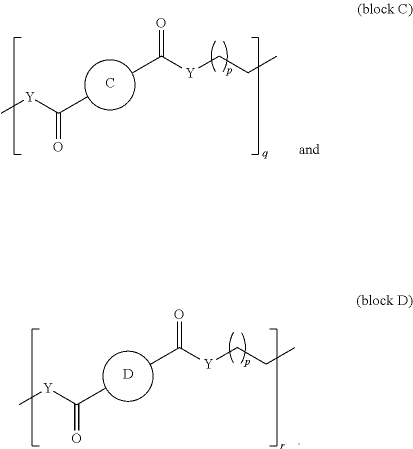

For example, the polymer according to the present application can have a structure of formula -Aₙ-C_{q}-Dᵣ-, -Aₙ-C_{q}-Dᵣ-Aₙₙ-, -Aₙ-Aₙₙ-C_{q}-Dᵣ-, -Aₙ-C_{q}-Dᵣ-Bₘ—, —C_{q}-Dᵣ-Bₘ-Bₘₘ—, —Bₘ—C_{q}-Dᵣ-, —C_{q}-Dᵣ-Bₘ—, —C_{q}-Dᵣ-Bₘ-Bₘₘ—, —C_{q}-Aₙ-Dᵣ-, —C_{q}—Bₘ-Dᵣ-, or -Aₙ-C_{q}—Bₘ-Dᵣ-Bₘₘwherein A is

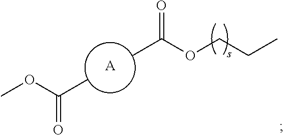

each A can be the same or different; B is

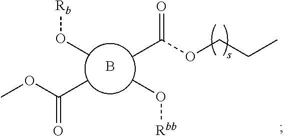

each B can be the same or different; C is

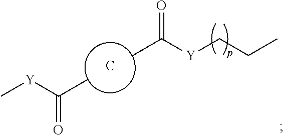

each C can be the same or different; D is

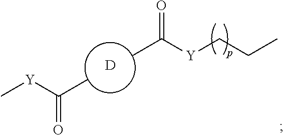

each D can be the same or different; each n, nn, nnn . . . nₖ can be the same or different and are independently selected from 1 to 1,000,000; each m, mm, mmm . . . . mᵢ can be the same or different and are independently selected from 1 to 1,000,000; each q, qq, qqq . . . q₁ can be the same or different and are independently selected from 1 to 1,000,000; each r, rr, rrr . . . rₒ can be the same or different and are independently selected from 1 to 1,000,000; k, i, l, and o are 1,000,000; wherein the sum of n, nn, nnn . . . nₖ is 1 to 1,000,000, the sum of m, mm, mmm . . . . mᵢ is 1 to 1,000,000; the sum of q, qq, qqq . . . q₁ is 1 to 1,000,000; and the sum of r, rr, rrr . . . rₒ is 1 to 1,000,000.

For example, the polymer according to the present application can have a structure of formula -Aₙ-C_{q}-Dᵣ-C_{qq}-Dᵣᵣ-, —B—C_{q}-Dᵣ-C_{qq}-Dᵣᵣ-Aₙ-Bₘ, —C_{q}-Dᵣ-Aₙ-Bₘ—C-Dᵣᵣ-C_{qqq}—, —Bₘ—C_{q}-Dᵣ-C_{qq}-Dᵣᵣ-, —Bₘ-Bₘₘ—C_{q}-Dᵣ-C_{qq}-Dᵣᵣ, or —C_{q}-Dᵣ-C_{qq}-Dᵣᵣ-Bₘ-Bₘₘ—C_{qqq}-Dᵣ-A-, wherein A is

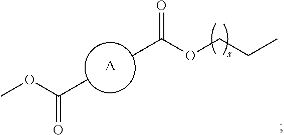

each A can be the same or different; B is

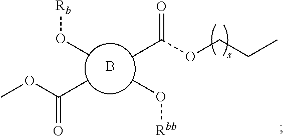

each B can be the same or different; C is

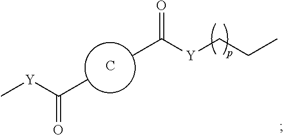

each C can be the same or different; D is;

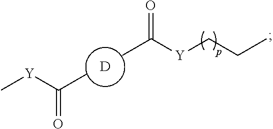

each D can be the same or different; each n, nn, nnn . . . nₖ can be the same or different and are independently selected from 1 to 1,000,000; each m, mm, mmm . . . . mᵢ can be the same or different and are independently selected from 1 to 1,000,000; each q, qq, qqq . . . q₁ can be the same or different and are independently selected from 1 to 1,000,000; each r, rr, rrr . . . rₒ can be the same or different and are independently selected from 1 to 1,000,000; k, i, l, and o are 1,000,000; wherein the sum of n, nn, nnn . . . nₖ is 1 to 1,000,000, the sum of m, mm, mmm . . . . mᵢ is 1 to 1,000,000; the sum of q, qq, qqq . . . q₁ is 1 to 1,000,000; and the sum of r, rr, rrr . . . rₒ is 1 to 1,000,000.

According to the present application, n is from 1 to 1,000,000. For example, n is from 2 to 1,000,000, n is from 10 to 1,000,000, n is from 20 to 1,000,000, n is from 25 to 1,000,000, n is from 30 to 1,000,000, n is from 40 to 1,000,000, n is from 50 to 1,000,000, n is from 75 to 1,000,000, n is from 100 to 1,000,000, n is from 150 to 1,000,000, n is from 200 to 1,000,000, n is from 250 to 1,000,000, n is from 300 to 1,000,000, n is from 350 to 1,000,000, n is from 400 to 1,000,000, n is from 450 to 1,000,000, n is from 500 to 1,000,000, n is from 550 to 1,000,000, n is from 600 to 1,000,000, n is from 650 to 1,000,000, n is from 700 to 1,000,000, n is from 750 to 1,000,000, n is from 800 to 1,000,000, n is from 850 to 1,000,000, n is from 900 to 1,000,000, n is from 950 to 1,000,000, n is from 1,000 to 1,000,000, n is from 1,500 to 1,000,000, n is from 2,000 to 1,000,000, n is from 3,000 to 1,000,000, n is from 4,000 to 1,000,000, n is from 5,000 to 1,000,000, n is from 6,000 to 1,000,000, n is from 7,000 to 1,000,000, n is from 8,000 to 1,000,000, n is from 9,000 to 1,000,000, n is from 10,000 to 1,000,000, n is from 20,000 to 1,000,000, n is from 30,000 to 1,000,000, n is from 40,000 to 1,000,000, n is from 50,000 to 1,000,000, n is from 100,000 to 1,000,000, n is from 250,000 to 1,000,000, n is from 500,000 to 1,000,000, n is from 750,000 to 1,000,000. For example, n is from 2 to 850,000, n is from 10 to 700,000, n is from 50 to 600,000, n is from 100 to 500,000, n is from 250 to 500,000, n is from 500 to 500,000, n is from 1,000 to 500,000, n is from 2,000 to 500,000, n is from 10,000 to 500,000, n is from 100,000 to 500,000.

According to the present application, m is from 1 to 1,000,000. For example, m is from 2 to 1,000,000, m is from 10 to 1,000,000, m is from 20 to 1,000,000, m is from 25 to 1,000,000, m is from 30 to 1,000,000, m is from 40 to 1,000,000, m is from 50 to 1,000,000, m is from 75 to 1,000,000, m is from 100 to 1,000,000, m is from 150 to 1,000,000, m is from 200 to 1,000,000, m is from 250 to 1,000,000, m is from 300 to 1,000,000, m is from 350 to 1,000,000, m is from 400 to 1,000,000, m is from 450 to 1,000,000, m is from 500 to 1,000,000, m is from 550 to 1,000,000, m is from 600 to 1,000,000, m is from 650 to 1,000,000, m is from 700 to 1,000,000, m is from 750 to 1,000,000, m is from 800 to 1,000,000, m is from 850 to 1,000,000, m is from 900 to 1,000,000, m is from 950 to 1,000,000, m is from 1,000 to 1,000,000, m is from 1,500 to 1,000,000, m is from 2,000 to 1,000,000, m is from 3,000 to 1,000,000, m is from 4,000 to 1,000,000, m is from 5,000 to 1,000,000, m is from 6,000 to 1,000,000, m is from 7,000 to 1,000,000, m is from 8,000 to 1,000,000, m is from 9,000 to 1,000,000, m is from 10,000 to 1,000,000, m is from 20,000 to 1,000,000, m is from 30,000 to 1,000,000, m is from 40,000 to 1,000,000, m is from 50,000 to 1,000,000, m is from 100,000 to 1,000,000, m is from 250,000 to 1,000,000, m is from 500,000 to 1,000,000, m is from 750,000 to 1,000,000. For example, m is from 2 to 850,000, m is from 10 to 700,000, m is from 50 to 600,000, m is from 100 to 500,000, m is from 250 to 500,000, m is from 500 to 500,000, m is from 1,000 to 500,000, m is from 2,000 to 500,000, m is from 10,000 to 500,000, m is from 100,000 to 500,000.

In one embodiment, the polymer is an alternating copolymer.

In another embodiment, the polymer is a random copolymer.

In another embodiment, the polymer is a statistical copolymer.

In yet another embodiment, the polymer is a block copolymer.

In some embodiments, the polymer has the structure of Formula (VII):

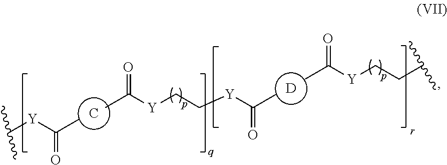

wherein

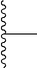

is a terminal group of the polymer.

In some embodiments, Y is NH. In other embodiments, Y is O.

In some embodiments, the polymer has the structure selected from the group consisting of:

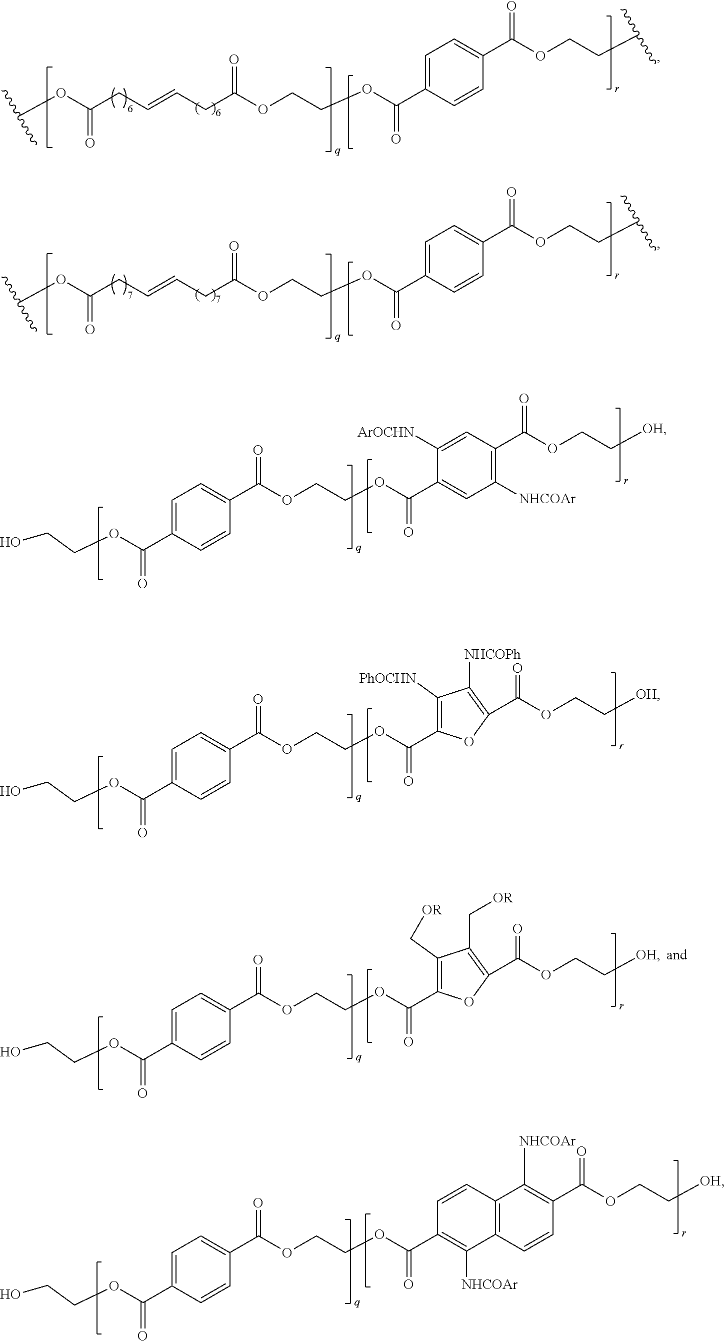

wherein
q and r represent number average degrees of polymerization for repeat units and are distributed throughout the polymer chain in a statistically defined manner;
q is 1 to 1,000,000; and
r is 1 to 1,000,000.

The polymers of the present application can also be prepared according to the Schemes 4-11 described below.

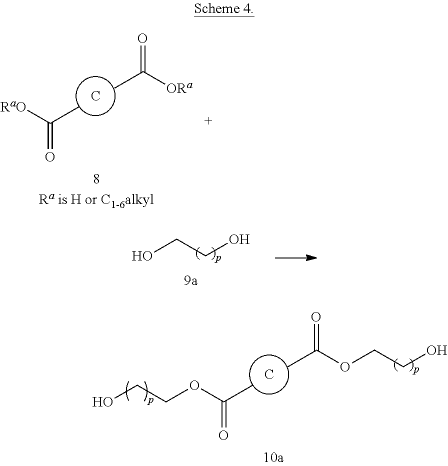

Initial esterification/transesterification reaction between compound 8 and diol 9a leads to formation of compound 10a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

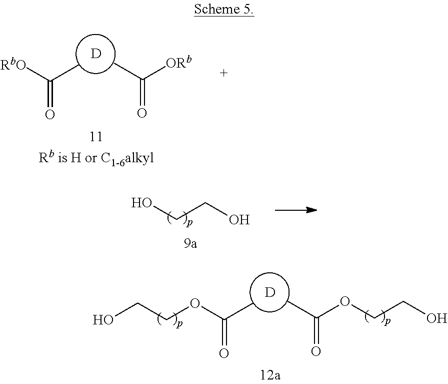

The reaction between compounds 11 and diol 9a leads to formation of compound 12a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

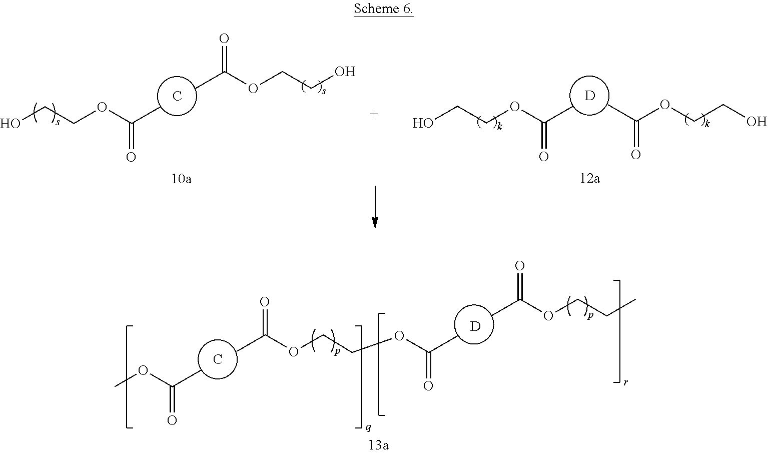

Polymers of formula 13a can be prepared by an initial polycondensation reaction (oligomer formation) between compounds 10a and 12a followed by a polymerization step (polymer formation) (Scheme 6). The initial polycondensation reaction (oligomer formation) can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 0° C. to 150° C., at a temperature of 40° C. to 90° C., or at a temperature of 50° C. to 70° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 20° C. to 400° C., at a temperature of 100° C. to 300° C., or at a temperature of 200° C. to 300° C.

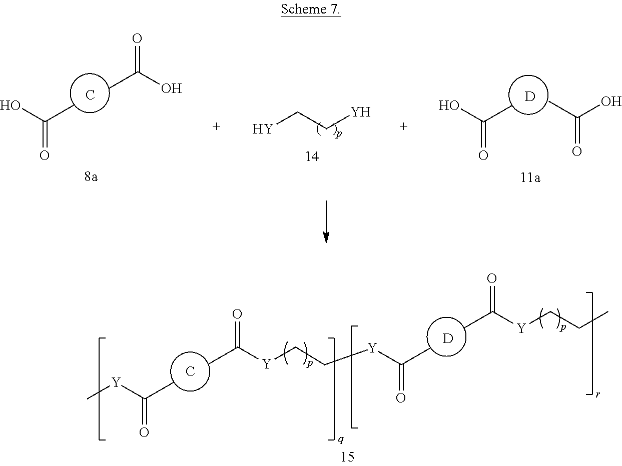

Polymers of formula 15 can be prepared by an initial polycondensation reaction (oligomer formation) between compounds 8a, 11a, and 14 followed by a polymerization step (polymer formation) (Scheme 7). The initial polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

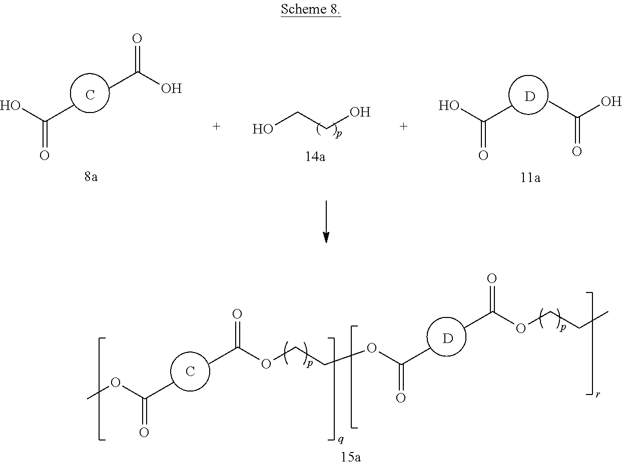

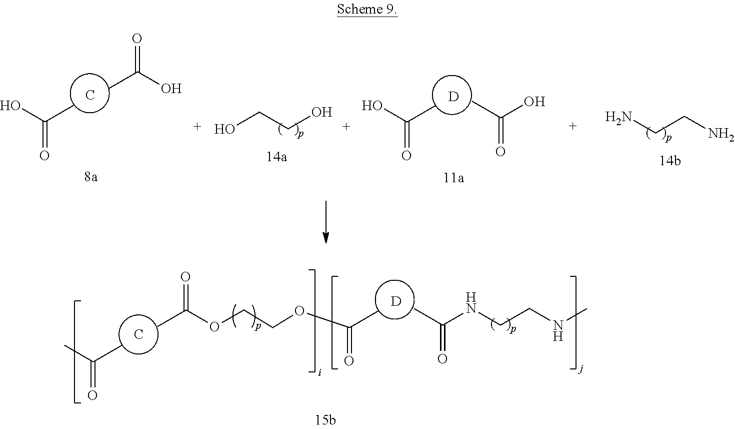

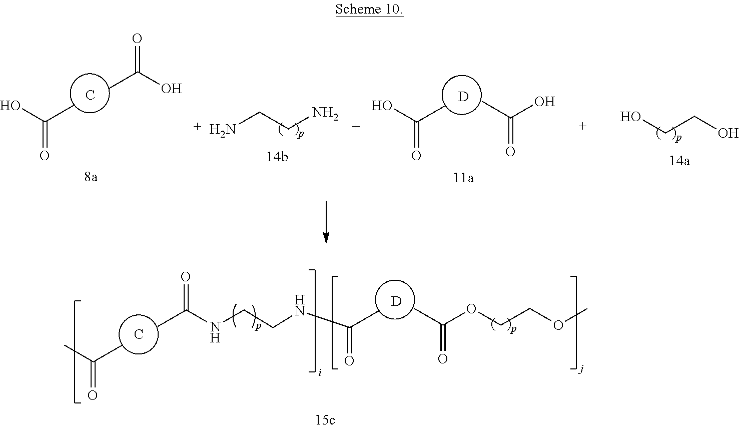

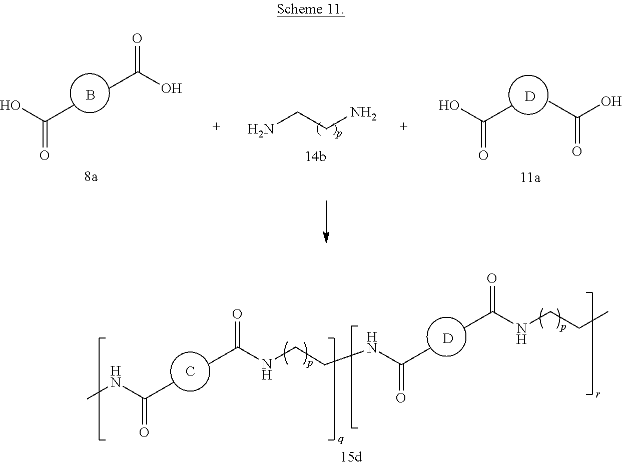

The polymers of formula 15 (15a-15d) can also be prepared by first preparing the salt between acid 8a and the compound of formula 14 (14a or 14b) (salt 1) and acid 11a and the compound of formula 14 (14a or 14b) (salt 2), followed by an initial polycondensation reaction (oligomer formation) and then a polymerization step. The salt formation can be carried out in a variety of solvents, for example in water, methanol (MeOH), ethanol (EtOH), isopropanol (i-PrOH), dimethylformamide (DMF), or other such solvents or in a mixture of such solvents. The salt formation can be carried out at a temperature of 20° C. to 100° C., at a temperature of 20° C. to 75° C., at a temperature of 20° C. to 50° C., at a temperature of 20° C. to 45° C., at a temperature of 20° C. to 40° C., at a temperature of 25° C. to 40° C., at a temperature of 30° C. to 40° C., at a temperature of 35° C. to 40° C., or at a temperature of 30° C. to 45° C. The salt formation can be carried out for 10 min to 24 hours, for 20 min to 20 hours, for 30 min to 18 hours, for 45 min to 12 hours, for 1 hour to 6 hours, or for 1 hour to 3 hours. The polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

Polycondensation reaction and polymer formation step can be performed in the same reaction vessel or different reaction vessels. In some embodiments, the reaction vessel was vented at least once during the process of polycondensation reaction and polymer formation step.

In some embodiments, polycondensation reaction and polymer formation step can be performed under an inert atmosphere (e.g., under a nitrogen atmosphere or an argon atmosphere).

In some embodiments, polycondensation reaction and polymer formation step can be performed under pressure. For example, the polycondensation reaction and polymer formation step can be performed at a pressure for the inert gas from 50 psig to 300 psig, from 75 psig to 250 psig, from 100 psig to 200 psig, or from 125 psig to 200 psig. In other embodiments, polycondensation reaction and polymer formation step can be performed under atmospheric pressure. In other embodiments, the polycondensation reaction and polymer formation step can be performed under vacuum.

Another aspect of the present application relates to a process for preparation of a polymer comprising one or more repeat units containing monomer C and one or more repeat units containing monomer D. This process includes:
providing a compound having the structure of Formula (VIII):

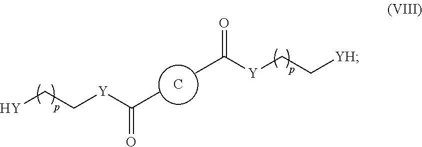

providing a compound having the structure of Formula (IX):

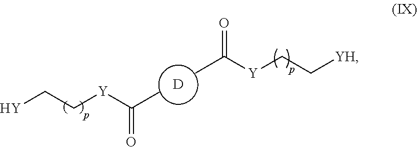

reacting the compound of formula (VIII) and the compound of formula (IX) under conditions effective to produce the polymer,
wherein
each Y is O;

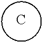

is arylene or C₂₋₃₀ alkylene, wherein arylene and C₂₋₃₀ alkylene can be optionally substituted from 1 to 3 times with R³;

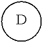

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)k₂—(CH₂)k₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

According to the present application, the compound of formula (VIII) and the compound of formula (IX) can be reacted in any suitable solvent or without the solvent. This reaction can be performed in water, methanol (MeOH), ethanol (EtOH), isopropanol (i-PrOH), dimethylformamide (DMF), acetone, methyl ethyl ketone (MEK), ethyl acetate, THF, or diethyl ether or other such solvents or in a mixture of such solvents. Preferably, the compound of formula (VIII) and the compound of formula (IX) are reacted in the absence of solvent.

In one embodiment, the compound of formula (VIII) is reacted with the compound of formula (IX) in the presence of a catalyst. Suitable catalysts that can be used are catalysts conventionally used in polycondensation reactions, such as oxides or salts of silicon, aluminum, zirconium, titanium, cobalt, and combinations thereof. In some examples, antimony (III) oxide is used as a polycondensation catalyst. Preferably, the catalyst is selected from a group consisting of Sb₂O₃, GeO2, titanium(IV) butoxide, titanium(IV) isopropoxide, di-butyl tin laurate, and SnCl₂.

In another embodiment, the compound of formula (VIII) is reacted with the compound of formula (IX) under vacuum.

In another embodiment, the compound of formula (VIII) is reacted with the compound of formula (IX) at a temperature above 100° C. Preferably, the compound of formula (VIII) is reacted with the compound of formula (IX) at a temperature from about 100° C. to about 500° C., from about 150° C. to about 450°, from about 150° C. to about 400°, from about 200° C. to about 350°, from about 200° C. to about 300°, from about 250° C. to about 300°, or from about 200° C. to about 350⁰. More preferably, the compound of formula (VIII) is reacted with the compound of formula (IX) at a temperature from about 180° C. to about 350° C., from about 190° C. to about 340° C., from about 190° C. to about 330° C., from about 190° C. to about 320° C., from about 190° C. to about 310° C., from about 200° C. to about 300° C., from about 210° C. to about 300° C., from about 210° C. to about 290° C., from about 220° C. to about 290° C., from about 220° C. to about 280° C., from about 230° C. to about 280° C., from about 230° C. to about 270° C., from about 240° C. to about 270° C., from about 250° C. to about 270° C., or from about 250° C. to about 260° C.

In one embodiment, the compound of formula (VIII) has a structure of formula (VIIIa):

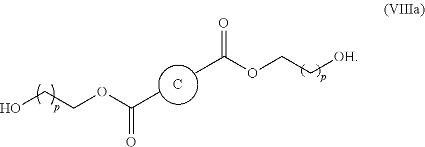

In another embodiment, the compound of formula (IX) has a structure of formula (IXa):

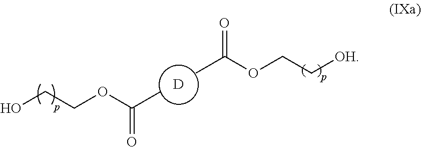

In at least one embodiment, the process further includes:
providing a compound having the structure of formula (X):

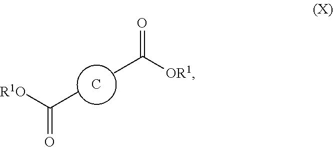

wherein R¹ is H or C₁₋₆ alkyl; and
forming the compound having the structure of formula (VIII) from the compound of formula (X).

One embodiment relates to the process of the present application where said forming the compound having the structure of formula (VIII) comprises:
reacting the compound of formula (X) with the compound of formula (XIa):

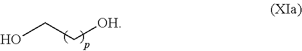

Yet another embodiment relates to the process of the present application where said providing a compound having the structure of formula (IX) or a salt thereof comprises: providing a compound having the structure of formula (XII):

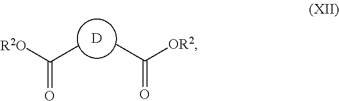

wherein R² is H or C₁₋₆ alkyl; and
forming the compound having the structure of formula (IX) from the compound of formula (XII).

Yet another embodiment relates to the process of the present application where said forming the compound having the structure of formula (IX) comprises:
reacting the compound of formula (XII) with the compound of formula (XIa):

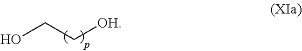

The compound of formula (XII) can be reacted with the compound of formula (XIa) in the presence of a transesterification catalyst. Suitable transesterification catalyst that can be used are selected from the group consisting of zinc acetate (Zn(OAc)₂), manganese acetate (Mₙ(OAc)₂), cobalt acetate (Co(OAc)₂), lead acetate (Pb(OAc)₂), sodium acetate (NaOAc), and tin(II) chloride (SnCl₂).

Any of the above described polymers can be prepared using this aspect of the invention.

In some embodiments, the polymer comprises a moiety of formula:

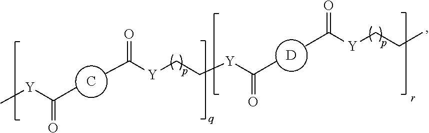

as described above.

In some embodiments, the polymer has the structure of Formula (VII), as described above.

Another aspect of the present application relates to a process for preparation of a polymer comprising one or more repeat units containing monomer C and one or more repeat units containing monomer D. This process includes:
providing a compound having the structure of formula (X):

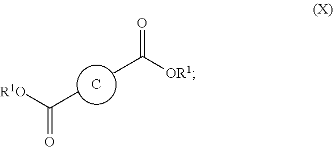

providing a compound having the structure offormula (XI):

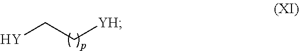

providing a compound having the structure of formula (XII):

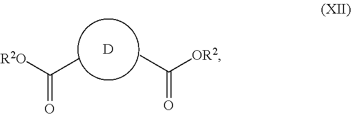

and
reacting the compound of formula (X), the compound of formula (XI), and the compound of formula (XII) under conditions effective to produce the polymer,
wherein
each Y is independently O or NH;

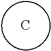

is arylene or C₂₋₃₀ alkylene, wherein arylene and C₂₋₃₀ alkylene can be optionally substituted from 1 to 3 times with R³;

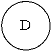

is arylene, heteroarylene, or arylene-Z-arylene, wherein arylene and heteroarylene can be optionally substituted from 1 to 3 times with R⁴;
R¹ is H or C₁₋₆ alkyl;
R² is H or C₁₋₆ alkyl;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)k₂—(CH₂)k₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

In some embodiments, Y is NH. In other embodiments, Y is O.

According to the present application, the compound of formula (X), the compound of formula (XI), and the compound of formula (XII) can be reacted in any suitable solvent or without the solvent. This reaction can be performed in water, methanol (MeOH), ethanol (EtOH), isopropanol (i-PrOH), dimethylformamide (DMF), phenols, cresols, hexafluoro-isopropanol, or other such solvents or in a mixture of such solvents.

In one embodiment, the compound of formula (X), the compound of formula (XI), and the compound of formula (XII) are reacted under vacuum.

In another embodiment, the compound of formula (X), the compound of formula (XI), and the compound of formula (XII) are reacted at a temperature of 100° C. to 400° C., at a temperature of 125° C. to 375° C., at a temperature of 150° C. to 350° C., at a temperature of 175° C. to 325° C., at a temperature of 225° C. to 300° C., at a temperature of 250° C. to 300° C., at a temperature of 260° C. to 300° C., at a temperature of 200° C. to 300° C., at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C., at a temperature of 20° C. to 100° C., at a temperature of 20° C. to 75° C., at a temperature of 20° C. to 50° C., at a temperature of 20° C. to 45° C., at a temperature of 20° C. to 40° C., at a temperature of 25° C. to 40° C., at a temperature of 30° C. to 40° C., at a temperature of 35° C. to 40° C., or at a temperature of 30° C. to 45° C.

In another embodiment, the compound of formula (X), the compound of formula (XI), and the compound of formula (XII) are reacted for 10 min to 24 hours, for 20 min to 20 hours, for 30 min to 18 hours, for 45 min to 12 hours, for 1 hour to 6 hours, or for 1 hour to 3 hours.

In some embodiments, the compound of formula (X), the compound of formula (XI), and the compound of formula (XII) are reacted under an inert atmosphere (e.g., under a nitrogen atmosphere or an argon atmosphere).

In some embodiments, the compound of formula (X), the compound of formula (XI), and the compound of formula (XII) are reacted under pressure. For example, the compound of formula (X), the compound of formula (XI), and the compound of formula (XII) are reacted at a pressure for the inert gas from 50 psig to 300 psig, from 75 psig to 250 psig, from 100 psig to 200 psig, or from 125 psig to 200 psig. In other embodiments, the compound of formula (X), the compound of formula (XI), and the compound of formula (XII) are reacted under atmospheric pressure.

In some embodiments, the polymers comprising one or more repeat units containing monomer C and one or more repeat units containing monomer D can be prepared by first preparing a salt between the compound of formula (X) and the compound of formula (XI) (salt 1) and a salt between the compound of formula (XI) and the compound of formula (XII) (salt 2), followed by an initial polycondensation reaction (oligomer formation) and then a polymerization step.

According to the present application, salt formation can be carried out in a variety of solvents, for example in water, methanol (MeOH), ethanol (EtOH), isopropanol (i-PrOH), dimethylformamide (DMF), or other such solvents or in a mixture of such solvents.

Salt formation can be carried out at a temperature of 20° C. to 100° C., at a temperature of 20° C. to 75° C., at a temperature of 20° C. to 50° C., at a temperature of 20° C. to 45° C., at a temperature of 20° C. to 40° C., at a temperature of 25° C. to 40° C., at a temperature of 30° C. to 40° C., at a temperature of 35° C. to 40° C., or at a temperature of 30° C. to 45° C.

Salt formation can be carried out for 10 min to 24 hours, for 20 min to 20 hours, for 30 min to 18 hours, for 45 min to 12 hours, for 1 hour to 6 hours, or for 1 hour to 3 hours.

According to the present application, the polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents.

The polycondensation reaction can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C.

According to the present application, the polymer formation step can be performed neat or in a variety of solvents, for example in phenols, cresols, hexafluoro-isopropanol, dimethylformamide (DMF) or other such solvents or in a mixture of such solvents.

The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

Polycondensation reaction and polymer formation step can be performed in the same reaction vessel or different reaction vessels. In some embodiments, the reaction vessel was vented at least once during the process of polycondensation reaction and polymer formation step.

In some embodiments, polycondensation reaction and polymer formation step can be performed under an inert atmosphere (e.g., under a nitrogen atmosphere or an argon atmosphere).

In some embodiments, polycondensation reaction and polymer formation step can be performed under pressure. For example, the polycondensation reaction and polymer formation step can be performed at a pressure for the inert gas from 50 psig to 300 psig, from 75 psig to 250 psig, from 100 psig to 200 psig, or from 125 psig to 200 psig. In other embodiments, polycondensation reaction and polymer formation step can be performed under atmospheric pressure. In other embodiments, the polycondensation reaction and polymer formation step can be performed under vacuum.

Any of the above described polymers can be prepared using this aspect of the invention.

In some embodiments, the polymer comprises a moiety of formula:

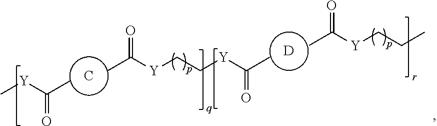

as described above.

In some embodiments, the polymer has the structure of Formula (VII), as described above.

Another aspect of the present application relates to a cleavable polymer comprising one or more repeat units containing monomer A, one or more repeat units containing B, and one or more repeat units containing C:
wherein
repeat unit containing monomer A is

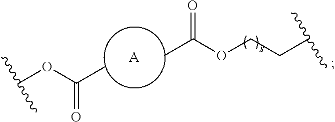

repeat unit containing monomer B is

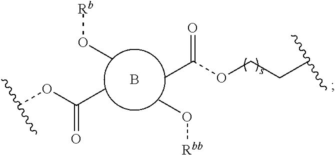

repeat unit containing monomer C is

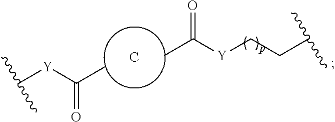

[symbol]

is a chemically cleavable bond;

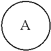

is selected from the group consisting of arylene, heteroarylene, heterocyclene, and C₅₋₈ cycloalkylene;

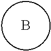

is selected from the group consisting of phenylene, furanylene, thiphenylene, and naphtanylene, wherein phenylene, furanylene, thiphenylene, and naphtanylene can be optionally substituted from 1 to 2 times with R;

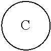

is arylene or C₂₋₃₀ alkylene, wherein arylene and C₂₋₃₀ alkylene can be optionally substituted from 1 to 3 times with R³;
each Y is independently O or NH;
R^{a} and R^{aa} are independently selected from —H, —C₁₋₃₀ alkyl, or —C₁₋₃alkyl-OH;
R^{b} and R^{bb} are independently selected from —H,

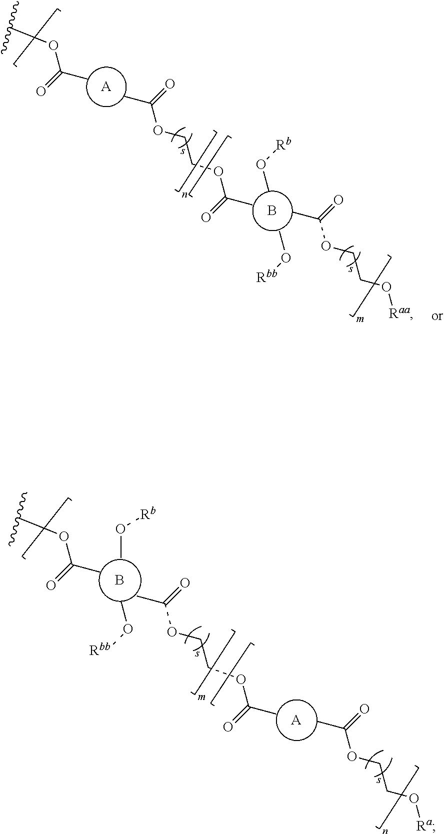

R is —OR¹, —NHR², —NO₂, or halogen;
R¹ is H, C₁₋₃alkyl, or aryl;
R² is —C(O)—R¹;
R³ is —CH═CH—;
p is 1 to 30;
s is 1 to 30;
n is 1 to 1,000,000; and
m is 1 to 1,000,000.

In some embodiments, the cleavable polymer further comprises one or more repeat units containing monomer D:

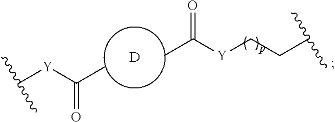

each Y is independently O or NH;

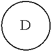

is arylene, heteroarylene, or arylene-Z-arylene, wherein arylene and heteroarylene can be optionally substituted from 1 to 3 times with R⁴;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

Another aspect of the present application relates to a cleavable polymer comprising one or more repeat units containing monomer A, one or more repeat units containing monomer B, and one or more repeat units containing monomer D:
wherein repeat unit containing monomer A is

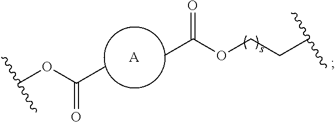

repeat unit containing monomer B is

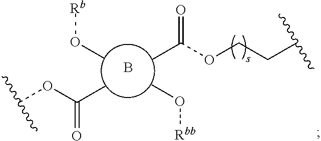

repeat unit containing monomer D is

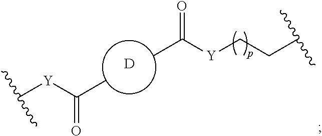

[symbol]

is a chemically cleavable bond;

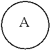

is selected from the group consisting of arylene, heteroarylene, heterocyclene, and C₅₋₈ cycloalkylene;

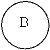

is selected from the group consisting of phenylene, furanylene, thiphenylene, and naphtanylene, wherein phenylene, furanylene, thiphenylene, and naphtanylene can be optionally substituted from 1 to 2 times with R;

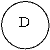

is arylene, heteroarylene, or arylene-Z-arylene, wherein arylene and heteroarylene can be optionally substituted from 1 to 3 times with R⁴;
each Y is independently O or NH;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or10;
k₃ is 1, 2, 3, 4, 5, 6, 7, 8, 9, or 10;
R^{a} and R^{aa} are independently selected from —H, —C₁₋₃₀ alkyl, or —C₁₋₃₀ alkyl-OH;
R^{b} and R^{bb} are independently selected from —H,

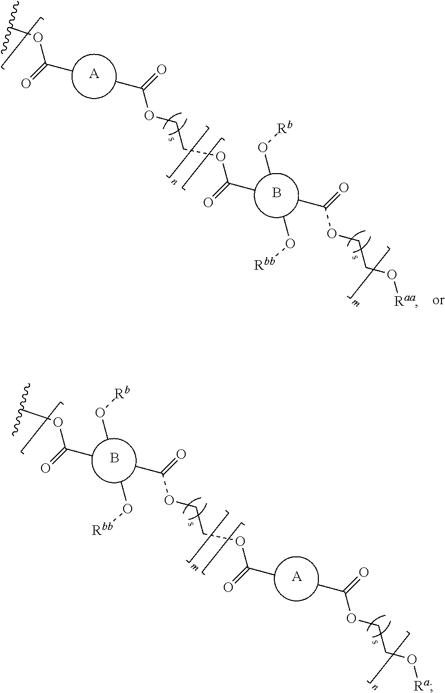

R is —OR¹, —NHR², —NO₂, or halogen;
R¹ is H, C₁₋₃alkyl, or aryl;
R² is —C(O)—R¹;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Ar is aryl optionally substituted with C₁₋₆ alkyl or —OC₁₋₆ alkyl;
p is 1 to 30;
s is 1 is to 30;
n is 1 to 1,000,000; and
m is 1 to 1,000,000.

Another aspect of the present application relates to a polymer comprising one or more repeat units containing monomer A, one or more repeat units containing monomer C, and one or more repeat units containing monomer D:
wherein
   repeat unit containing monomer A is

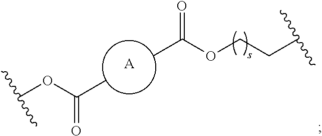

repeat unit containing monomer C is

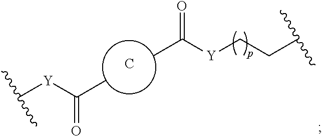

repeat unit containing monomer D is

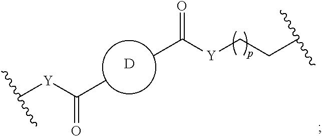

each Y is independently O or NH;

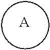

is selected from the group consisting of arylene, heteroarylene, heterocyclene, and C₅₋₈ cycloalkylene;

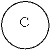

is arylene or C₂₋₃₀ alkylene, wherein arylene and C₂₋₃₀ alkylene can be optionally substituted from 1 to 3 times with R³;

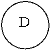

is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30; and
s is 1 to 30.

Another aspect of the present application relates to a cleavable polymer comprising one or more repeat units containing monomer B, one or more repeat units containing monomer C, and one or more repeat units containing monomer D:
wherein
   repeat unit containing monomer B is;

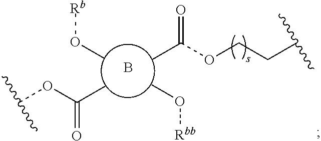

repeat unit containing monomer C isl;

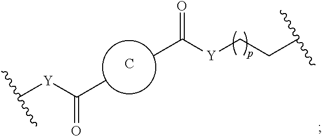

repeat unit containing monomer D is

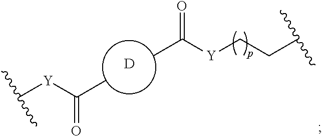

[symbol]

is a chemically cleavable bond;
each Y is independently O or NH;

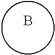

is selected from the group consisting of phenylene, furanylene, thiphenylene, and naphtanylene, wherein phenylene, furanylene, thiphenylene, and naphtanylene can be optionally substituted from 1 to 2 times with R;

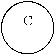

is arylene or C₂-3o alkylene, wherein arylene and C₂-3o alkylene can be optionally substituted from 1 to 3 times with R³;

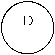

is arylene, heteroarylene, or arylene-Z-arylene, wherein arylene and heteroarylene can be optionally substituted from 1 to 3 times with R⁴;
R^{a} and R^{aa} are independently selected from —H, —C₁₋₃₀ alkyl, or —C₁₋₃₀ alkyl-OH;
R^{b} and R^{bb} are independently selected from —H,

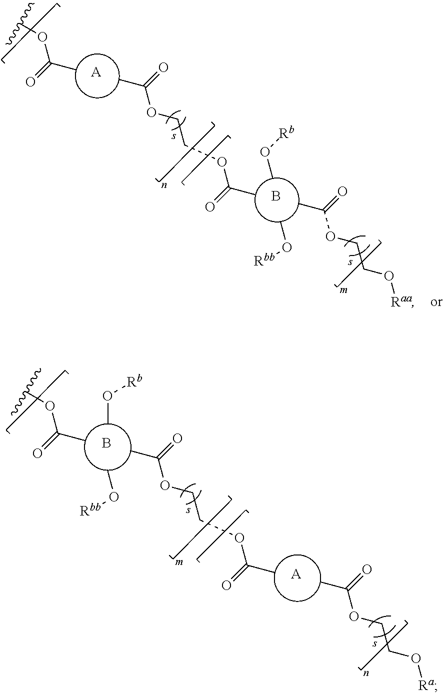

R is —OR¹, —NHR², —NO₂, or halogen;
R¹ is H, C₁₋₃₀ alkyl, or aryl;
R² is —C(O)—R¹; R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30;
s is 1 to 30;
n is 1 to 1,000,000; and
m is 1 to 1,000,000.

The polymers of the present application are suitable for use in various objects including packaging films or sheets and injection molded or thermoformed articles.

Another aspect of the present application relates to a sheet. The sheet comprises the polymer of the present application.

Another aspect of the present application relates to a films. The films comprises the polymer of the present application.

Various extrusion, blow molding, injection molding, casting or melt processes known to those skilled in the art may be used to form films or sheets from the polymer of the present application. These films or sheets can be used to prepare articles of manufacture used to wrap, or otherwise package food or various other solid articles. The films or sheets may have a wide variety of thicknesses, and other properties such as stiffness, breathability, temperature stability and the like which may be changed based on the desired end product and article to be packaged.

Sheets comprising the polymers of the present application may be formed by any suitable method, including without limitation dipcoating, solution casting, compression molding, injection molding, lamination, melt extrusion casting, blown film, extrusion coating, tandem extrusion coating, or by a combination of two or more of these methods. Preferably, the sheets are formed by an extrusion method, such as melt extrusion casting, melt coextrusion casting, melt extrusion coating, or tandem melt extrusion coating processes.

Another aspect of the present application relates to a molded article. The article comprising the polymer of the present application.

The molded article can have a minimum thickness (i.e., the thickness at the smallest dimension of the article) of at least about 0.1 mm, at least about 0.5 mm, at least about 1 mm. Alternatively, the molded article may have a thickness of about 1 mm to 100 mm, or 2 mm to 100 mm, or 3 to about 100 mm, or about 3 to about 50 mm, or about 5 to about 35 mm.

The molded article according to the present application can be prepared in the form of a sheet, a container (e.g., a bottle or a bowl), a cap or stopper (e.g., for a container), a sealant for a container (a bottle cap liner), a valve, a toy, a tray, a medical device or instrument (e.g., an automated or portable defibrillator unit), a handle, a knob, a push button, a decorative article, a panel, a console box, or a footwear component (e.g., a heel counter, a toe puff, or a sole).

The polymer composition used to prepare a film, a sheet, or a molded article includes one or more polymers of the present application.

In some embodiments, the polymer composition may also include a crystallinity agent. Examples of crystallinity agents include, but are not limited to talc, kaolin, mica, bentonite clay, calcium carbonate, titanium dioxide, and aluminum oxide.

In some embodiments, the polymer composition may also include a starch-based melt rheology modifier. Suitable starches are those produced by plants and include cereal grains (corn, rice, sorghum, etc.), potatoes, arrowroot, tapioca, and sweet potato.

In some embodiments, the polymer composition may also include one or more crystallinity retarders. Examples of crystallinity retarders include, but are not limited to, xanthan gum, guar gum, and locust bean gum.

In some embodiments, the polymer composition may also include colorants. Suitable colorants that can be used include titanium dioxide, sodium copper chlorophyllin, a food grade analine powder, or food grade colorants.

In some embodiments, the polymer composition may also include inorganic materials including metals such as aluminum, copper, titanium, silicon, or the oxides thereof.

In some embodiments, the polymer composition may also include gloss agents to provide an aesthetically pleasing gloss to a film, a sheet, or a molded article. Exemplary gloss agents include shea butter and nut oils such as Brazil nut oil.

In some embodiments, the polymer composition may also include one or more surfactants, and/or one or more dispersants, and/or one or more adhesives.

Suitable surfactants that can be used include amphoteric surfactants, anionic surfactants, cationic surfactants, and nonionic surfactants. Examples of the amphoteric surfactants that can be used include sulfobetaines, phosphobetaines, carboxybetaines, imidazolium betaines, and alkylamine oxides. Examples of the anionic surfactant that can be used include alkylbenzene sulfonate (e.g., C₆₋₂₄ alkylbenzene sulfonate such as sodium laurylbenzenesulfonate, etc.), alkylnaphthalene sulfonate (e.g., di-C₃₋₈ alkylnaphthalene sulfonate, such as sodium diisopropylnaphthalenesulfonate, etc.), alkyl sulfonate (e.g., C₆₋₂₄ alkyl sulfonate such as sodium dodecanesulfonate, etc.), dialkylsulfosuccinic acid ester salt (e.g., di-C₆₋₂₄ alkyl sulfosuccinate such as sodium di-2-ethylhexylsulfosuccinate, etc.), alkyl sulfate (e.g., sulfated grease, C₆₋₂₄ alkyl sulfate such as a sodium salt of coconut oil-reduced alcohol), and alkyl phosphate (e.g., mono- to tri-C₈₋₁₈ alkyl ester phosphate such as mono- to tri-lauryl ether phosphate, polyoxyethylene alkyl ether phosphate, etc.). Examples of the cationic surfactant include tetraalkylammonium salt (e.g., mono-or di-C₈₋₂₄ alkyl-tri- or di-methylammonium salts such as lauryltrimethylammonium chloride or dioctadecyldimethylammonium chloride, etc.), trialkylbenzylammonium salt (e.g., C₈₋₂₄ alkylbenzyldimethylammonium salt such as cetylbenzyldimethylammonium chloride (benzalkonium chloride salt, etc.), etc.), and alkylpyridinium salt (e.g., C₈₋₂₄ alkylpyridinium salt such as cetylpyridinium bromide, etc.). Examples of the nonionic surfactant include polyoxyethylene alkyl ether (e.g., polyoxyethylene C₆₋₂₄ alkyl ether such as polyoxyethylene octyl ether, polyoxyethylene lauryl ether or polyoxyethylene cetyl ether), polyoxyethylene alkylphenyl ether (e.g., polyoxyethylene C₆₋₁₈ alkylphenyl ether such as polyoxyethylene octylphenyl ether or polyoxyethylene nonylphenyl ether, etc.), polyoxyethylene polyhydric alcohol fatty acid partial ester (e.g., polyoxyethylene glycerin C₈₋₂₄ fatty acid ester such as polyoxyethylene glycerin stearic acid ester, polyoxyethylene sorbitan C₈₋₂₄ fatty acid ester such as polyoxyethylene sorbitan stearic acid ester, polyoxyethylene sucrose C₈₋₂₄ fatty acid ester, etc.), and polyglycerin fatty acid ester (e.g., polyglycerin C₈₋₂₄ fatty acid ester such as polyglycerin monostearic acid ester).

In some embodiments, the polymer composition further includes one or more of the following: surface treatment agents (coupling agents such as a silane coupling agent, etc.), coloring agents (dyes and pigments, etc.), hue improving agents, dye fixing agents, glossing agents, metal corrosion preventing agents, stabilizers (an antioxidant, an ultraviolet absorber, etc.), dispersion stabilizing agents, thickeners or viscosity adjusting agents, thixotropic property-imparting agents, leveling agents, defoaming agents, disinfectants, fillers (milled fiber, chopped fiber, and glass microspheres), and flame or fire retardants.

In some embodiments, the polymer composition further includes one or more hardeners. Suitable hardeners that can be used include aliphatic amines, cycloaliphatic amines, polyamides, aromatic amines, anhydrides, phenols, thiols, and latent hardeners (e.g., Lewis acids).

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—Materials

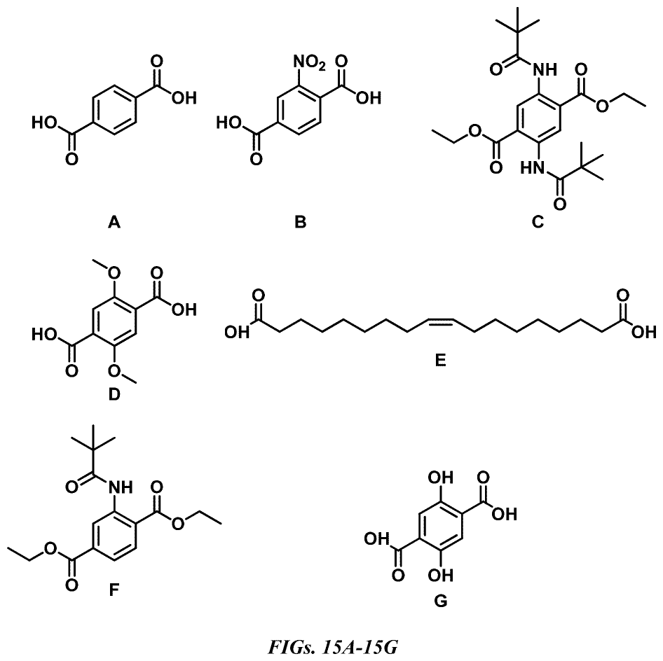

Terephthalic acid (TPA, 99+%, Acros Organics), ethylene glycol (EG, anhydrous, 99.8%, Sigma-Aldrich), and diethyl 2,5-dihydroxyterephthalate (DHTE, 97%, Oakwood Chemical) were used as precursors in polymer synthesis. The chemical structures of TPA and DHTE are shown in FIG. 15A and FIG. 15G, respectively. Zinc acetate (Zn(CH₃COO)₂), anhydrous, 99.8%, Alfa Aesar) and antimony(III) oxide (Sb₂03, 99%, Sigma-Aldrich) were respectively used as catalysts in the esterification/transesterification and polycondensation reactions. Triphenyl phosphate (TPP, ≥99%, Sigma-Aldrich) was used as a thermal stabilizer in the polycondensation reaction. Sea water (Imagitarium™, Pacific Ocean Water) and zinc chloride (ZnCl₂, anhydrous, 98+%, Thermo Scientific) were used to study the degradation efficiency in a simulated marine environment. Solvents and chemical reagents for analysis, such as dimethyl sulfoxide-d (DMSO-d), trifluoroacetic acid (TFA-d), chloroform-d (CDCl₃, 1 v/v % TMS), and pyridine (GCMS solvent) were purchased from Fisher and used as received. N,O-Bis(trimethylsilyl)trifluoroacetamide with 1% trimethylchlorosilane was purchased from Sigma-Aldrich and used as received.

### Example 2—Synthesis

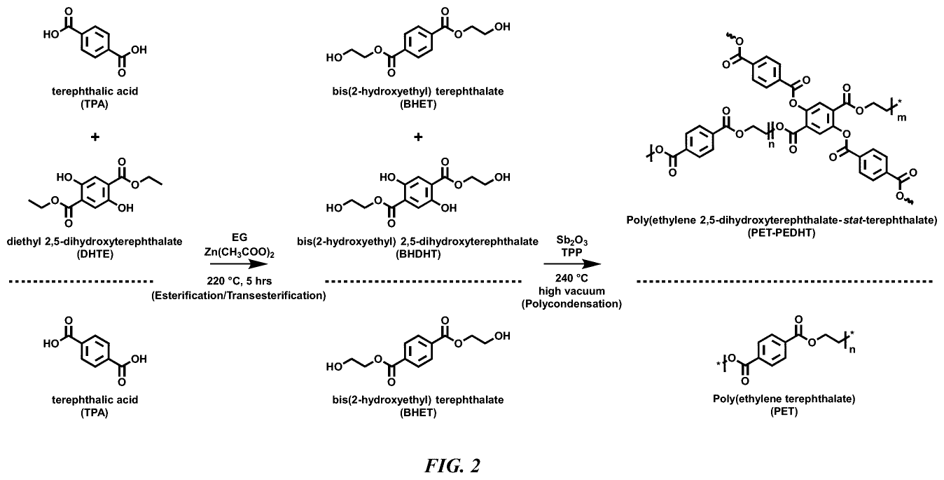

Poly(ethylene terephthalate-stat-2,5-dihydroxyterephthalate) (PEDHT) copolymers and pure PET were synthesized according to a classic two-step polycondensation reaction (FIG. 2). Two-step polymerization was performed in a stainless-steel reactor (Parr Instrument Company, type 4560). The first step involved the esterification and transesterification of TPA and DHTE with EG, respectively, using zinc acetate (0.13% molar ratio relative to diester/diacid) as the esterification/transesterification catalyst. Diacid/diester and EG were charged into the autoclave reactor at a molar ratio of 1:10. The system was then purged with argon for 30 min, followed by increasing the reaction temperature up to 220° C. for 5 hours with the pressure at 110 psi and an argon sweep to remove the byproducts (water and ethanol). Agitation was provided by a stainless-steel impeller at 250 rpm. After the first step reaction, the bis-hydroxy monomers and excess EG were transferred to a round-bottom flask for the distillation of EG using an oil bath set to 110° C. under vacuum for 12 hours. The monomers were brought back to the autoclave reactor with antimony(III) oxide (0.02% molar ratio relative to the diacid/diester) and triphenyl phosphate (0.1% molar ratio relative to the diacid/diester) acting as catalyst and thermal stabilizer, respectively. The second step of polycondensation was carried out at 240° C. under high vacuum with the stirring speed set at 600 rpm to produce polymer. At the end of the reaction, the pressure was returned to ambient pressure using argon to prevent thermal oxidation of the product. The polymers were scraped out from the reactor and dried under vacuum at room temperature for 24 hours.

### Example 3—Polymer Degradation Procedure

ZnCl₂ and H₂O were mixed in a 100 ml glass liner in the desired ratio and stirred for 5 min. Copolymer powder (after cryogrinding (Retsch)) (1 g) was added to a transparent ZnCl₂/H₂O solution. The liner was placed into the stainless-steel reactor (Parr Instrument Company, type 4560). The reactor was purged with argon gas and the inner pressure was increased up to 300 psi in order to keep the water in the liquid state during reaction. The reactor was heated and the starting point of the reaction was defined as reaching the set point of the target temperature. After the required reaction time, the reactor was removed from the heating mantle and cooled rapidly back to room temperature. The degradation products were filtered with quantitative filter paper (Whatman, ashless Grade 42) followed by two water washings. The remaining polymer and the precipitated monomers were recovered as solids due to poor solubility at room temperature, whereas EG was filtered as the liquid product. The reclaimed solid products were dried in a vacuum oven at 60° C. for 24 hours. The dried products were weighed and analyzed by using ¹H NMR to study the chemical structure and to evaluate PET conversion. GC-MS was further used to identify the composition and the purity of the solid products.

### Example 4—Characterization

Chemical structures were analyzed by using solution ¹H NMR spectroscopy (Bruker Avance III 600 MHz spectrometer). DMSO-d was used for analysis of the solid products, while CDCl₃ and TFA-d (75/25 v/v) solvent mixtures were used for degradation kinetic study.

The composition and the purity of the solid products were quantified by using an Agilent 6890 GC coupled with an Agilent 5975C MS detector. Chromatographic separation was performed by using an Agilent DB-1 column.

The functional groups of the copolymers were analyzed by FTIR (iD7 ATR Accessory for the NicoletT M iST M 5 Spectrometer, ThermoFisher). The spectra were obtained from 4000 to 400 cm⁻¹ from 32 scans at a resolution of 4 cm⁻¹.

Due to crosslinking between the phenolic hydroxy of DHTE and terephthalate, swelling tests were used to determine the insoluble fraction in the copolymers. Copolymer powder (150 mg) was immersed in a solvent mixture of phenol/1,1,2,2-tetrachloroethane (60/40 v/v) for 16 hours at 120° C. The gel was carefully filtered by membrane filter (0.22 μm pore size, hydrophobic PTFE, 47 mm membrane, MilliporeSigma) from the solution, washed in chloroform for 24 hours, dried at 50° C. for 16 hours under vacuum, and weighed.

Molecular weight and dispersity of the soluble fraction were determined using a Tosoh Ecosec GPC (Tosoh Ecosec HLC-8320GPC) equipped with a UV and RI detector. Hexafluoroisopropanol (HFIP) and dichloroacetic acid (DCAA) (50/50 v/v) were used to dissolve the samples at a concentration of 6 mg/mL. HFIP was used as the eluent at a flow rate of 0.3 mL/min. The molecular weights were determined relative to poly(methyl methacrylate) (PMMA) standards.

Thermal properties of polymers were analyzed by using differential scanning calorimetry (DSC, TA instruments Discovery DSC Q2500) under N₂ atmosphere. The samples were made by injection molding in order to study glass transition and crystallization behaviors. The samples were heated from 25 to 300° C. at a rate of 10° C. min¹, where they were held for 5 min before being cooled back to 25° C. at a rate of 10° C. min-. The glass transition, crystallization, and melting temperature were obtained by using “Trios” software of TA Instruments. The thermal stability of the polymers was evaluated by thermogravimetric analysis (STA 449 F1 Jupiter, NETZSCH). For each experiment, 5-6 mg of the samples in alumina crucible pan were heated from 80 to 1000° C. at a rate of 10° C. min⁻¹ under N₂ atmosphere.

The factors of hydrolysis degradation including catalyst concentration, temperature, reaction time, and copolymer composition, which affect the efficiency of the reaction, were identified. The degradation kinetics in various reaction conditions were also studied to clarify the roles of these factors. In the hydrolysis depolymerization kinetics of PET, the reaction order was usually considered pseudo-first-order since water is in excess over PET (Wang et al., “Zinc-Catalyzed Ester Bond Cleavage: Chemical Degradation of Polyethylene Terephthalate,” Journal of Cleaner Production 208:1469-1475 (2019); Kim et al., “Kinetics of Polycarbonate Methanolysis by a Consecutive Reaction Model,” Industrial & Engineering Chemistry Research 48:6591-6599 (2009); López-Fonseca et al., “Kinetics of Catalytic Glycolysis of PET Wastes with Sodium Carbonate,” Chemical Engineering Journal 168:312-320 (2011), which are hereby incorporated by reference in their entirety). As a result, the Trojan horse-induced copolymer hydrolysis in the present of metal catalyst was initially assumed to be controlled by the pseudo-first-order kinetic equation:

$$Rate = {kC}_{{H}_{2} O} {C}_{p} = {kC}_{p} \qquad Eq . ( 1 )$$

where k is the rate constant and Cₚ is the concentration of PEDHT copolymer at time t.

$${C}_{p} = {C}_{p 0} ( 1 - X ) \qquad Eq . ( 2 )$$

where X is PEDHT copolymer hydrolysis conversion. Then, Equation 1 could be converted as follows:

$$\frac{d ( X )}{dt} = k ( 1 - X ) \qquad Eq . ( 3 )$$

Equation 3 was integrated over time to give Equation 4:

$$ln \frac{1}{( 1 - X )} = kt \qquad Eq . ( 4 )$$

By using the rate constants, the activation energy Eₐ is obtained from Arrhenius Equation 5

$$k = {Ae}^{- \frac{Ea}{RT}} \qquad Eq . ( 5 )$$

Take the natural logarithm of both sides and get

$$lnk = lnA - \frac{Ea}{RT} \qquad Eq . ( 6 )$$

where A is the pre-exponential factor which corresponds to the collision frequency, R is the gas constant (8.314 J k−1 mol-1), and T is the temperature in Kelvin. By using Equation 6, the rate constant at different temperatures can be calculated and further used in Equation 4 to estimate the time required for PET degradation to a certain degree.

### Example 5—Results and Discussion of Examples 1-4

Table 1 shows the characteristics of the synthesized materials. The sample codes of the copolymers are denoted as PEDHTX, where X represents the mole fraction % of DHTE units relative to the total amount of diester and diacid.

TABLE 1
Composition and Reaction Condition of PET and PEDHT Copolymers

| | Feed ratio | Polycondensation | | | | |
|---|---|---|---|---|---|---|
| | TPA/ | Temp./ | In- | Soluble | Soluble | |
| | DHTE/ | Time^{c} | soluble | fraction | fraction | Soluble |
| Sample | EG, | (° C./ | fraction^{d} | Mₙ^{e} | M_{w}^{f} | fraction |
| Codeª | eg^{b} | hour) | (%) | (kDa) | (kDa) | Ð^{g} |
| PET | 1/0/10 | 240/8 | 0.0 | 15.7 | 31.3 | 2.00 |
| PEDHT5 | 0.95/0.05/10 | 240/2.5 | 3.9 | 11.8 | 51.5 | 4.35 |
| PEDHT10 | 0.9/0.1/10 | 240/2 | 5.4 | 11.3 | 58.2 | 5.13 |
| PEDHT20 | 0.8/0.2/10 | 240/1.75 | 11.3 | 12.2 | 72.0 | 5.88 |

^{a}Sample code: PEDHTX, X = mol % of dihydroxyterephthalate repeat unit.
^{b}Equivalents of terephthalaic acid (TPA) & diethyl dihydroxyterephthalate (DHTE) on a 10 eq basis of ethylene glycol (EG).
^{c}The esterification/transesterification reaction was carried out at 220° C. for 5 hours and bis-hydroxy ester monomer conversion of each precursor was ≥ 99%, which was determined by gas chromatography-mass spectrometry.
^{d}Insoluble fraction by dissolving sample in phenol/1,1,2,2-tetrachloroethane (60/40, v/v) at 120° C. for 16 hours.
^{e}Number-average molecular weight.
^{f}Weight-average molecular weight.
^{g}Dispersity calculated by M_{w}/Mₙ. The molecular weights were determined by GPC in 1,1,1,3,3,3-hexafluoro-2-propanol solution with poly(methyl methacrylate) (PMMA) standards.

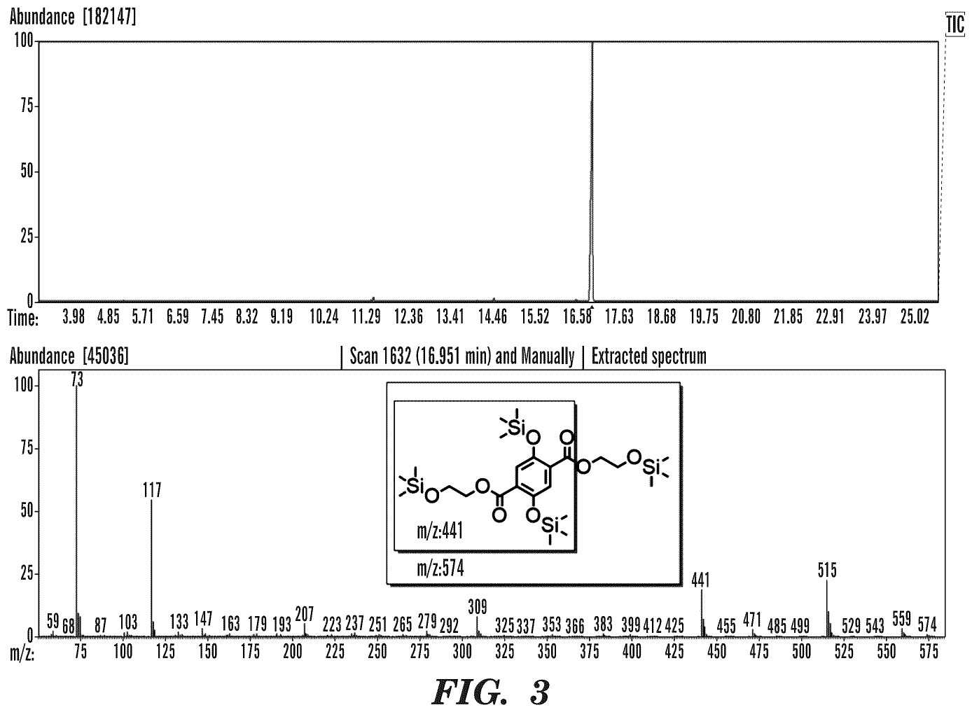

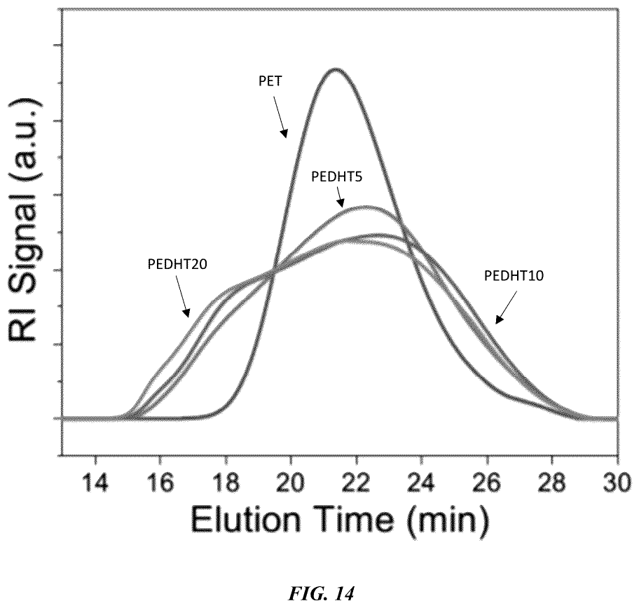

PET and PEDHT copolymers were synthesized by a two-step polymerization similar to the industrial manufacturing process. The first step was monomer preparation (esterification/transesterification), in which diacid/di-ethyl ester was converted to bis-hydroxy ester. The conversion reached>99% within 5 hours under an excess of EG without any side reactions (FIG. 3). Following the completion of monomer preparation and distillation to remove excess EG, the bis-hydroxy ester was mixed with additional catalyst and converted into polyester through transesterification under dynamic vacuum. It should be noted that viscosity was higher during the polymerization of PEDHT copolymers, far exceeding the viscosity of that of pure PET. Therefore, this reduced the reaction time and further caused limitations on the growth of the polymer chain. To understand the viscosity effect during the reaction to the polymers, GPC was used to measure molecular weight of PEDHT copolymers, and it showed that a portion of the copolymer remained insoluble. GPC chromatograms soluble component of the copolymers appear in FIG. 14 and had number-average molecular weights comparable to PET. The dispersity (D) of PEDHT copolymers exceeded over 2 times that typically associated with a polycondensation material, and D increases with DHTE content. The increased viscosity, insoluble fraction, and elevated dispersity were ascribed to the permanent covalent network that formed due to the chain extension, branching, and/or cross-linking reactions via reaction of phenolic and carboxylic/ester (FIG. 2). The insoluble fraction (Table 1) results indicated that the degree of cross-linking increased with DHTE content. In general, PEDHT copolymers were within the conditions required to assess the performance of these materials and well enough to make a comparison with pure PET.

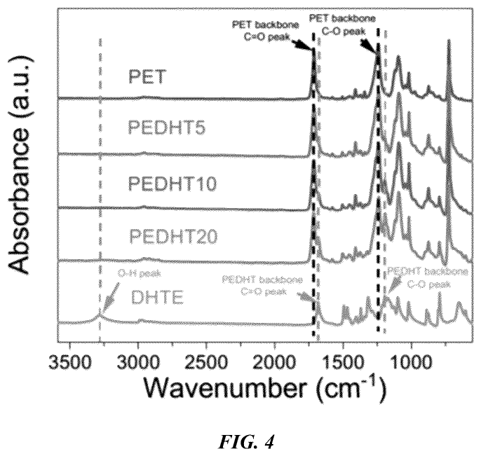

In addition to solution state analyses, FTIR spectroscopy was used to analyze the microstructure of the copolymers in the solid state (FIG. 4). The strong absorption peaks in the region of 1714 and 1681 cm⁻¹ were assigned to the stretching vibration of the carbonyl group (C═O) of PET and PEDHT units, respectively, while the peaks at 1237 and 1191 cm⁻¹ corresponded to carbonyl (C—O) stretching vibration of PET and PEDHT units, respectively. The frequency of carbonyl (C═O) stretching peak of PEDHT unit was 33 cm⁻¹ lower than that of PET due to the electron-withdrawing effect of the additional phenolic groups on the aromatic ring (Coates et al., “Infrared Spectroscopy in Process Analysis,” Encyclopedia of Analytical Chemistry: Applications, Theory and Instrumentation (2006), which is hereby incorporated by reference in its entirety). In general, the FTIR spectra of PEDHT copolymers showed different absorption peaks of C═O and C—O stretching vibration for PET and PEDHT units, respectively, and the ratio of absorption intensities (I1714/I1681 and I1237/I1191) decreased with the increase in the PEDHT unit content. Furthermore, the phenolic (—OH) group of DHTE was observed at 3286 cm⁻¹, while there was no significant peak showing up in this region of PEDHT copolymers. This was consistent with the esterification of phenolic groups during polycondensation, resulting in a 3D network. This supported the hypothesis that the insoluble fraction of the copolymers is attributed to the permanent covalent network or gelation of the polymers, which is formed due to branching or cross-linking reactions (Montarnal et al., “Silica-Like Malleable Materials From Permanent Organic Networks,” Science 334:965-968 (2011); Capelot et al., “Metal-Catalyzed Transesterification for Healing and Assembling of Thermosets,” Journal of the American Chemical Society 134:7664-7667 (2012), which are hereby incorporated by reference in their entirety).

To further elucidate the effect of DHTE loading on the thermal properties of the copolymers, DSC was performed (FIGS. 5A-B and Table 2). The melting point Tₘ decreased monotonically with DHTE loading. This trend was observed in studies on other statistical copolymers, including polyamides, which was attributed to the suppression of the crystal thickness resulting from the comonomer unit within the polymer chain (Carter et al., “Bioenabled Platform to Access Polyamides with Built-In Target Properties,” Journal of the American Chemical Society 144(22):9548-9553 (2022); Abdolmohammadi et al., “Analysis of the Amorphous and Interphase Influence of Comononomer Loading on Polymer Properties Toward Forwarding Bioadvantaged Copolyamides,” Macromolecules 54:7910-7924 (2021); Lee et al., “Next-Generation High-Performance Biobased Naphthalate-Modified PET for Sustainable Food Packaging Applications,” Macromolecules 55(17):7785-7797 (2022), which are hereby incorporated by reference in their entirety). In most cases, crystals were comprised solely of majority component, with the minority counits relegated to the amorphous phase. In this case, as DHTE fraction increases, the crystal thickness was suppressed due to shorter PET sequences. This result depressed the melting point, as anticipated by the Thompson-Gibbs equation (Hiemenz P. C. and Lodge T. P., Polymer Chemistry, Second Edition, Boca Raton (2007), which is hereby incorporated by reference in its entirety). Moreover, a similar trend was also observed in melting enthalpy and degree of crystallinity, which supported the suppression effect of crystal thickness by the comonomer units.

TABLE 2
Thermal Transition Properties of PET and PEDHT Copolymers

| Sample | DSC | | | | | | | | TGA | | |
|---|---|---|---|---|---|---|---|---|---|---|---|
| Code | T_{g}^{b} | ΔH_{cc}^{b} | T_{cc}^{b} | Δ_{c}^{b} | T_{c}^{b} | ΔHₘ^{b} | Tₘ^{b} | γ_{c}^{b} | T_{d,5%}^{c} | T_{d,max}^{c} | R₁₀₀₀ (wt %)^{c} |
| PET | 71.2 | N.D.^{d} | N.D. | 43.2 | 191.7 | 38.6 | 237.5 | 27.5 | 404.8 | 442.1 | 16.0 |
| PEDHTS | 78.6 | N.D. | N.D. | 37.7 | 168.4 | 35.8 | 235.3 | 25.6 | 404.8 | 444.8 | 17.7 |
| PEDHTIO | 75.5 | 8.5 | 155.5 | 10.9 | 150.9 | 30.6 | 222.0 | 21.9 | 391.3 | 442 9 | 16.4 |
| PEDHT20 | 77.8 | 10.1 | 135.2 | N.D. | N.D. | 18.3 | 190.0 | 13.0 | 369.0 | 444.6 | 14.6 |

^{a}Sample code: PEDHTX, x = mol % of dihydroxyterephthalate repeat unit.
^{b}Glass transition (T_{g}), crystallization (T_{c}), cold crystallization (T_{cc}) and melting (Tₘ) temperatures. The enthalpies (ΔH_{cc}, ΔH_{c}, and ΔHₘ) corresponded to each thermal transition.
^{c}T_{d,5%}: decomposition temperatures at which the weight loss reached 5% of its initial weight. T_{d,max}: the temperature at the maximum rate of decomposition. R₁₀₀₀: The residual mass at 1000° C.
^{d}Not detected by DSC.

Likewise, the melt recrystallization temperature Tc also decreased with respect to DHTE loading. This could result from two effects: first, the disruption effect on the regularity of crystallizable PET sequences due to the comonomer. Second, the macrostructure formation due to the permanent covalent network suppressed the chain motion of rearranging PET sequences into crystal lattice. As the DHTE composition increased, the cross-link density increased, leading to attenuation of the polymer chain diffusion, which was in accordance with a previous study that the polymers with similar cross-linking networks exhibited slow crystallization behavior (Demongeot et al., “Cross-Linking of Poly (Butylene Terephthalate) by Reactive Extrusion Using Zn (II) Epoxy-Vitrimer Chemistry,” ACS Publications. 50:6117-6127 (2017), which is hereby incorporated by reference in its entirety). The crystallization ability of the copolymers could become critically hindered by these two effects, and cause the material to be completely amorphous eventually. These effects were also confirmed by the downward trend of crystallization enthalpy and the degree of crystallinity reached during melt crystallization.

Turning to the amorphous phase, where the vast majority of the DHTE content evidently resides, all PEDHT copolymers showed one unique T_{g} value via DSC, indicating a homogeneous amorphous phase. The PEDHT copolymers showed T_{g} values 4-7° C. higher compared to that of PET, indicating that the formation of the cross-linking network due to DHTE further increased the energy barriers of the phase change of polymer substrate from a glassy state to a rubbery state.

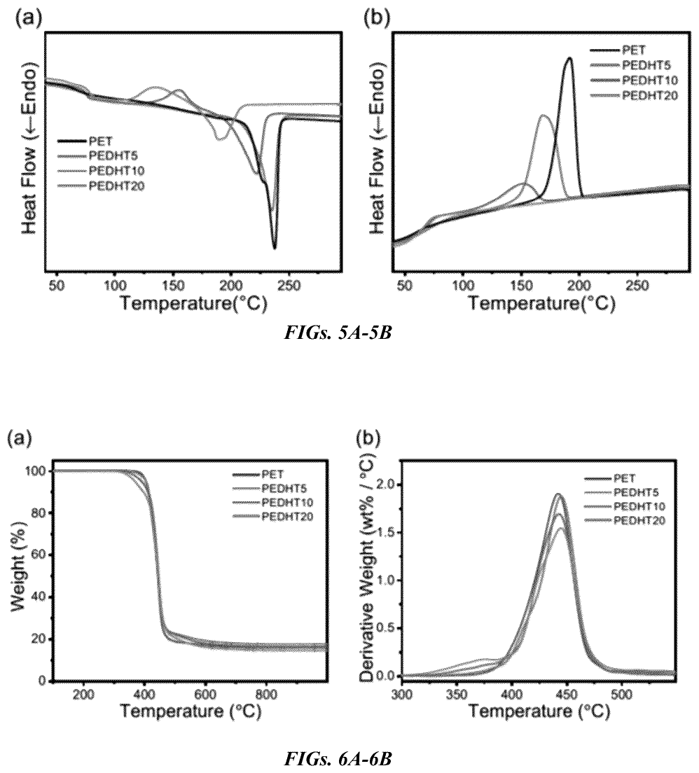

Based on thermal property characterization, PEDHT copolymers were similar to pure PET for a wide range of practical applications since the copolymers showed higher service temperature and ease-of-processing due to T_{g} rising and Tₘ depressing, respectively, compared to PET. Additionally, the thermal stability of PEDHT copolymers was characterized using TGA (FIGS. 6A-B and Table 2). The results indicated that the thermal stability of PEDHT copolymers was similar to that of PET, while producing similar char residue and slightly higher T_{d,max} values. The enhancement of the thermal stability was attributed to the permanent covalent network formed by DHTE, which reinforced the dimensional stability of the polymer structure. In summary, the thermal analysis demonstrated that DHTE embedded inside PET retained the thermal properties of the original material with improvement in some of the certain applications such as processing.

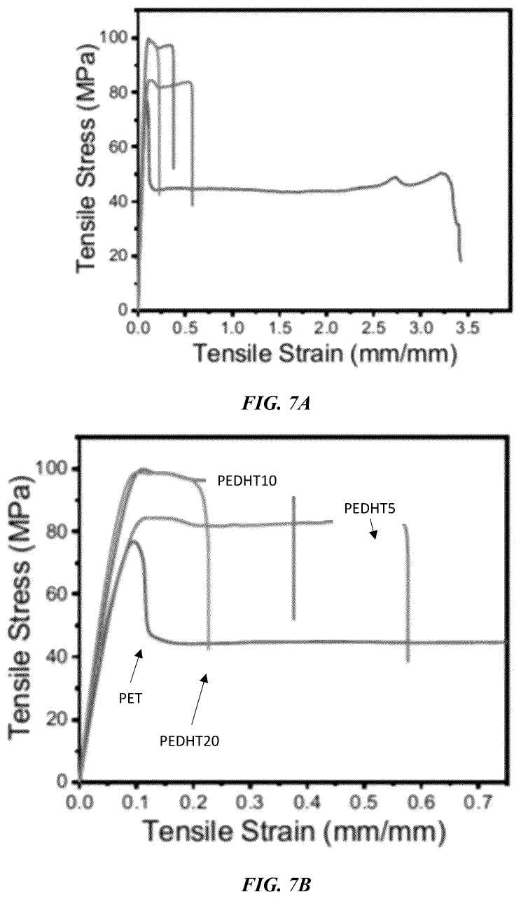

It should be mentioned that the presence of the melting behavior indicated that the copolymers were melt processable. This meant PEDHT copolymers might be able to be processed through similar process techniques done for PET, like injection molding or blow molding, for commodity production. Therefore, to confirm this hypothesis, injection molding was used to process PEDHT copolymers. The produced tensile samples were used to determine the mechanical properties to elucidate the applicability of these materials (Table 3) (representative stress-strain curves are shown in FIGS. 7A-B). The Young's modulus of PEDHT copolymers showed an increase of 40% compared to that of PET. This result can be attributed to the presence of the macrostructure network, which enabled the materials to withstand higher load under the same degree of deformation. Likewise, the copolymer yield strength increased from 74 MPa to 102 MPa for >10 mol % DHTE loading. This observation can be attributed to the increase in the rigidity of the copolymers due to the change in the cross-link density inside the material. As the cross-link density increased, the material can withstand with stronger forces before necking. Based on these effects, a similar trend was observed in the ultimate strength, which showed an improvement of 110% from 45 MPa to 96 MPa with DHTE loading≥10 mol %. While the cross-linking improved the rigidity and strength of the materials, elongation-at-break decreased from 358% to 23% with DHTE, changing the fracture fashion of the copolymers from ductile-to-brittle. This can result from the disruption effect of 3D network which disrupted the strain-induced crystallization and lead to material fracture. Therefore, the mechanical properties were tunable through DHTE content to meet a range of performance specifications.

TABLE 3
Mechanical Properties of PET and PEDHT Copolymers

| | Young's | | Yield | Elongation |
|---|---|---|---|---|
| Sample | modulus | Toughness | Strength | at break |
| Code^{a} | (Mpa) | (MJ/m³) | (Mpa) | (%) |
| PET | 1040.5 ± 13.0 | 157.5 ± 8.2 | 74.1 ± 2.4 | 358.2 ± 14.4 |
| PEDHT5 | 1477.5 ± 16.5 | 46.2 ± 5.8 | 83.5 ± 0.8 | 60.1 ± 7.0 |
| PEDHT10 | 1449.5 ± 42.2 | 32.7 ± 4.0 | 102.3 ± 2.2 | 36.8 ± 4.3 |
| PEDHT20 | 1491.6 ± 96.4 | 18.0 ± 2.0 | 97.7 ± 1.1 | 22.8 ± 1.4 |

^{a}Sample code: PEDHTX, x = mol % of dihydroxyterephthalate repeat unit.

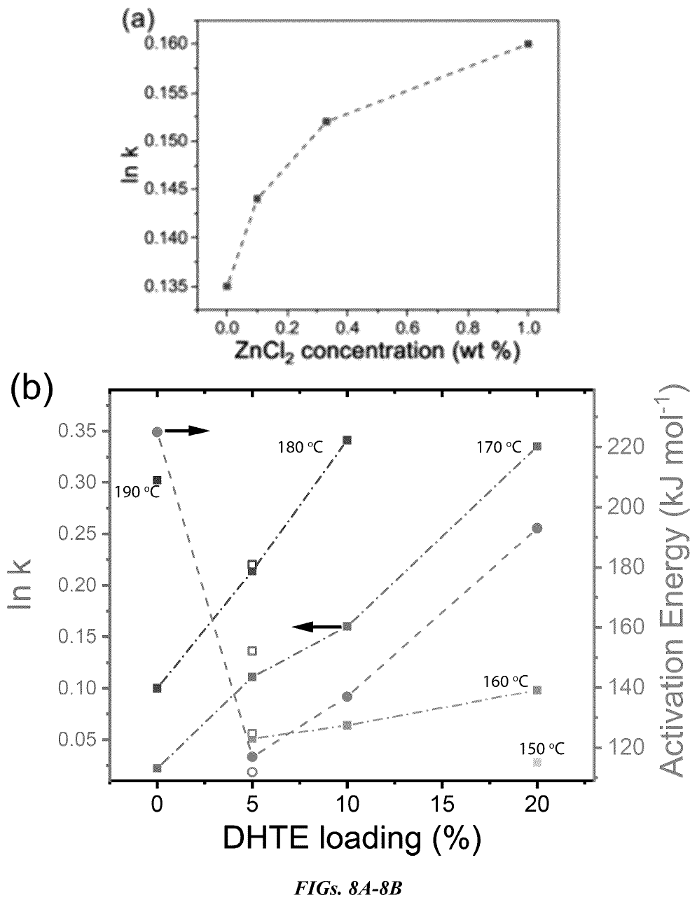

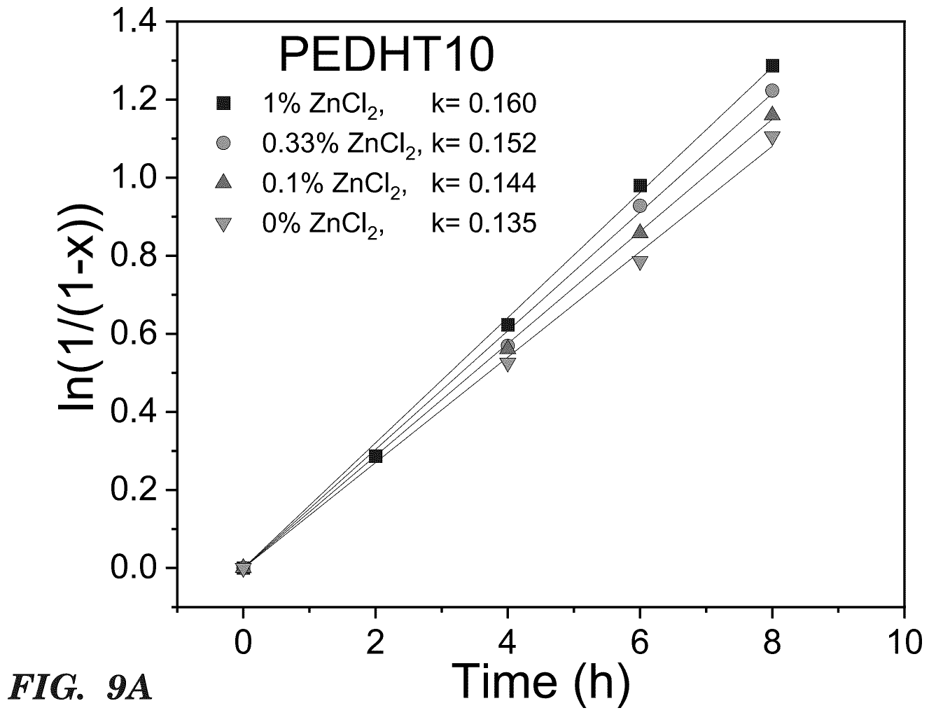

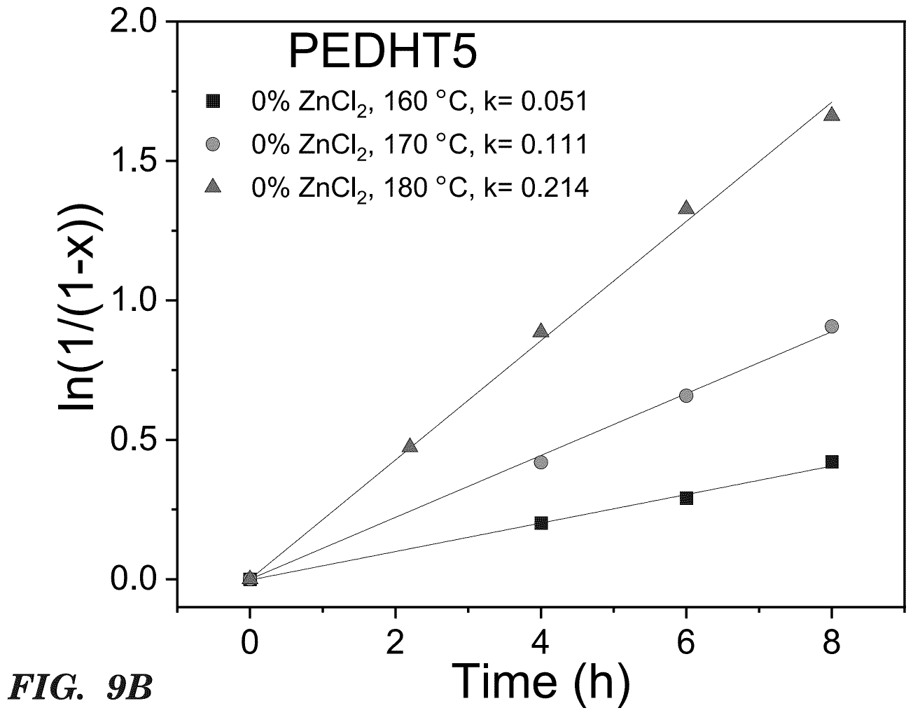

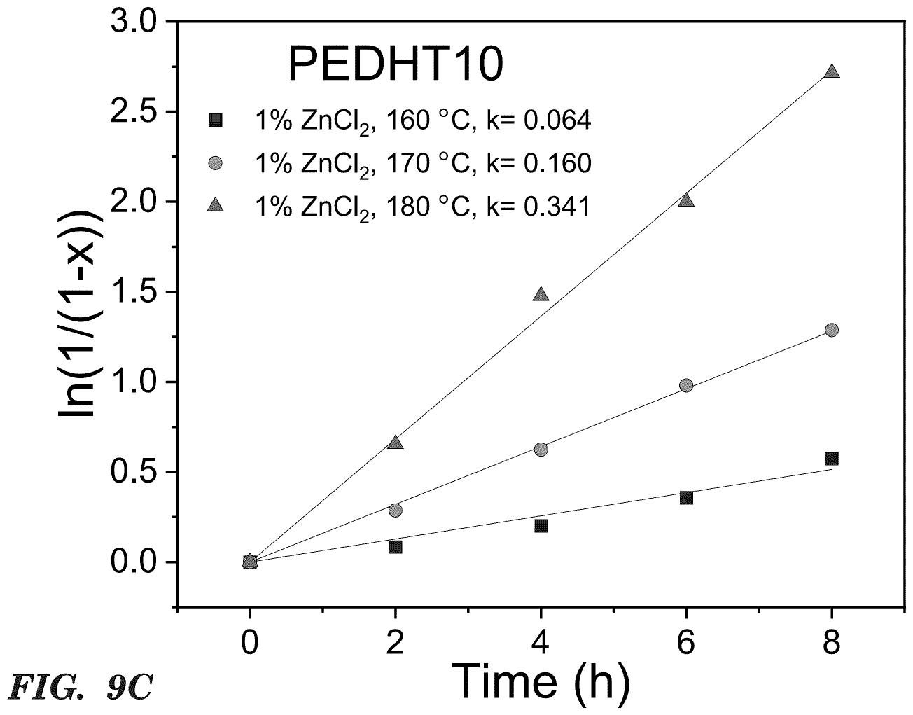

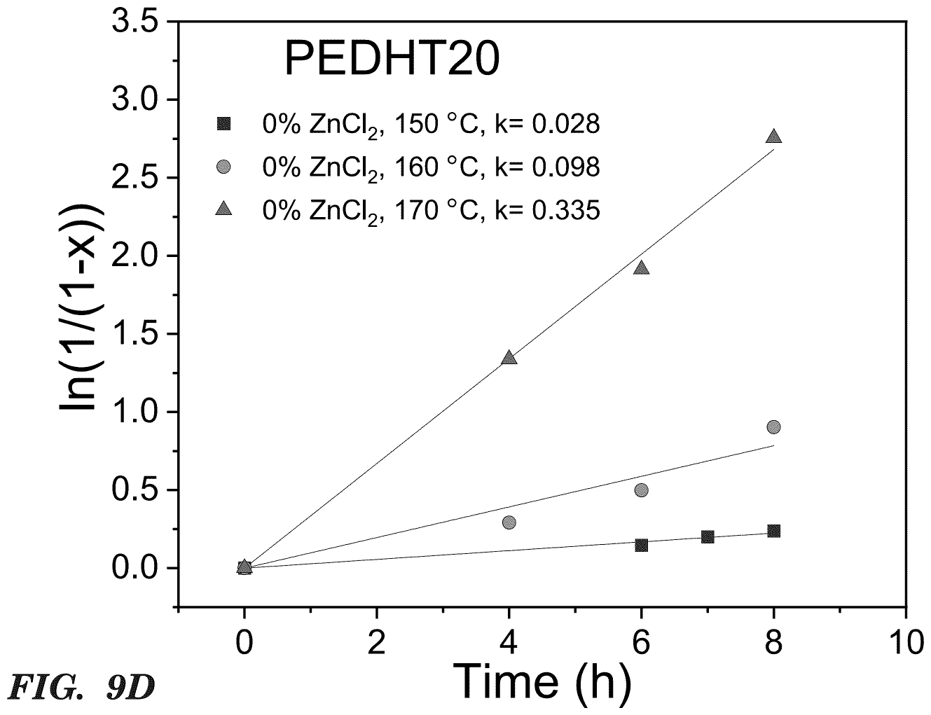

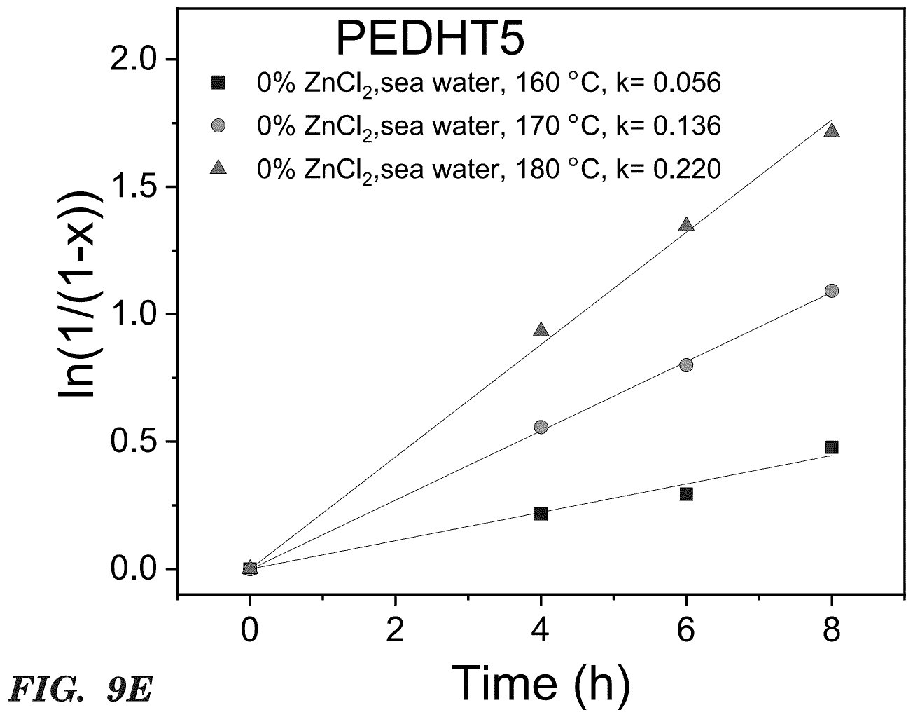

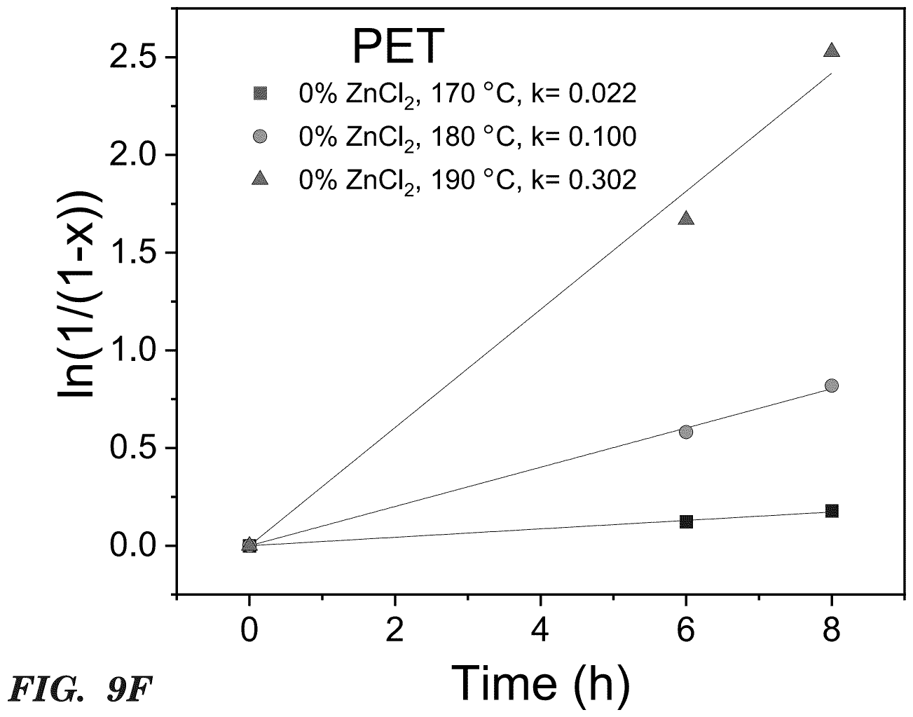

Traditional PET hydrolysis is mediated through catalysis with acidic, basic, or heavy metal solutions. The cations attack the acyl O of the ester, which results in the shift of the electronic cloud away from the acyl C. This allows the O of H₂O to attach to the activated acyl C, cleaving the polymer chain (Achilias et al., “The Chemical Recycling of PET in the Framework of Sustainable Development,” Water, Air and Soil Pollution: Focus 4:385-396 (2004), which is hereby incorporated by reference in its entirety). While this process is quite facile in solvated esters, the highly crystalline nature of PET severely impedes the ingress of reactive species into the solid bulk. Ostensibly, the onset of hydrolysis is relegated to the amorphous phase near the surface. In this work, it was hypothesized that “Trojan Horse” counits like DHTE would facilitate depolymerization by more rapidly releasing oligomeric subchains with far greater affinity for the aqueous phase. To test this, several depolymerization experiments were conducted varying time, temperature, and catalyst composition (Tables 4-6 and FIGS. 8A-B, 9A-F, and 10).

TABLE 4
Hydrolysis Degradation Results of PET and PEDHT
Copolymers Under Different Reaction Conditions

| Sample | ZnCl₂ | Temperature | Time | Degradation |
|---|---|---|---|---|
| Code | Concentration (%) | (° C.) | (h) | conversion^{b} (%) |
| PET | 0 | 170 | 8 | 16.3 |
| | 70 | 170 | 8 | 46.5 |
| PEDHT5 | 0 | 160 | 8 | 34.4 |
| | 0 | 170 | 8 | 59.6 |
| | 0 | 180 | 8 | 81.0 |
| | sea water | 160 | 8 | 38.1 |
| | sea water | 170 | 8 | 66.5 |
| | sea water | 180 | 8 | 82.0 |
| | 0 | 200 | 2 | 98.7 |
| PEDHT10 | 0 | 170 | 8 | 66.9 |
| | 1 | 160 | 8 | 43.7 |
| | 1 | 170 | 8 | 72.4 |
| | 1 | 180 | 8 | 93.4 |
| PEDHT20 | 0 | 150 | 8 | 21.1 |
| | 0 | 160 | 8 | 59.5 |
| | 0 | 170 | 8 | 93.6 |

^{a}Mass ratio of polymer to aqueous solution was 1:30.
^{b}Degradation conversion was calculated from NMR quantitative analysis.

TABLE 5
Hydrolysis Degradation of PET and PEDHT5
Under Different Reaction Conditions

| Sample | ZnCl₂ | Temperature | Time | Degradation |
|---|---|---|---|---|
| Code | Concentration (%) | (° C.) | (h) | conversion^{b} (%) |
| PET | 70 | 170 | 8 | 46.51 |
| | 70 | 180 | 8 | 100.00 |
| | 0 | 170 | 6 | 11.56 |
| | 0 | 170 | 8 | 16.28 |
| | 0 | 180 | 6 | 44.10 |
| | 0 | 180 | 8 | 55.93 |
| | 0 | 190 | 6 | 81.14 |
| | 0 | 190 | 8 | 92.02 |
| | 0 | 160 | 4 | 18.25 |
| | 0 | 160 | 6 | 25.27 |
| | 0 | 160 | 8 | 34.39 |
| PEDHT5 | sea water | 160 | 4 | 19.49 |
| | sea water | 160 | 6 | 25.50 |
| | sea water | 160 | 8 | 38.05 |
| | 0 | 170 | 4 | 34.21 |
| | 0 | 170 | 6 | 48.22 |
| | 0 | 170 | 8 | 59.60 |
| | sea water | 170 | 4 | 42.74 |
| | sea water | 170 | 6 | 55.07 |
| | sea water | 170 | 8 | 66.46 |
| | 0 | 180 | 2.2 | 37.73 |
| | 0 | 180 | 4 | 58.78 |
| | 0 | 180 | 6 | 73.48 |
| | 0 | 180 | 8 | 81.02 |
| | sea water | 180 | 4 | 60.69 |
| | sea water | 180 | 6 | 73.97 |
| | sea water | 180 | 8 | 82.00 |
| | 0 | 200 | 2 | 98.70 |

^{a}Mass ratio of polymer to aqueous solution was 1:30.
^{b}Degradation conversion was calculated from NMR quantitative analysis.

TABLE 6
Hydrolysis Degradation of PEDHT10 and PEDHT20
Under Different Reaction Conditions

| Sample | ZnCl₂ | Temperature | Time | Degradation |
|---|---|---|---|---|
| Code | Concentration (%) | (° C.) | (h) | conversion^{b} (%) |
| PEDHT10 | 1 | 160 | 2 | 8.04 |
| | 1 | 160 | 4 | 18.18 |
| | 1 | 160 | 6 | 30.03 |
| | 1 | 160 | 8 | 43.74 |
| | 1 | 170 | 2 | 24.92 |
| | 1 | 170 | 4 | 46.40 |
| | 1 | 170 | 6 | 62.46 |
| | 1 | 170 | 8 | 72.39 |
| | 0.33 | 170 | 4 | 43.39 |
| | 0.33 | 170 | 6 | 60.46 |
| | 0.33 | 170 | 8 | 70.56 |
| | 0.1 | 170 | 4 | 42.94 |
| | 0.1 | 170 | 6 | 57.61 |
| | 0.1 | 170 | 8 | 68.64 |
| | 0 | 170 | 4 | 40.88 |
| | 0 | 170 | 6 | 54.44 |
| | 0 | 170 | 8 | 66.90 |
| | 1 | 180 | 2 | 48.06 |
| | 1 | 180 | 4 | 77.20 |
| | 1 | 180 | 6 | 86.46 |
| | 1 | 180 | 8 | 93.38 |
| | 1 | 190 | 2 | 99.21 |
| PEDHT20 | 0 | 150 | 6 | 13.60 |
| | 0 | 150 | 7 | 18.24 |
| | 0 | 150 | 8 | 21.10 |
| | 0 | 160 | 4 | 25.24 |
| | 0 | 160 | 6 | 39.21 |
| | 0 | 160 | 8 | 59.46 |
| | 0 | 170 | 4 | 73.79 |
| | 0 | 170 | 6 | 85.23 |
| | 0 | 170 | 8 | 93.64 |
| | 0 | 180 | 2 | 99.01 |

^{a}Mass ratio of polymer to aqueous solution was 1:30.
^{b}Degradation conversion was calculated from NMR quantitative analysis.

Given the demonstrated efficacy of Zn²⁺in the catalysis of PET hydrolysis and glycolysis (Wang et al., “Zinc-Catalyzed Ester Bond Cleavage: Chemical Degradation of Polyethylene Terephthalate,” Journal of Cleaner Production 208:1469-1475 (2019); Pingale et al., “Glycolysis of Postconsumer Polyethylene Terephthalate Waste,” Journal of Applied Polymer Science 115:249-254 (2010), which are hereby incorporated by reference in their entirety), the sensitivity of ZnCl₂ concentration on depolymerization kinetics was first determined by comparing PET and PEDHT10 at 170° C. and 8 hours. PET was quite resilient without catalyst under these conditions, losing only 16 wt % of its mass without catalyst. Using the staggering 70 wt % ZnCl₂ concentration employed by Wang et al., “Zinc-Catalyzed Ester Bond Cleavage: Chemical Degradation of Polyethylene Terephthalate,” Journal of Cleaner Production 208:1469-1475 (2019), which is hereby incorporated by reference in its entirety, mass loss increased nearly threefold to 47 wt % (Table 4). In comparison, uncatalyzed depolymerization of PEDHT10 realized 67% mass loss, increasing slightly to 72 wt % with 1 wt % ZnCl₂. While the significant depolymerization of PEDHT10 in the absence of ZnCl₂ was mainly attributed to the NGP autocatalysis afforded by the DHTE counits, it was also suspected that residual Zn(CH₃COO)₂ used in polymer synthesis played an important role (Li et al., “Depolymerization of Poly (Ethylene Terephthalate) with Catalyst Under Microwave Radiation,” Journal ofAppliedPolymer Science 109:1298-1301 (2008), which is hereby incorporated by reference in its entirety). The rate constants and conversions vary slightly when ZnCl₂ concentration increased from 0% to 1% (FIG. 8A), which suggested that a residual amount of Zn(CH₃COO)₂ (0.004 wt % of solution) already significantly facilitated hydrolysis. The more efficient catalytic effect of Zn(CH₃COO)₂ could be attributed to the fact that it was homogeneously distributed in the powder phase vs. in solution, and also that the acetate ion was a stronger base compared to chloride ion in the solution.

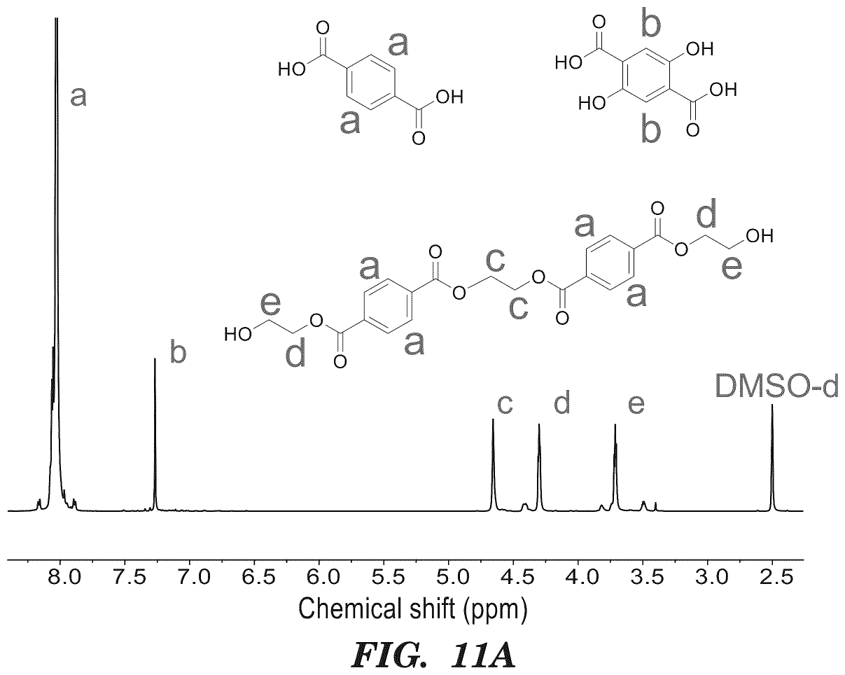

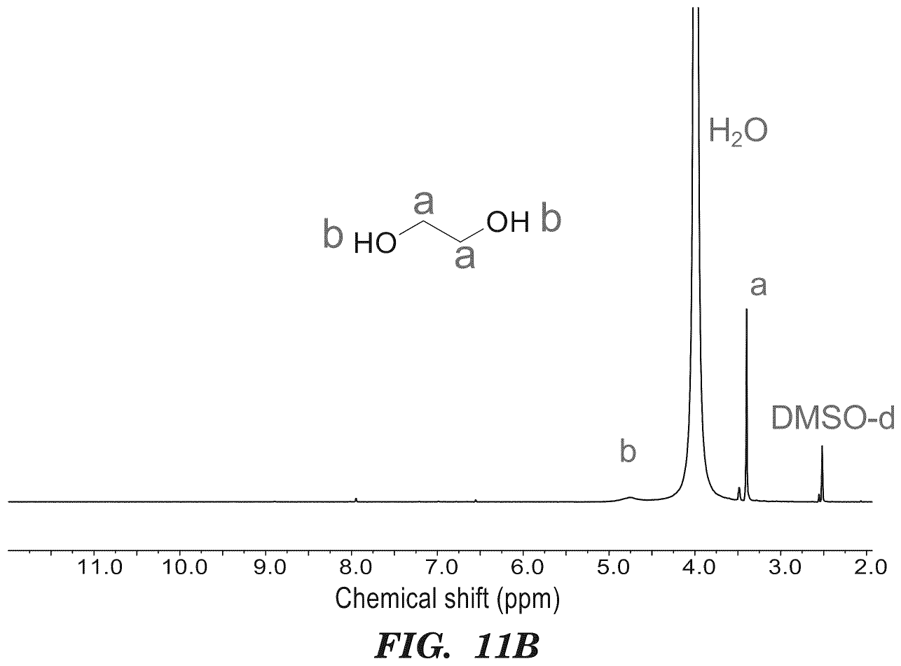

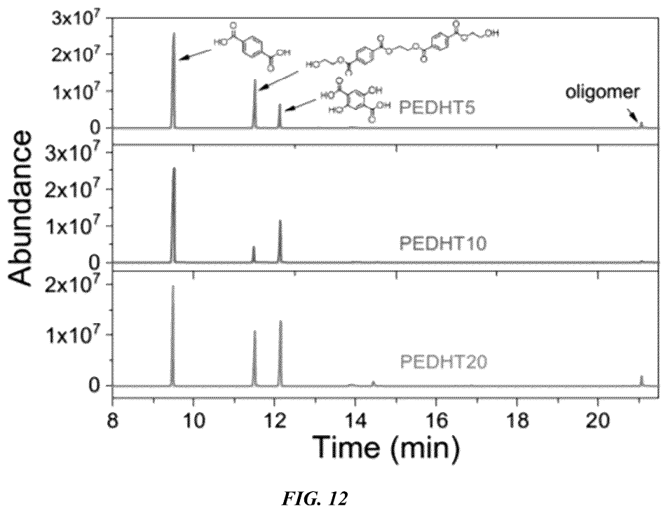

Based on the 11.3 kDa molecular weight estimate for PEDHT10, a random distribution of DHTE repeat units implied that roughly 1 kDa oligomers (6-7 repeat units) were first liberated by the NGP-accelerated hydrolysis. These could be retained in the polymeric solids or lost to the supernatant. To investigate the hydrolysis products, ¹H-NMR and GC-MS were performed (FIGS. 11A-B and 12). The NMR of the solids precipitated from the aqueous solution showed the peak signal at 8.02 ppm, which indicated the four aromatic TPA protons, while the signal at 7.27 ppm corresponded to the two aromatic DHTA protons. The peak signal at 4.66 ppm was the methylene unit from the ethylene glycol linkage in BHET dimer, while the signals at 4.30 ppm and 3.71 ppm were the terminal methylene units of BHET dimer, in accordance with the NMR result of BHET dimer reported in the literature (Fukushima et al., “Organocatalytic Depolymerization of Poly (Ethylene Terephthalate),” Journal of Polymer Science Part A: Polymer Chemistry 49:1273-1281 (2011), which is hereby incorporated by reference in its entirety). In the case of liquid products, the peaks of 3.40 ppm and 4.75 ppm were designated to protons of methylene and hydroxy group of EG, respectively. The GC-MS analysis was used to further verify the purity and the composition of the solid products (FIG. 12 and Table 7). The GC-MS spectra showed three major peaks, corresponding to three distinct molecules. The peaks with retention times of 9.48 min and 12.15 min had mass spectra matching TPA and DHTA, respectively, while the peak at 11.48 min was consistent with BHET dimer. Both the yield and the purity of the solid products were over 90%. Furthermore, DHTA in the composition of the solid products was consistent with the DHTE loading inside the copolymers. Based on this analysis, it was concluded that the liberated oligomers from the PEDHT subsequently underwent hydrolysis exclusively to monomers and BHET dimer.

TABLE 7
Yield and Purity of Solid Products in Different Degradation Conditions

| | Polymer | Yield | TPA | DHTA | BHET | Purity |
|---|---|---|---|---|---|---|
| Entry | (g) | (%)ª | (%)^{b} | (%)^{b} | Dimer (%)^{b} | (%)^{b} |
| 1^{c} | 1.00 | 95.5 | 81.3 | 4.4 | 14.3 | 95.7 |
| 2^{d} | 1.00 | 94.9 | 83.4 | 8.5 | 8.1 | 98.6 |
| 3^{e} | 1.00 | 94.2 | 57.1 | 17.1 | 25.8 | 91.3 |

ªYield = n₁/n₀, where n₁ is the amount of substance of product (monomer and dimer), n₀ is the amount of substance of structural unit of PET copolymer.
^{b}Determined by Gas chromatography-mass spectrometry (GC-MS).
^{c}PEDHT5, 0% ZnCl₂/H₂O, 200° C. for 2 hours.
^{d}PEDHT10, 1% ZnCl₂/H₂O, 190° C. for 2 hours.
^{e}PEDHT20, 0% ZnCl₂/H₂O, 180° C. for 2 hours.

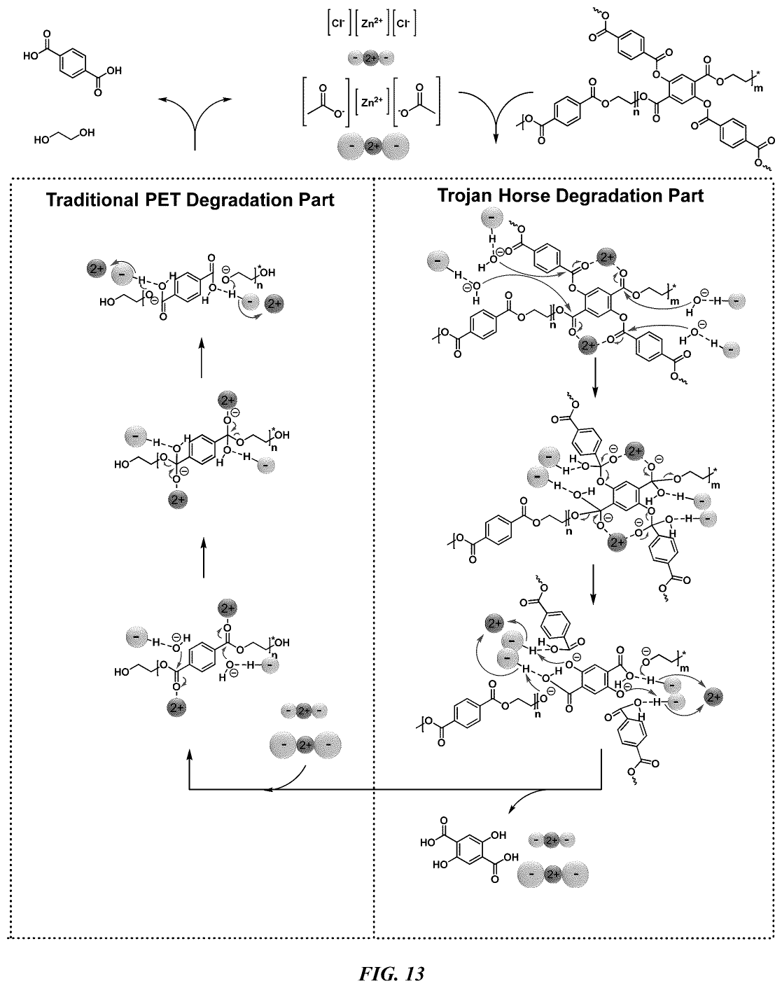

To further understand the depolymerization of PEDHT copolymers, the mechanism should be considered. According to previous studies, the catalyst used for depolymerization will interact with the solvent (water/EG) and the ester bonds of PET to facilitate depolymerization (Imran et al., “Manganese-, Cobalt-, and Zinc-Based Mixed-Oxide Spinels as Novel Catalysts for the Chemical Recycling of Poly (Ethylene Terephthalate) Via Glycolysis,” Polymer Degradation and Stability 98:904-915 (2013); Wang et al., “Zinc-Catalyzed Ester Bond Cleavage: Chemical Degradation of Polyethylene Terephthalate,” Journal of Cleaner Production 208:1469-1475 (2019); Wang et al., “Degradation of Poly (Ethylene Terephthalate) Using Ionic Liquids,” Green Chemistry 11:1568-1575 (2009), which are hereby incorporated by reference in their entirety). In the case of the TH-containing PEDHT copolymers, the proposed degradation mechanism is shown in FIG. 13. Water is first activated in the presence of ZnCl₂ and Zn(CH₃COO)₂ via hydrogen bond interactions (Sun et al., “Solubilization and Upgrading of High Polyethylene Terephthalate Loadings in a Low-Costing Bifunctional Ionic Liquid,” ChemSusChem 11:781-792 (2018), which is hereby incorporated by reference in its entirety). Next, depolymerization reactions are considered at both TH repeat units and PET repeat units. Note that the phenolic group of DHTE reacts with the hydroxy ester end group of the polymer chain to form an ester bond. It was assumed that the chelate forms when Zn²⁺of ZnCl₂ and Zn(CH₃COO)₂ coordinates with the oxygen atom of the ester bond in the polymer backbone and on the TH unit. This coordination effect would allow the ester bonds to be more reactive with the hydroxide ion (OH⁻) of H₂O as reported by Mattsson et al., “A Mild Hydrolysis of Esters Mediated by Lithium Salts,” Tetrahedron Letters 48:2497-2499 (2007), which is hereby incorporated by reference in its entirety. Meanwhile, electronic destabilization occurs, and the electronic cloud shifts to the oxygen atom, making the carbon atom of the ester bond to be positively charged. Then, the nucleophilic oxygen of H₂O attacks the acyl carbon of the ester bond to form carboxylic (—COOH) end group, whereas the proton (H+) of H₂O reacts with the acyl-oxygen of PET to form HOCH₂CH₂—. During this stage, the copolymers break into shorter PET chains. Afterwards, the shorter chains go through a similar degradation mechanism as reported elsewhere (Al-Sabagh et al., “Cu-and Zn-Acetate-Containing Ionic Liquids as Catalysts for the Glycolysis of Poly (Ethylene Terephthalate),” Polymer Degradation and Stability 110:364-377 (2014); Wang et al., “Zinc-Catalyzed Ester Bond Cleavage: Chemical Degradation of Polyethylene Terephthalate,” Journal of Cleaner Production 208:1469-1475 (2019); Sun et al., “Solubilization and Upgrading of High Polyethylene Terephthalate Loadings in a Low-Costing Bifunctional Ionic Liquid,” ChemSusChem 11:781-792 (2018), which are hereby incorporated by reference in their entirety). The Zn²⁺only coordinates with the oxygen atom of the ester bonds in the polymer chains, which displays a similar coordination effect to that of the TH component. Nonetheless, the depolymerization rate of the PET part decreases dramatically due to the absence of the chelate formation. Finally, hydrolysis depolymerization of the shorter polymer chains occurs, and oligomers, dimers, as well as monomers are generated sequentially. Based on the proposed mechanism mentioned above, the formation of the chelate due to the coordination effect between metal ions and specific side functional groups plays an important role in the hydrolysis degradation process.

To further interrogate the efficacy of DHTE in the promotion of PET hydrolysis, a comprehensive series of depolymerization experiments were conducted varying the DHTE content and temperature with no added catalyst. The degradation conversion of PEDHT5 in pure water increased around 50% when the temperature rose each 10° C. from 160° C. to 180° C. in the same period of time (8 hours) (Tables 4-6 and FIG. 8B). Moreover, the rate constant of PEDHT5 showed a two-fold increase every 10° C. A nearly quantitative hydrolysis was carried out at 200° C. in 2 hours in pure water. PET and other PEDHTs showed similar trends of the conversion and rate constant with respect to temperature compared to those of PEDHT5. Therefore, these results suggested that reaction temperature had a significant impact on the degree of depolymerization, especially when the temperature on the planet is mostly between −1 to 50° C., much lower than what had been used for the proof of concept here.

Compared with the traditional chemolysis pathways, here the high activity of the TH-unit was key to PET depolymerization over modest time periods with only catalytic quantities of catalyst. The rapid scission at TH-units released shorter chain fragments, disintegrated large solid particles, which reduced the mass transfer limitations of solid state polyester hydrolysis. The effect of TH-unit composition at 170° C. and 8 hours is presented in Tables 4-6 and FIG. 8B. The degradation conversion increased from 16.3% to 59.6% on moving from 0 mol % to 5 mol % DHTE, and 93.6 wt % at 20 mol % DHTE. A similar trend was observed in the depolymerization rate constant, which showed an increase of around 150% with every 5% increase in DHTE loading, illustrating that depolymerization was strongly dependent on DHTE content.

Besides landfills, an unfortunate final destination for PET waste is the ocean. Accordingly, an ideal PET copolymer would degrade to small molecules rather than microplastics over reasonable time scales. Sea water is rich in metallic ions, such as Na⁺, Mg²⁺, and Ca²⁺, which could act as natural catalysts for electronic destabilization of the polymer chain to facilitate the bond cleavage. Therefore, ocean chemistry could be considered in the design of bottle-grade PET as a triggering condition for hydrolysis. Here, the influence of sea water was investigated by using PEDHT5 and was compared to the results in pure water (Table 4 and FIG. 8B). The results under the condition of 160 to 180° C. for 8 hours were used for comparison. The range of degradation conversion increased between 1.2% to 11.5% in the presence of sea water with corresponding increases in rate constant. These results have proved that the efficiency of PEDHT degradation was better in sea water than that in pure water, which could be attributed to the multiple kinds of metal ions in sea water that coordinated with TH units to catalyze hydrolysis. This suggested that ocean-specific TH units could be designed to better capitalize on marine chemistry to create more environmentally-friendly materials if accidentally released into the ocean.

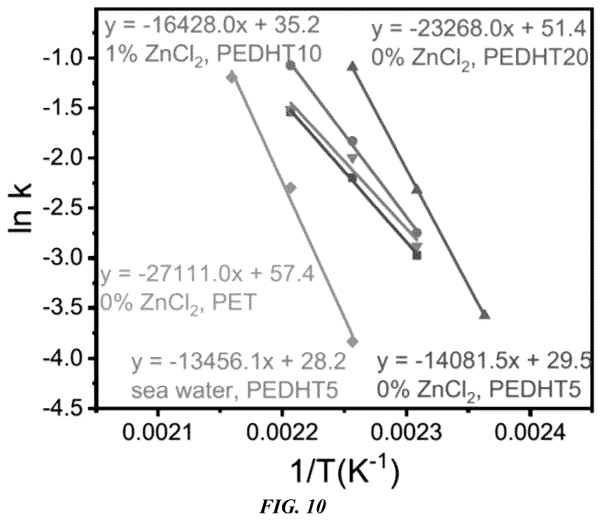

Based on the discussion of the rate constant and the degradation conversion mentioned above, it was concluded that DHTE was a very effective trigger for breaking down PET polymer chain. Nonetheless, to understand the role of TH unit in PET more deeply, the degradation kinetics of PEDHT copolymers with multiple compositions were investigated (FIG. 8B). The activation energy for hydrolysis degradation was 225 kJ mol⁻¹, 117 kJ mol⁻¹, 137 kJ mol⁻¹, and 193 kJ mol⁻¹ for PET, PEDHT5, PEDHT10, and PEDHT20 systems, respectively. The activation energy decreased by nearly 50% with the insertion of 5% DHTE loading, followed by an increasing trend along with DHTE content. This observation could be ascribed to two opposing effects: on one hand, TH units tend to reduce the activation energy owing to the coordination effect with metal ions. On the other hand, DHTE forms additional ester bonds through its phenolic group, which increases the activation energy due to the increased branch/crosslink density and associated reduction in chain mobility. At low DHTE loading (5%), the energy saved by the coordination effect exceeds the energy needed to break the additional ester bonds. However, as DHTE loading keeps increasing (>10%), the energy needed to break the additional ester bonds keeps growing and finally overwhelms the energy saved by metal coordination effect. Therefore, low DHTE loading decreases activation energy due to the coordination effect, but pass through a minimum value due to the network formation thereafter. The pre-exponential factor (A), which implies the collision spots for the reaction, also showed a similar trend as that of activation energy, and the values were e57.4, e29.5, e35.2, and e51.4 for PET, PEDHT5, PEDHT10, and PEDHT20, respectively (FIG. 10). The maximum value shown from PET could be due to the linear and unbranched chain structure, which allows water to go more deeply into the polymer and increase the reactive spots to proceed with the hydrolysis degradation. With DHTE, the permanent covalent network formed by cross-linking could suppress water penetration and decrease the hydrolysis reactive spots, favoring surface erosion. However, as more DHTE are introduced into the polymer, the value of pre-exponential factors increases, suggesting that any reduction in water ingress is overwhelmed by the increasing hydrolytic sensitivity from DHTE. Thus, the pre-exponential factor decreases initially, followed by an increasing trend thereafter.

According to the kinetic data, the time required for hydrolysis degradation of pure PET and PEDHTs in various conditions can be estimated (Table 8). The assumed temperature represents the surface water temperature of different locations and seasons of the ocean, which could be used to analyze the efficiency of TH unit in marine conditions and to tell how surrounding temperature plays an important role in a mild environment. The time for PET to reach 99% degradation in tropical zone of the Indian Ocean is 4 times and 10 times shorter than that in tropical zone of Pacific Ocean and the warm season of Mediterranean Sea, respectively, indicating a wide range of PET degradation rates. Even though the time required to reach a certain extent of degradation conversion looks extremely long, the depolymerization in a natural environment could be much shorter depending on factors such as UV radiation, current/wave force, and biological factors like enzymes and microbes that are unaccounted for in our purely thermally activated experiments (Yoshida et al., “A Bacterium that Degrades and Assimilates Poly (Ethylene Terephthalate),” Science 351:1196-1199 (2016); Koshti et al., “Biological Recycling of Polyethylene Terephthalate: A Mini-Review,” Journal of Polymers and the Environment 26:3520-3529 (2018); Wei et al., “Biocatalysis as a Green Route for Recycling the Recalcitrant Plastic Polyethylene Terephthalate,” Microbial Biotechnology 10:1302 (2017); Danso et al., “New Insights into the Function and Global Distribution of Polyethylene Terephthalate (PET)-Degrading Bacteria and Enzymes in Marine and Terrestrial Metagenomes,” Applied and Environmental Microbiology 84:e02773-17 (2018); Gewert et al., “Pathways for Degradation of Plastic Polymers Floating in the Marine Environment,” Environmental Science: Processes & Impacts 17:1513-1521 (2015); Urbanek et al., “Degradation of Plastics and Plastic Degrading Bacteria in Cold Marine Habitats,” Applied Microbiology and Biotechnology 102:7669-7678 (2018), which are hereby incorporated by reference in their entirety). In the case of PEDHT copolymers, the trend of the required time is similar to that of activation energy and pre-exponential factor. The time passes through a minimum in PEDHT5, which shows a significant decrease of 6 orders of magnitude compared to that of pure PET. Further optimization of TH content and chemical design may also prove to be effective, which is promising in that chemically recyclable and/or biodegradable PET copolymers functionally indistinguishable from legacy PET may be achievable.

TABLE 8
Time Needed for Modified PET Hydrolysis Degradation Under Simulated Marine
Environmentª

| | | (years) for | | | | |
|---|---|---|---|---|---|---|
| | | hydrolysis | | | | |
| | | conversio | Time needed (years) | | Time needed (years) for | |
| | Time | n up to | for hydrolysis | | hydrolysis | |
| | needed | (%) under | degradation conversion | | degradation conversion up | |
| | degradation | of Pacific | up to (%) under tropical | | to (%) under warm season | |
| | co tropical | Ocean | zone of Indian Ocean | | of Mediterranean Sea | |
| Sample | zone | (30° C.) | (35 ° C.) | | (27° C.) | |
| Code | 50% | 99% | 50% | 99% | 50% | 99% |
| PET | 6.42 * 10⁹ | 4.26 * 10¹⁰ | 1.50 * 10⁹ | 9.99 * 10⁹ | 1.57 * 10¹⁰ | 1.04 * 10¹¹ |
| PEDHT5 | 1.73 * 10³ | 1.15 * 10⁴ | 8.15 * 10² | 5.41 * 10³ | 2.75 * 10³ | 1.83 * 10⁴ |
| PEDHT5* | 8.11 * 10² | 5.39 * 10³ | 3.95 * 10² | 2.62 * 10³ | 1.26 * 10³ | 8.40 * 10³ |
| PEDHT10 | 1.40 * 10⁴ | 9.32 * 10⁴ | 5.82 * 10³ | 3.87 * 10⁴ | 2.41 * 10⁴ | 1.60 * 10⁵ |
| PEDHT20 | 8.07 * 10⁶ | 5.36 * 10⁷ | 2.32 * 10⁶ | 1.54 * 10⁷ | 1.74 * 10⁷ | 1.15 * 10⁸ |

*PEDHT5 in seawater
^{a}World Sea Temperatures. https://www.seatemperature.org/

In this work, PET incorporated with bioderived diphenolic TPA counits was successfully synthesized by a two-step polycondensation reaction. FTIR analysis revealed that trend of DHTE loading in the copolymers was consistent with the change in ratio of absorption intensity, and the phenolic group reacted with hydroxy ester group of the monomer and polymer chain to form the permanent covalent network. Based on the investigation on multiple reaction parameters, including catalyst concentration, hydrolysis time/temperature, and DHTE loading, the hydrolytic degradation of PEDHT copolymers with dilute metal catalytic aqueous solution can proceed easily under far milder conditions with no emission of toxic substances compared to that of traditional PET hydrolysis. Herein, the effect that DHTE imposed on degradability behaviors was the key to the improvement of PET chemical recycling. According to the hydrolysis kinetic data, the solid state degradation of PEDHT copolymers was first-order. DHTE destabilized the chemical resilience of PET, where PEDHT5 showed the most rapid depolymerization with an increase in the speed of degradation by almost 6 orders of magnitude compared to PET.

The proposed mechanism of PEDHT hydrolysis degradation involves interactions between backbone ester bonds, ortho-position DHTE esters, and the metal ions, which result in the formation of chelate. This coordination effect promotes the reactivity of the ester bonds in the polymer toward being attacked by the hydroxide ion of the water molecule, which facilitates depolymerization. Post depolymerization, the reclaimed solid product were two precursors (TPA and DHTA) and BHET dimer, which could be easily separated from water, and could further be regenerated into brand new polymer without performance deterioration. Furthermore, the thermal properties of PEDHT copolymers showed slightly higher T_{g} (4-7° C.) than that of PET, due to the increased energy barrier for the chain motion of the permanent covalent network in the amorphous domain. The suppression effect on the crystal thickness caused by the comonomer unit lead to Tₘ depression, improving processability. In the case of mechanical performance, the 3D network reinforced the rigidity of the copolymers, including Young's modulus, yield strength, and plastic deformation strength, but also caused the elongation at break to decrease along with increasing DHTE loading. These results suggest that DHTE is not only capable of being used for modifying PET degradability, but also conserves the thermal performance and is able to tune the mechanical properties of the materials to match requirements for the specific application.

In summary, this work provides a novel strategy for PET chemical recycling while potentially maintaining full functional equivalency and compatibility with legacy PET. Moreover, the Trojan horse chemical used for polymer synthesis can be derived from biobased SA and the overall degradation procedure is environmentally friendly compared to those traditional approaches since water is the only needed material. Further studies including toxicology, techno-economic and life-cycle assessment, and gas barrier aspects, will be needed to provide a more comprehensive understanding of these materials before they are ready for end-use applications like food packaging.

### Example 6—Oxidatively Sensitive Olefin-Modified PET

### Synthesis of C18:1 Diacid

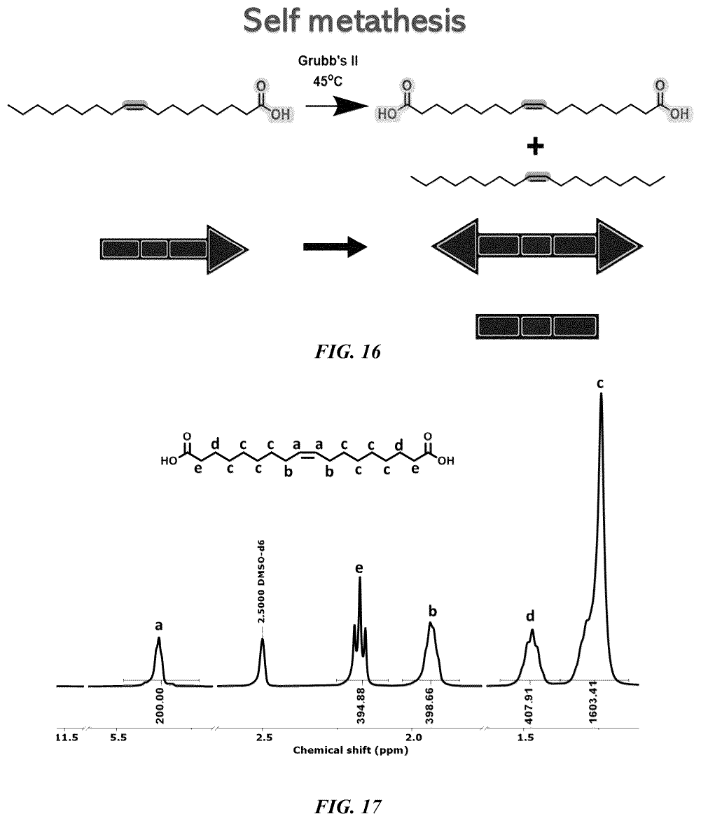

C18:1, the monomer shown in FIG. 15E, was prepared via the metathesis reaction shown in FIG. 16. Oleic acid (28.2 g) (90% purity, technical grade) was charged in a reactor vessel with an argon sparge maintained at 45° C. for 30 minutes. Grubbs 2nd generation catalyst (15 mol) was wetted with hexane and purged with argon, and pressure fed into the reactor maintained at 45° C. for 24 hours. The resulting precipitate (diacid) was washed with hexane and recrystallized with ethyl acetate-hexane mixtures and toluene 3-5 times until product purity of ˜99% was achieved. ¹H NMR of the product is shown in FIG. 17.

### C18-Esterification (Prepolymer Synthesis)

The required amount of precursors: EG (ethylene glycol) and (Z)-octadec-9-enedioic acid (molar ratio 10:1) were transferred to a 300 mL stainless steel Parr reactor, equipped with a paddle agitator, thermocouple, and dip tube. The esterification was catalyzed by zinc acetate, and temperature and pressure were maintained at 220° C. and 110 psi, respectively, with a mild argon-sparge maintained over the reaction mass for 5 hours to remove water and drive reaction equilibria. This step involved direct esterification of (Z)-octadec-9-enedioic acid with ethylene glycol with a ten molar excess of ethylene glycol. The product was distilled under a vacuum for 2-3 hours at 125° C. to remove excess ethylene glycol from the mixture. This step was crucial before polycondensation as glycol readily vaporizes at 240° C. under vacuum and may entrain prepolymer along with glycol into the cold trap.

### Polycondensation

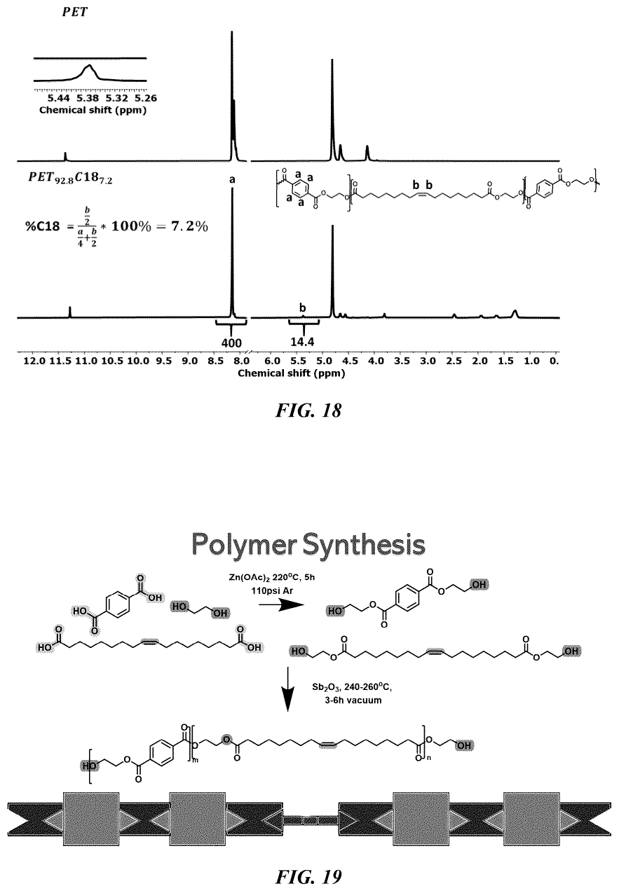

Prepolymers BHET and C18 glycol adduct were reacted in the presence of catalyst antimony trioxide at a temperature of 240-260° C. under high vacuum conditions (˜23 psi vacuum) according to the reaction scheme shown in FIG. 19. Intense agitation and high vacuum ensured rapid removal of ethylene glycol that accelerated forward reaction according to Le Chatelier's principle. The reaction was carried out for 8 hours to achieve a high molecular weight. The melt was rapidly quenched upon contact with air and comminuted to fine particles with a cryo-mill. The fine powder was vacuum dried to reduce the moisture content of the particles and to prevent agglomeration during prolonged storage. Relative molecular weight was determined by Gel permeation chromatography against PMMA standards. ¹H-NMR tests were performed to check for unsaturated functionalization of PET as well as end-group analysis (FIG. 18).

Oxidative Cleavage of the Copolymer Using KMnO₄/NaIO₄ Couple

Potassium permanganate has been used to cleave oleic acid into azelaic and pelargonic acid. The same principle was used for cleaving the monounsaturated diester at the double bond incorporated into the PET polymer. The unsaturated polymer (1 g) was added to a 30 ml solution of 0.036M KOH solution with 0.055 mol KMnO₄ and 0.0028 mol NaIO₄ and heated to 35° C. while stirring for dissolution of KMnO₄. The reaction was carried out at temperature intervals of 10° C. for 12-48 hours. Upon reaction completion, the slurry was filtered, and the residue was acidified with the slow addition of HCl accompanied by the exothermic bubbling at 64° C. till the residue contaminated with MnO₂ turned faint yellow to nearly colorless indicating the endpoint for reduction of Mn⁷⁺/Mn⁴⁺ions to Mn²⁺ ions. The slurry was filtered, and the residue was washed with water and vacuum dried. Finally, the residue was vacuum dried and characterized to quantify the extent of depolymerization. The process was repeated for different incorporation ratios of the unsaturated in the copolymer.

### Ozonolysis

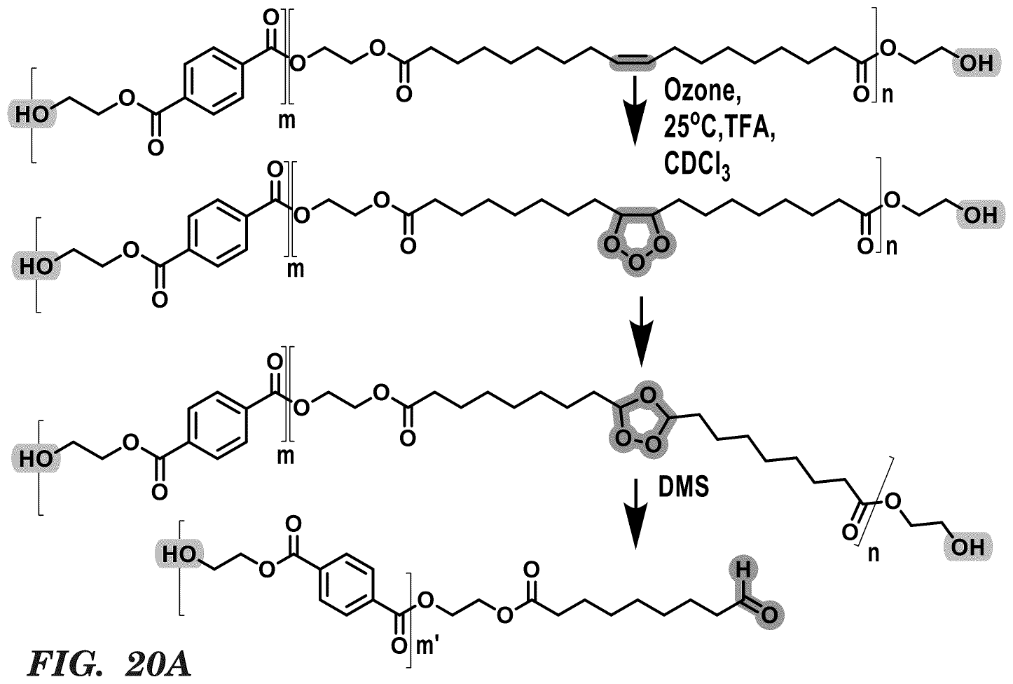

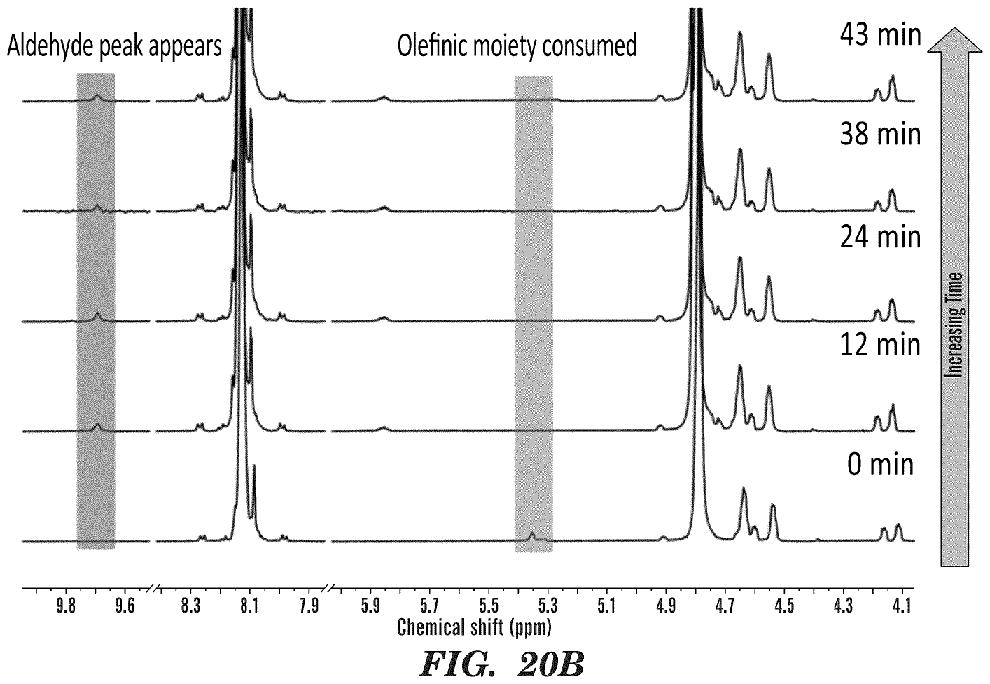

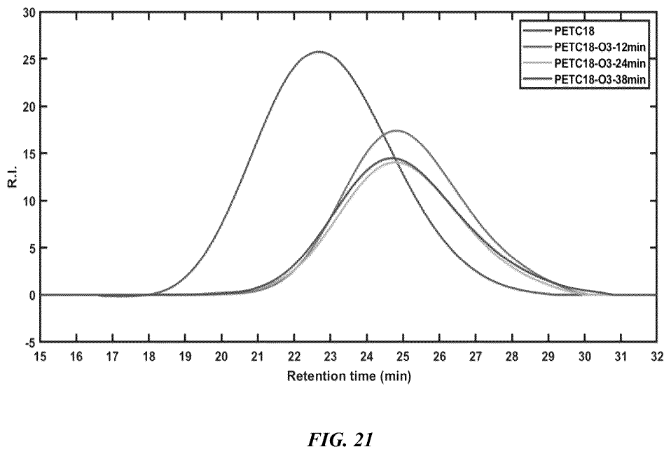

Ozonolysis proceeded according to the Criegee mechanism as illustrated in FIG. 20A. The first step involved the formation of a molozonide that decomposed to yield a carbonyl compound. Decomposition of the Criegee intermediate (peroxidic compound) to an aldehyde required reductive workup carried out in the presence of dimethyl sulfide. The finely divided polymer obtained after cryo-milling was solubilized in trifluoroacetic acid. The reaction contents were vigorously stirred to reduce external diffusional resistance with ozone bubbling at a rate of 0.4 mmol/min for a duration of 30 minutes. The temperature was maintained well below 25° C. using a water bath. This was followed by addition of 0.1 ml of DMS while the reaction slowly equilibrated to room temperature. Aliquots were taken, and the reaction was quenched by precipitating the polymer upon adding water as a nonsolvent. The polymer was filtered, vacuum dried to the strip residual solvent, and characterized by ¹H-NMR (FIG. 20B) and GPC (FIG. 21) to quantify the extent of depolymerization and alkene consumption.

### DSC Analysis

Differential scanning calorimetry was performed on (DSC, TA instruments Discovery 2500) to conduct a thermal analysis of the copolymer pre- and post-oxidation. Nitrogen was used as a purge gas at 50 ml/min. Samples were weighed and sealed in hermetically sealed aluminum pans. Each cycle consisted of heating the sample from 25° C. to 300° C. (ramp rate 10° C./min), isothermal equilibration for 5 minutes, followed by cooling the sample back to 25° C.(ramp rate 10° C./min). Two cycles were performed for each dataset. The T_{g}, ΔH_{f}, and T_{c} were computed for unoxidized samples.

### GPC Analysis

Gel permeation chromatograms were recorded on Tosoh Ecosec HLC-8320GPC equipped with a UV and RI detector in tandem. Samples were pre-dissolved in trifluoroacetic acid (sample conc. ˜6-7 mg/ml), and HFIP was chosen as an eluent for PET-copolymers at a flow rate of 0.3 ml/min. Samples were compared against PMMA calibration standards for determining Mₙ and M_{W}.

### Example 7—Results and Discussion of Example 6

NMR plots traced the stepwise conversion of oleic acid into the diacid upon metathesis using Grubbs 2 as a catalyst. Recrystallization was important to obtain diacid with >95% purity. The purity was assessed both with GCMS and NMR prior to esterification with glycol.

A series of polymeric PET-C18 formulations were prepared by changing the C18 dosage during the polycondensation stage, and mechanical and thermal properties were evaluated against Lab made PET (sans additives) (Table 9). Gel permeation chromatography was used to obtain the M_{W} and D of the synthesized series. ¹H-NMR corroborated the presence of the olefinic moiety in the backbone.

TABLE 9
Molecular and Thermal Characteristics of C18:1 Copolymers of PET

| | mol % | | | | | | | |
|---|---|---|---|---|---|---|---|---|
| Sample | C18:1 | | | Tg | | Ton_{ch}-Tp_{ch} | | |
| Name | (targeted) | Mn | Mw | (° C.) | Tm(° C.) | (° C.)^{a} | Ton_{ch} | ΔHₘ |
| Lab-PET | | | | 78.3 | 249.2 | 10.4 | 193.9 | 40.4 |
| PET_{98.7}C18_{1.3} | 97.5/2.5 | 34.7 | 74.3 | 69.6 | 242.9 | 3.2 | 201.1 | 43.7 |
| PET_{97.9}C18_{2.1} | 95/5 | 29.0 | 63.3 | 59.6 | 247.6 | 10.4 | 205.9 | 38.5 |
| PET_{97.6}C18_{2.4} | 96/4 | 15.4 | 51.1 | 63.2 | 245.4 | 3.9 | 215.12 | 39.1 |
| PET_{93.6}C18_{6.4} | 92.5/7.5 | 34.1 | 94.7 | 49.4 | 241.6 | 7.5 | 192.4 | 32.2 |
| PET_{93.3}C18_{6.7} | 92.5/7.5 | 36.1 | 87.7 | 46.1 | 242.5 | 11.9 | 199.4 | 36.9 |

ªIn crystallization during the DSC cooling cycle, the temperature difference between the onset of crystallization and the peak of the crystallization exotherm. This is a measure of the crystallization rate, with small values reflecting a higher rate of crystallization.

The strength in the premise of the presence of a trojan horse moiety in the chain is the reactivity of these moieties being mirrored at macromolecular scales at low dosages. This is possible if the trojan horse units get seeded stochastically in the backbone. Aggregating trojan horse units will reduce the efficacy of a trojan horse unit as they don't effectively lead to different scission centers along the chain. A random distribution of trojan horse units along the chain entails random chain scission of the polymer leading to accelerated depolymerization of the polyester. Random sequence distribution of the units was verified using ozonolysis, and secondary evidence was also provided by thermomechanical characterization. The randomness of the copolymeric unit can be gleaned by selectively cleaving the trojan horse unit and observing the peak distortion post-depolymerization.

The insertion of the aliphatic spacer reformed the thermal behavior of the polymer, as evidenced by DSC scans. The polymer's glass transition temperature was suppressed, indicating a lowering of the activation energy of the polymer to commit long-chain motion brought about by the flexible C18 unit occupying a large proportion of the free volume and lowering the density of ester linkages per unit volume of the chain. The Tₘ fell due to imperfection in the lattice due to the trojan horse unit. The addition of the flexible chain caused a significant increase in both conformational and compositional entropy at melt, thereby suppressing the melting point of copolymers. The presence of the comonomeric unit at low dosages led to a faster onset of crystallization from the melt owing to an increased degree of supercooling due to suppressed T_{g} however, at comonomeric loadings˜7%, a slightly delayed onset of crystallization was observed probably due to the reduced thermal barrier to adopting disruptive conformations for stable nuclei to grow. However, upon slight cooling, this increased flexibility favored the chain to adopt nuclei-forming configurations leading to rapid nucleation as evidenced by a sharp, hot crystallization and higher peak temperature translating to faster overall crystallization time. The overall reduction in percentage crystallinity was observed as comonomeric unit loadings were increased, as evidenced by the reduced enthalpy of fusion as the comonomer constitutes the noncrystallizable fraction of the polymer that is expected to be pushed out to the surface of the crystal upon prolonged equilibration. These will also preclude further densification of spherulites however, upon low loadings can plasticize while acting as tie strands between two crystal domains and cause rapid kinetic perfection of isomorphs of PET.

Oxidative Scission of TH Units With KMnO₄/NaIO₄ Couple

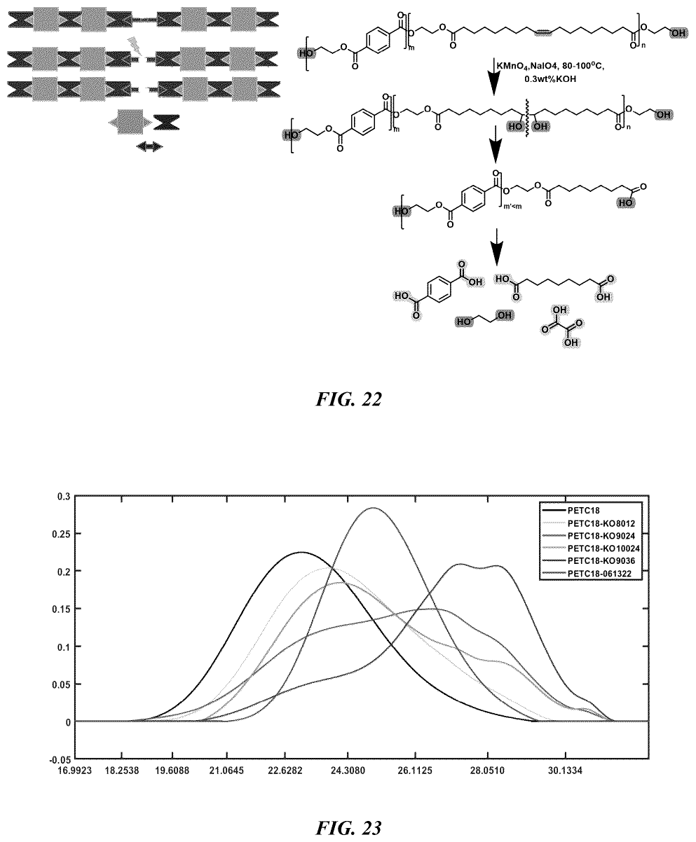

The PET/C18 formulations had an embedded unsaturation which acted as an oxidant labile site to initiate depolymerization. Potassium permanganate is known to oxidize alkenes to cis diols under basic conditions and, upon prolonged heating, results in the oxidative breakdown of the cis diol to carboxylic acids as shown in FIG. 22.

Under alkaline conditions, the permanganate ion adds to the double bond forming a cyclic hypomanganate (Mₙ (V) oxidation state) diester adduct that subsequently hydrolyzes to form a monoester and finally forms the cis diol. Coupling this oxidant with NaIO₄ ensures cleavage of the diol. Further, the hypomanganate diester can potentially oxidatively rearrange to cyclic manganate (VI) ion that can be reoxidized to permanganate by metaperiodate. Hypomanganate ions readily disproportionate into Mₙ VI, and Mₙ IV states in a moderately alkaline medium. Also, permanganate is likely to form manganate ions upon heating. These manganate ions can disproportionate into permanganate and Mₙ IV ions or can be oxidized by sodium meta periodate These result in a nexus of oxidation and hydrolysis throughout the bulk of the polymer. Alkene oxidation with catalytic quantities of permanganate is continually regenerated by sodium meta periodate due to its higher standard cell potential of 1.6V. This can increase the half-life of the higher oxidation state species (Mₙ⁷⁺), allowing enough time for the oxidant to overcome transport barriers in a slurry-based depolymerization system.

PET is extremely hydrophobic, and the reaction zone is usually limited to a few layers below the surface. As depolymerization ensues, it exposes a fresh surface with readily accessible oxidant-prone sites making a pulsed availability of oxidant-prone moiety. Co-oxidant metaperiodate renders the oxidant aeonic due to repetitive oxidations allowing it to consume the trojan horse in both the bulk and fresh surface effectively while minimizing the amount of permanganate required.

In the absence of an oxidant primary mechanistic mode of depolymerization is surface hydrolysis, as PET is extremely hydrophobic. The hydrolytically accessible sites are located in the amorphous regions of PET, with end chains being the site of maximum depolymerization activity. The presence of oxidant labile moiety randomly distributed in the chain leads to a stochastically directed scission by the oxidant resulting in a breakneck decrease in molecular weight vis-a-vis end-chain scission. Hydrophilicity increases with an increase in the concentration of acid end groups and a subsequent decrease in molecular weight, further catalyzing the reaction to completion. The oxidation dominant regime brings about coerced random chain scission resulting in a mix of oligomers that undergo milder and faster hydrolysis leading to a quick depolymerization cascade to monomers.

The trojan horse-laced polymer particles were suspended in an alkaline oxidant-rich slurry subjected to differing reaction extents as a function of time and temperature. Temperatures>T_{g} were chosen to obviate diffusional barriers in a heterogeneous reaction system. NMR and GPC traced the extent of depolymerization as a function of the olefinic moiety's consumption and molecular weight reduction. Exemplary GPC results of PET_{97.6}C18_{2.4} for various times and temperatures are shown in FIG. 23. In the legend of FIG. 23, PETC18-KO8012 refers to an oxidation experiment conducted at 80° C. for 12 hours. Analogously, PETC18-K09024, PETC18K09036, and PETC18-KO10024 refer to experiments at 90° C./24 hours, 90° C./36 hours, and 100° C./24 hours, respectively.

At 80° C., the control PETC18 (in the absence of oxidant) exhibited a very slight reduction in molecular weight that could be attributed to mild end-chain hydrolysis with almost no change in the % D.U. while the presence of the oxidant resulted in a 21% reduction in weight loss of the residue indicating an 18% increase in monomer ejection as monomeric salts are soluble in alkaline solutions. Monomer ejection was improved at 90C. However, the rate of hydrolysis also increased as one ascends farther from T_{g}, causing a narrowing of the gap between the GPC traces for the insoluble residue at differing timestamps for the control vis-a-vis the reactive conditions. Most of the alkene was consumed within 48 hours, which proved the permeance of the oxidant inside the bulk of the polymer. The same experiments at 100C revealed an increased monomer ejection rate due to faster hydrolysis however, the half-life of Mₙ⁷⁺ (the most potent oxidant species) is likely to be reduced, and more Mₙ⁴⁺ is likely to be present in the medium slowing down oxidation as seen by a higher % DU at intermediate stages of the reaction.

The experimental conditions at 80° C., 90° C., and 100° C. revealed the competing nature of both hydrolysis and oxidation, with the rate of hydrolysis being a strong function of temperature while the most potent oxidant being consumed more rapidly compared to the diffusional time scale resulting in overall slower oxidation. This hints at the existence of optimum temperature between 90° C. and 100° C. prevailing at existing reaction concentrations. Also, the existence of a second optimum might be evident at higher temperatures that allow for faster hydrolysis, reduced dielectric constant, and faster breach of the oxidant to the olefinic moiety inside the chain.

### Example 8—Other Cleavable PET Copolymers

Additional PET copolymers incorporating the cleavable monomers illustrated in FIGS. 15B-G were prepared and subjected to various depolymerization conditions as shown in Table 10. In each case the polymer was powdered and suspended in an aqueous slurry containing a depolymerization catalyst. The amount of mass loss was reported according to the retained solids. With the exception of PET-E3.4, the molecular weight and dispersity values of the retained solids were unchanged throughout the depolymerization. In the case of PET-E3.4, the initial number average molecular weight was 15.7 kDa and the initial dispersity was 3.3.

TABLE 10

| | Mn, | | | | | polymer(g)/ | Temp, | % wt |
|---|---|---|---|---|---|---|---|---|
| Entry^{a} | kDa | Ð | Catalyst | [molarity] | time(h) | water ratio(ml) | ° C. | loss |
| PET | 39.9 | — | None | 0 | 4.5 | 30 | 180 | 17.1 |
| PET | 39.9 | — | NaOH | 1 | 8 | 15 | 100 | 65.3 |
| PET | 39.9 | | KOH | 1 | 1 | 30 | 80 | 7.2 |
| PET | 39.9 | — | KOH | 1 | 3 | 30 | 80 | 15.7 |
| PET | 39.9 | — | KOH | 1 | 4 | 30 | 80 | 22.2 |
| PET | 39.9 | — | KOH | 1 | 1 | 30 | 90 | 13.7 |
| PET | 39.9 | — | KOH | 1 | 3 | 30 | 90 | 21.7 |
| PET | 39.9 | — | KOH | 1 | 4 | 30 | 90 | 31.6 |
| PET | 39.9 | — | KOH | 1 | 1 | 30 | 100 | 13.5 |
| PET | 39.9 | — | KOH | 1 | 3 | 30 | 100 | 34.7 |
| PET | 39.9 | — | KOH | 1 | 4 | 30 | 100 | 46.3 |
| PET-B5 | 21.4 | 3.2 | NaOH | 1 | 7.5 | 15 | 100 | 82.3 |
| PET-B5 | 21.4 | 3.2 | KOH | 1 | 1 | 30 | 80 | 14.2 |
| PET-B5 | 21.4 | 3.2 | KOH | 1 | 2 | 30 | 80 | 17.3 |
| PET-B5 | 21.4 | 3.2 | KOH | 1 | 4 | 30 | 80 | 24.9 |
| PET-B5 | 21.4 | 3.2 | KOH | 1 | 1 | 30 | 90 | 21.2 |
| PET-B5 | 21.4 | 3.2 | KOH | 1 | 2 | 30 | 90 | 30.2 |
| PET-B5 | 21.4 | 3.2 | KOH | 1 | 4 | 30 | 90 | 39.5 |
| PET-B5 | 21.4 | 3.2 | KOH | 1 | 1 | 30 | 100 | 29.9 |
| PET-B5 | 21.4 | 3.2 | KOH | 1 | 2 | 30 | 100 | 41.9 |
| PET-B5 | 21.4 | 3.2 | KOH | 1 | 4 | 30 | 100 | 53.6 |
| PET-C1.5 | 13.1 | 2.1 | NaOH | 1 | 7.5 | 15 | 100 | 90.2 |
| PET-D5 | 25.5 | 3.5 | −water | 0 | 4.5 | 30 | 180 | 59.8 |
| PET-E3.4 | 3.42 | 3.33 | KOH/KMnO₄/NaIO₄ | 0.036 | 24 | 30 | 100 | 31.0 |
| PET-E3.4 | 3.02 | 3.52 | KOH/KMnO₄/NaIO₄ | 0.036 | 36 | 30 | 100 | 21.6 |
| PET-E3.4 | 2.75 | 3.65 | KOH/KMnO₄/NaIO₄ | 0.036 | 48 | 30 | 100 | 30.5 |
| PET-E3.4 | 3.37 | 3.27 | KOH/KMnO₄/NaIO₄ | 0.036 | 24 | 30 | 90 | 13.5 |
| PET-E3.4 | 1.79 | 5.36 | KOH/KMnO₄/NaIO₄ | 0.036 | 36 | 30 | 90 | 16.6 |
| PET-E3.4 | 2.65 | 3.53 | KOH/KMnO₄/NaIO₄ | 0.036 | 48 | 30 | 90 | 25.1 |
| PET-E3.4 | 6.44 | 2.27 | KOH/KMnO₄/NaIO₄ | 0.036 | 12 | 30 | 80 | 5.1 |
| PET-E3.4 | 3.78 | 3.17 | KOH/KMnO₄/NaIO₄ | 0.036 | 36 | 30 | 80 | 14.3 |
| PET-E3.4 | | | KOH/KMnO₄/NaIO₄ | 0.036 | 48 | 30 | 80 | 20.8 |
| PET-F5 | | | KOH | 1 | 1 | 30 | 100 | 46.8 |
| PET-F5 | | | KOH | 1 | 2 | 30 | 100 | 68.6 |
| PET-F5 | | | KOH | 1 | 3 | 30 | 100 | 74.0 |
| PET-F5 | | | KOH | 1 | 5 | 30 | 100 | 88.3 |

^{a}PET is a pure PET homopolymer. PET-XY refers to a copolymer containing repeat unit X at Y mol %. The chemical structure of X is given by the corresponding letter designated in FIGS. 15A-G.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A cleavable polymer comprising one or more repeat units containing group A and one or more repeat units containing group B,
wherein
the repeat unit containing group A is 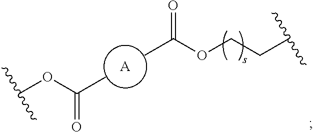
the repeat unit containing group B is 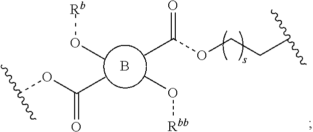 [symbol]
is a chemically cleavable bond;
group 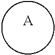
is selected from the group consisting of arylene, heteroarylene, heterocyclene, and C₅₋₈ cycloalkylene;
group 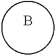
is selected from the group consisting of phenylene, furanylene, thiphenylene, and naphtanylene, wherein phenylene, furanylene, thiphenylene, and naphtanylene can be optionally substituted from 1 to 2 times with R;
R^{b} and R^{bb} are independently selected from —H, 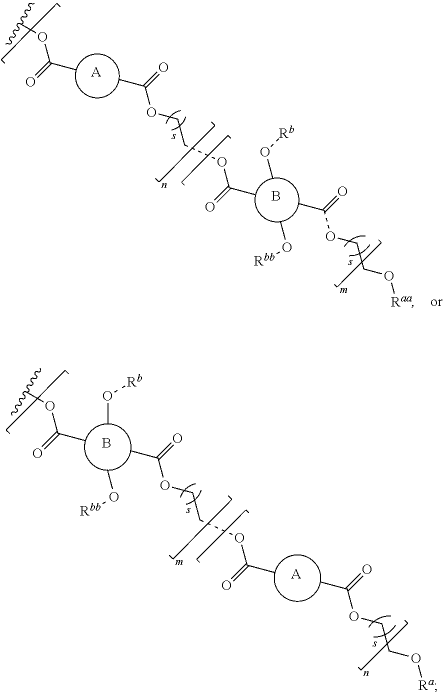
R^{a} and R^{aa} are independently selected from the group consisting of —H, —C1.30 alkyl, and —C₁₋₃₀ alkyl-OH;
R is —OR¹, —NHR², —NO₂, or halogen;
R¹ is H, C₁₋₃₀ alkyl, or aryl;
R² is —C(O)—R¹;
s is 1 to 30;
n is 1 to 1,000,000; and
m is 1 to 1,000,000.

2. The cleavable polymer of claim 1, wherein the repeat unit containing group A is

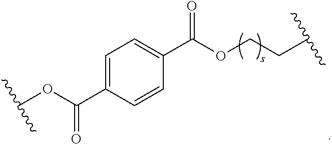

3. The cleavable polymer of claim 1, wherein the repeat unit containing group B is

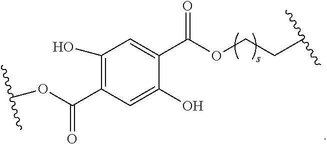

4. (canceled)

5. The cleavable polymer of claim 1, wherein the polymer comprises a moiety of formula:

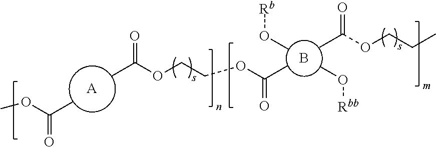

6. The cleavable polymer of claim 5, wherein the polymer has the structure of Formula (I):

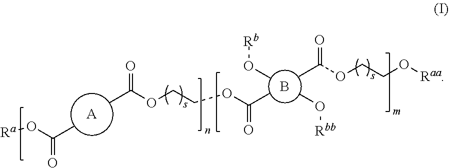

7. The cleavable polymer of claim 6, wherein the polymer has the structure of Formula (Ia) or Formula (Ib 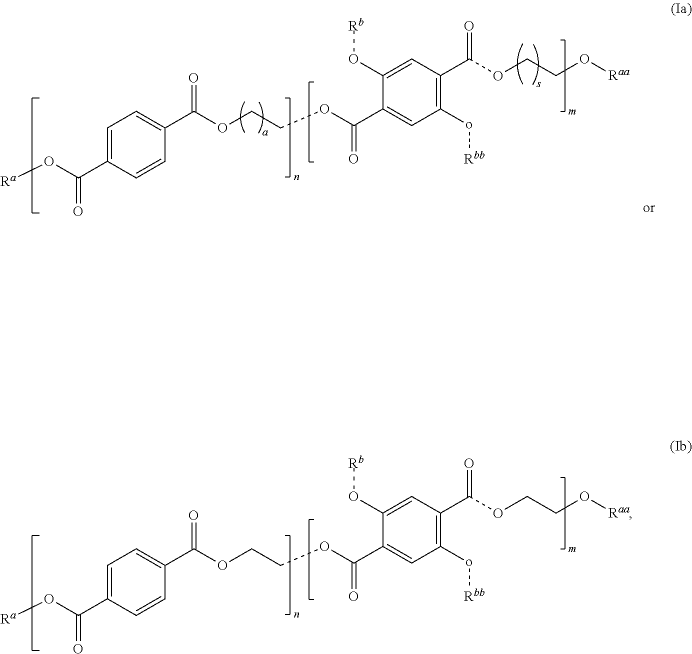
wherein
R^{a} and R^{aa} are independently selected from the group consisting of —H, —CH₃, and —CH₂—CH₂—OH; and
R^{b} and R^{bb} are independently selected from —H,

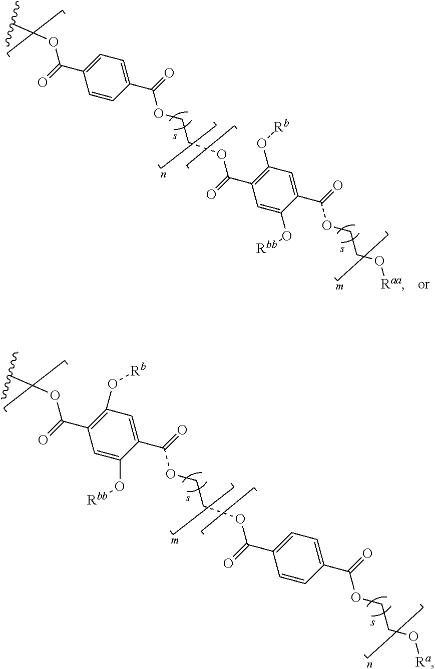

8. (canceled)

9. A process for preparation of a cleavable polymer comprising one or more repeat units containing group A and one or more repeat units containing group B, said process comprising:
providing a compound having the structure of Formula (II): 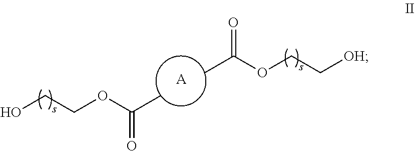
providing a compound having the structure of Formula (III): 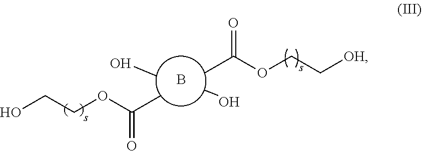
and
reacting the compound of formula (II) and the compound of formula (III) under conditions effective to produce the polymer,
wherein
group 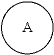
is selected from the group consisting of arylene, heteroarylene, heterocyclene, and C₅₋₈ cycloalkylene;
group 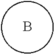
is selected from the group consisting of phenylene, furanylene, thiphenylene, and naphtanylene, wherein phenylene, furanylene, thiphenylene, and naphtanylene can be optionally substituted from 1 to 2 times with R;
R is —OR¹, —NHR², —NO₂, or halogen;
R¹ is H, C₁₋₃₀ alkyl, or aryl;
R² is —C(O)—R¹; and
s is 1 to 30.

10.-31. (canceled)

32. A cleavable polymer comprising one or more repeat units containing group C and one or more repeat units containing group D,
wherein
the repeat unit containing group C is 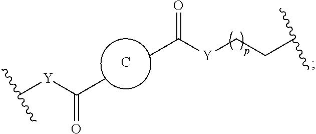
the repeat unit containing group D is 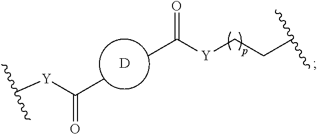
each Y is independently O or NH;
group 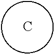
is C₂₋₃₀ alkylene, wherein C₂₋₃₀ alkylene can be optionally substituted from 1 to 3 times with R³;
group 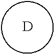
is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

33.-34. (canceled)

35. A cleavable polymer comprising one or more repeat units containing group C and one or more repeat units containing group D,
wherein
the repeat unit containing group C 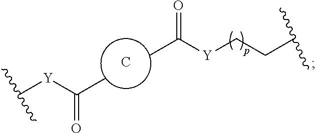
the repeat unit containing group D is 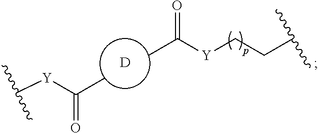
each Y is independently O or NH;
group 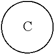
is arylene substituted from 1 to 3 times with R³;
group 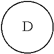
is heteroarylene or arylene-Z-arylene, wherein heteroarylene can be optionally substituted from 1 to 3 times with R⁴; or
group 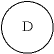
is arylene substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl; and
p is 1 to 30.

36.-51. (canceled)

52. The cleavable polymer of claim 1, further comprising one or more repeat units group C:
wherein the repeat unit containing group C is 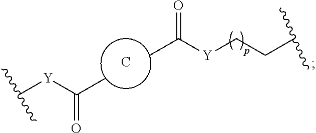
group 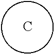
is arylene or C₂₋₃₀ alkylene, wherein arylene and C₂₋₃₀ alkylene can be optionally substituted from 1 to 3 times with R³;
each Y is independently O or NH;
R³ is —CH═CH—; and
p is 1 to 30.

53. (canceled)

54. The cleavable polymer of claim 1, further comprising one or more repeat units containing group D:
wherein
the repeat unit containing group D is 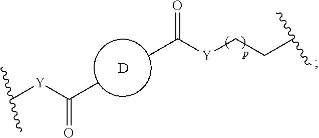
group 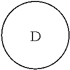
is arylene, heteroarylene, or arylene-Z-arylene, wherein arylene and heteroarylene can be optionally substituted from 1 to 3 times with R⁴;
each Y is independently O or NH;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or10;
k₂ is 1, 2, 3, 4, 5, 6, 7, 8, 9, or 10;
k₃ is 1, 2, 3, 4, 5, 6, 7, 8, 9, or 10;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Ar is aryl optionally substituted with C₁₋₆ alkyl or —OC₁₋₆ alkyl; and
p is 1 to 30.

55. A polymer comprising one or more repeat units containing group A, one or more repeat units containing group C, and one or more repeat units containing group D:
wherein
the repeat unit containing group A is 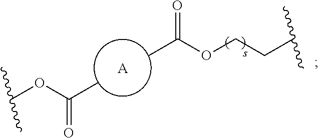
the repeat unit containing group C is 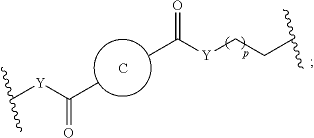
the repeat unis containing group D is; 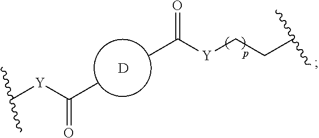
each Y is independently O or NH;
group 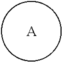
is selected from the group consisting of arylene, heteroarylene, heterocyclene, and C₅₋₈ cycloalkylene;
group 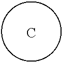
is arylene or C₂₋₃₀ alkylene, wherein arylene and C₂₋₃₀ alkylene can be optionally substituted from 1 to 3 times with R³;
group 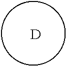
is arylene, heteroarylene, or arylene-Z-arylene, wherein arylene and heteroarylene can be optionally substituted from 1 to 3 times with R⁴;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30; and
s is 1 to 30.

56. A cleavable polymer comprising one or more repeat units containing group B, one or more repeat units containing group C, and one or more repeat units containing group D:
wherein
the repeat unit containing group B is R_{bb} 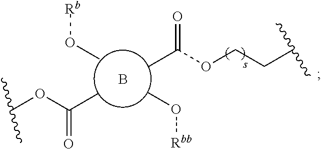
the repeat unit containing group C is 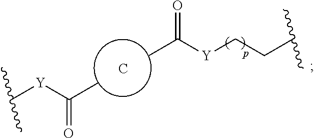
the repeat unit containing group D is 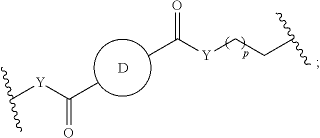 [symbol]
is a chemically cleavable bond;
each Y is independently O or NH;
group 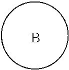
is selected from the group consisting of phenylene, furanylene, thiphenylene, and naphtanylene, wherein phenylene, furanylene, thiphenylene, and naphtanylene can be optionally substituted from 1 to 2 times with R;
group 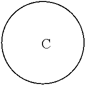
is arylene or C₂₋₃₀ alkylene, wherein arylene and C₂₋₃₀ alkylene can be optionally substituted from 1 to 3 times with R³;
group 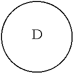
is arylene, heteroarylene, or arylene-Z-arylene, wherein arylene and heteroarylene can be optionally substituted from 1 to 3 times with R⁴;
R^{b} and R^{bb} are independently selected from —H, 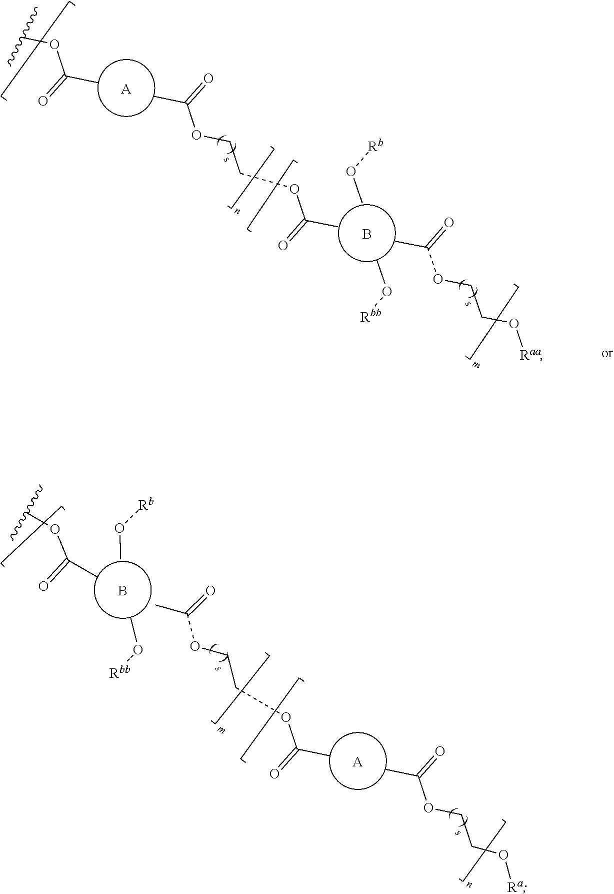
R^{a} and R^{aa} are independently selected from the group consisting of —H, —C1.30 alkyl, and —C₁₋₃₀ alkyl-OH;
R is —OR¹, —NHR², —NO₂, or halogen;
R¹ is H, C₁₋₃₀ alkyl, or aryl;
R² is —C(O)—R¹;
R³ is —CH═CH—;
R⁴ is selected from the group consisting of —OH, —OR⁵, —NHC(O)Ar, —CH₂OR⁵, and —OCH₂CH₂OR⁵;
R⁵ is C₁₋₆ alkyl or Ar;
Z is —C(O)—O—(CH₂)ₖ₁-N(C₁₋₆ alkyl)-(CH₂)ₖ₂—(CH₂)ₖ₃—O—C(O)—;
k₁ is 1, 2, 3, 4, 5, 6, 7, 8, 9, or 10;
k₂ is 1, 2, 3, 4, 5, 6, 7, 8, 9, or 10;
k₃ is 1, 2, 3, 4, 5, 6, 7, 8, 9, or 10;
Ar is aryl optionally substituted with C₁₋₆ alkyl or —OC₁₋₆ alkyl;
p is 1 to 30;
s is 1 to 30;
n is 1 to 1,000,000; and
m is 1 to 1,000,000.

57. A sheet comprising:
the polymer of claim 1.

58. A molded article comprising:
the polymer of claim 1.
